(19) United States
(12) Patent Application Publication
(10) Pub. No.: US 2025/0210620 A1
(43) Pub. Date: Jun. 26, 2025

(54) CONTROLLED PRELITHIATION OF NEGATIVE ELECTRODES FOR A LITHIUM ION CELL WITH A LITHIUM FOIL, APPARATUSES FOR THE PROCESS, AND RESULTING ELECTRODES

(71) Applicant: Ionblox, Inc., Fremont, CA (US)

(72) Inventors: Ayyappan Elangovan, Fremont, CA (US); Kevin Hays, Fremont, CA (US); Sujeet Kumar, Newark, CA (US); Herman A. Lopez, Sunnyvale, CA (US)

(21) Appl. No.: 18/829,139

(22) Filed: Sep. 9, 2024

Related U.S. Application Data
(60) Provisional application No. 63/613,946, filed on Dec. 22, 2023.

(51) Int. Cl. H01M 4/04; H01M 4/02; H01M 4/36; H01M 4/38; H01M 4/62; H01M 10/0525; H01M 10/0587

(52) U.S. Cl. CPC H01M 4/0435; H01M 4/364; H01M 4/386; H01M 4/622; H01M 10/0525; H01M 10/0587; H01M 2004/027

(57) ABSTRACT

Prelithiated negative electrodes are prepared under controlled conditions. Lithium foils are laminated onto active material layers using sufficient pressure such that heat is generated upon initiation of reaction of between lithium and the active material. The reaction proceeds to completion with the laminated assembly maintained under solvent-free, temperature controlled conditions for up to about 24 hours. The prelithiated negative electrode active material has a voltage against lithium metal of not more than about 1V at a value of lithium uptake of 10% of capacity, and irreversible capacity loss associated with the active material has been eliminated. Roll-to-roll processes and apparatus are described for safe manufacture of hundreds of meters of the prelithiated negative electrodes which can be taken up in roll form to be cut and assembled with other components to form lithium ion cells.

### CROSS REFERENCE TO RELATED APPLICATIONS

This application claims priority to copending U.S. provisional patent application 63/613,946 to Elangovan et al., filed Dec. 22, 2023, entitled “Controlled Prelithiation of Negative Electrodes for a Lithium Ion Cell With a Lithium Foil,” incorporated herein by reference.

### FIELD OF THE INVENTION

The invention relates to the formation of prelithiated electrodes for lithium ion cells, in which the active material comprises a silicon based material, as well as the resulting electrodes. The invention further relates to methods for prelithiating electrodes for use as negative electrodes in a lithium ion cell, especially processes involving sheets and rolls of lithium foil as well as apparatuses for performing roll-to-roll processing.

### BACKGROUND OF THE INVENTION

Lithium ion cells are widely used in consumer electronics and are a growing enabling component of the rapidly expanding electric vehicle market. Lithium is a desirable material due to its relatively high energy density and low mass. For some current commercial batteries, the negative electrode material can be graphite, and the positive electrode materials can comprise lithium cobalt oxide (LiCoO₂), lithium manganese oxide (LiMn₂O₄), lithium iron phosphate (LiFePO₄), lithium nickel oxide (LiNiO₂), lithium nickel cobalt oxide (LiNiCoO₂), lithium nickel cobalt manganese oxide (LiNiMnCoO₂), lithium nickel cobalt aluminum oxide (LiNiCoAlO₂) and the like. Graphite can be limited by its relatively low theoretical capacity, and silicon based materials are a promising alternative to graphite due to a much higher theoretical capacity for lithium incorporation. The successful cycling of silicon-based materials in a lithium ion cell can be challenging.

The successful cycling of a lithium ion cell relies on structural/compositional changes that take place during the first few electrochemical cycles of the cell. Silicon-based active materials are particularly sensitive to these initial changes in the cell, although these changes are also significant for graphite cells. The ability to commercialize lithium ion cells using significant amounts of silicon-based active materials can provide improved cell performance for significantly growing market segments.

### SUMMARY OF THE INVENTION

In a first aspect, the invention pertains to a method for the formation of a prelithiated electrode. The method can comprise 1) laminating a lithium foil onto a prepared electrode with sufficient pressure to initiate reaction of the lithium foil with an active material of the prepared electrode, as evidenced by the generation of heat, to form a laminated lithium foil-electrode assembly; and 2) maintaining the laminated lithium foil-electrode assembly under conditions to undergo controlled prelithiation of the electrode active material in a solvent-free reaction to provide for completion of the reaction, evidenced by the disappearance of elemental lithium on the electrode surface, in a time frame from about 5 minutes to about 24 hours.

In a further aspect, the invention pertains to a negative electrode structure separate from an electrochemical cell structure comprising: a current collector, and an electrode on a surface of the current collector, the electrode comprising an active material having a voltage against lithium metal of no more than about 1V at a value of lithium uptake of 10% of capacity, in which the active material has been prelithiated in an electrolyte-free environment such that the irreversible capacity loss for a charge and discharge cycle against a lithium metal electrode has been eliminated.

In another aspect, the invention pertains to a method for forming a lithium ion cell, the method comprising cutting a negative electrode structure element, forming a cell structure, and placing the formed cell structure into a container. The cutting a negative electrode structure element can be performed from a roll of prelithiated negative electrode structure to form a cut electrode structure, in which the prelithiated negative electrode structure comprises a metal current collector with a prelithiated negative electrode on both surfaces of the current collector, in which the size of the cut electrode is selected for assembly into the lithium cell, and in which prelithiation of the prelithiated negative electrode structure is performed in an electrolyte free environment. The forming a cell structure can comprise assembling 1) a stack of plurality of the cut negative electrode structures, a separator, and positive electrode structures, wherein separator is between each cut negative electrode structure and an adjacent position electrode structure to avoid a short circuit between the positive electrode structure and the negative electrode structure, or 2) a roll of cut electrode structure, separator and counter electrode structure with the separator between the cut electrode structure and the counter electrode structure.

In other aspects, the invention pertains to a roll-to-roll process apparatus for prelithiating electrochemical electrodes, the apparatus comprising: 1) a lamination system, 2) a cooling system, 3) prelithiated electrode collection system, and 4) an environmental chamber. The lamination system can comprise:
a) an electrode structure dispensing roll;
b) a first lithium foil dispensing roll;
c) a second lithium foil dispensing roll;
d) a calender roll positioned to receive and pass a continuous sheet with a selected applied pressure passing through the calender roll; and
e) a first conveyor system configured to guide a first sheet of lithium foil on support layer from the first lithium foil dispensing roll into contact with a first surface of an electrode structure layer from the electrode structure dispensing roll and a second sheet of lithium foil on support layer from the second lithium foil dispensing roll into contact with a second surface of the electrode structure layer opposite to the first surface of the electrode structure layer to form a stacked layer that is then guided to calender roll to form a lithium-electrode laminate having a support layer over each lithium foil layer.

The cooling system can comprise;
a) one or more cooling fluid sources and
b) a second conveyor system configured to provide an extended conveyance path configured to receive the lithium-electrode laminate and convey the lithium-electrode laminate over a path with thermal contact with cooling fluid from the cooling fluid source with a path length that provides for sufficient time for dissipation of heat generated by the prelithiation reaction between the electrode and the lithium foil such that prelithiated electrode exiting the extended conveyance path is thermally stable with respect to avoidance of ignition.

The prelithiated electrode collection system comprising:
a1) a take up roll configured to receive the prelithiated electrode exiting the cooling system, or
a2) an electrode portioning system and collector comprising a cutter configured to cut the continuous roll of prelithiated electrode into a portion for a cell electrode or a plurality thereof and a collector to accumulate the cut portions.

The environmental chamber can be configured to enclose the lamination system, the cooling system and the prelithiated electrode collection system to maintain the interior of the environmental chamber in a low moisture environment.

### BRIEF DESCRIPTION OF THE DRAWINGS

FIG. 1A is an exploded view of a pouch battery with a battery core separated from two portions of the pouch case.

FIG. 1B is a perspective lower face view of the assembled pouch battery of FIG. 1A.

FIG. 1C is a cross sectional view of the assembled pouch battery of FIGS. 1A and 1B viewed along the C-C line as shown in FIG. 1B.

FIG. 1D is a depiction of an embodiment of a battery core comprising an electrode stack.

FIG. 1E is a schematic cross sectional view of a spirally wound electrode assembly inside a cylindrical container.

FIG. 1F is a schematic cross sectional view of a portion of the electrode assembly shown in FIG. 1E.

FIG. 2 is a schematic depiction of the method showing formation of a single sided prelithiated negative electrode.

FIG. 3 is a schematic depiction of the method showing formation of a double sided prelithiated negative electrode.

FIG. 4 is a schematic depiction of a calendering step used to calender the negative electrode before the negative electrode layer is prelithiated.

FIG. 5A is a schematic depiction of a roll-to-roll process for prelithiating a double sided negative electrode.

FIG. 5B is a schematic depiction of a roll-to-roll process for prelithiating a single or double sided negative electrode wherein a cooling section involving vertical transits is used to increase path length within a small facility footprint.

FIG. 5C is an image of an exemplary roll-to-roll apparatus that can be used to carry out prelithiation of a single or double sided negative electrode according to the process described for FIG. 5B.

FIG. 5D is a schematic depiction of a roll-to-roll process for prelithiating a single or double sided negative electrode wherein a cooling drum is used to cool the electrode after prelithiation.

FIG. 6A is a schematic depiction of an automated process used to assemble a pouch cell that includes an electrode stack formed with prelithiated negative electrode sheets.

FIG. 6B is a schematic depiction of an automated process used to assemble a spirally wound, rolled cell that includes an electrode stack formed with a prelithiated negative electrode sheet.

FIG. 7A is an image showing one negative electrode layer (c) of a double sided negative electrode, after lithium transfer films (a) and (b) were removed following incomplete transfer of lithium from the lithium transfer films to the layers.

FIG. 7B is an image showing one negative electrode layer (b) of a double sided negative electrode, after lithium transfer films (a) and (c) were removed following substantially complete transfer of lithium from the lithium transfer films to the layers.

FIGS. 8A-8D are images showing changes in surface appearance of a negative electrode layer after 5 minutes, 10 minutes, 1 hour and 2 hours, respectively, of lithium being transferred from a lithium transfer film to the negative electrode layer.

FIG. 9A is an image showing a negative electrode layer after lithium has been transferred from a lithium transfer film to the layer and immediately following removal of the polymeric substrate of the film.

FIG. 9B is an image showing the negative electrode layer shown in FIG. 9A about 76 seconds later and wherein the layer has ignited and burned out following removal of the polymeric substrate.

FIG. 10A is an image showing ignition of a stack of eleven double sided negative electrodes wherein the polymeric substrates of lithium transfer films are removed from both sides and the top surface is recovered with a polymeric substrate.

FIG. 10B is an image showing the burning stack of FIG. 10A.

FIG. 11 is a plot of temperature as a function of time for prelithiated negative electrodes, each having a length of about 1.2 m and a width of about 13 cm and wound into a roll having an inner diameter of about 2.5 cm.

FIG. 12 is a plot of negative electrode thickness as a function of time after lithium has been transferred to the negative electrode layer and wherein transfer has been carried out either without calendering or by calendering within a range of calender roll gaps.

FIG. 13A shows an X-ray diffraction (XRD) pattern for Cu baseline.

FIG. 13B shows an XRD pattern for a lithiated negative electrode composition wherein lithiation has been carried out by direct contact of the composition and a lithium foil followed by calendering.

FIG. 13C shows an XRD pattern for a lithiated negative electrode composition wherein lithiation has been carried out electrochemically using Li foil as a counter electrode in a half cell assembly.

FIG. 14 is a plot of capacity retention as a function of cycle number for coin cells in which the negative electrodes were prelithiated using a lithium foil with direct contact and calendering, or electrochemically using Li foil as a counter electrode in a half cell assembly.

FIG. 15 is a plot of capacity retention as a function of cycle number for pouch cells in which the negative electrodes were prelithiated using a lithium foil with direct contact and calendering, or by applying lithium powder to a surface of the negative electrode layer.

FIG. 16 is a plot of temperature as a function of time for lithiated negative electrodes wound to 2.5 cm wherein lithiation was carried out using different commercially available lithium foils.

FIG. 17 is a plot of temperature as a function of time for lithiated negative electrodes wound to 2.5 cm wherein the negative electrodes were graphite electrodes.

FIG. 18A is a plot of temperature as a function of length for an outer surface following lithiation of a negative electrode using a roll-to-roll transfer process.

FIG. 18B is an image of the lithiated negative electrode layer of FIG. 18A at about 45 m and 37° C.

FIG. 18C is an image of the lithiated negative electrode layer of FIG. 18A at about 175 m and 45° C.

FIG. 18D shows an XRD pattern for a sample of the lithiated negative electrode layer shown in FIG. 18C.

FIG. 19A shows plots of temperature as a function of length for outer surfaces following lithiation of negative electrodes with different lengths and at different line speeds using a roll-to-roll transfer process.

FIG. 19B shows plots of temperature as a function of length for inner surfaces following lithiation as described for FIG. 19A.

FIG. 19C shows plots of temperature as a function of time for inner surfaces as described for FIG. 19B.

FIG. 20 shows changes in percent capacity relative to the first lithiation cycle for a prelithiated negative electrode that is lithiated and subsequently delithiated.

### DETAILED DESCRIPTION OF THE INVENTION

Methods for prelithiating electrodes in a mass production format that can safely and efficiently complete the reaction of the lithium with active material to form a prelithiated electrode for assembly into a cell. Providing supplemental lithium can be effective to improve cell performance for lithium ion cells, and the use of supplemental lithium can be particularly useful in the context of negative electrodes incorporating significant amounts of silicon based active materials, although results are also presented for graphite only electrodes. Lithium metal reacts spontaneously with active materials for a lithium ion negative electrode. The reaction should be appropriately controlled to avoid thermal runaway while providing for completion of the reaction at an appropriate time. As described herein, the lithium reaction is performed with an assembled electrode free from an electrochemical cell, and the reaction is completed relatively quickly to form the prelithiated electrode. It is presumed that the exact nature of the prelithiated electrode formed free of any electrolyte has a somewhat different structure from an electrode prelithiated in the presence of electrolyte, and such difference have yet to be fully elucidated. But from a quantitative perspective, a desirable amount of lithium can be loaded into the electrode using the processing described herein. After prelithiation, the electrode can be directly assembled into a cell, or conveniently the prelithiated electrode can be stored in a roll or sheet format for future assembly into a cell. The independent prelithiation of the electrode can simplify production in the context of cell assembly and isolate the most moisture sensitive process steps in the electrode production and separate from the cell assembly. The lithium metal can be provided as a roll or sheet of lithium foil. Association of the lithium foil with an electrode assembly can be controlled to adjust the rate of reaction such that the reaction occurs in a short period of time, but in a controlled fashion to avoid thermal run away. If the reaction is allowed to occur without appropriate control of the reaction, fires can occur. Various means of control are identified for use individually or in appropriate combinations. Apparatuses designed to incorporate appropriate process conditions are described to effectively perform roll-to-roll processing in efficient anode production for commercial cell manufacturing.

The electrodes described herein are suitable for use in lithium ion cells that use a non-aqueous electrolyte solution which comprises lithium cations and suitable anions. For secondary lithium ion batteries during charge, oxidation takes place in the cathode (positive electrode) where lithium ions are extracted and electrons are released. During discharge, reduction takes place in the cathode where lithium ions are inserted and electrons are consumed. Similarly, during charge, reduction takes place at the anode (negative electrode) where lithium ions are taken up and electrons are consumed, and during discharge, oxidation takes place at the anode with lithium ions and electrons being released.

Supplemental lithium refers to electroactive lithium equivalents that are provided in addition to the active lithium provided with the positive electrode active material, which is the conventional approach for providing lithium for a lithium ion cell. Effective delivery of supplemental lithium can be performed at various stages of cell preparation leading to completion and sealing of the cell. The provision of the supplemental lithium can be referred to as prelithiation. The transfer of lithium from the positive electrode takes place under a charge voltage during initial charging of the cell, and the prelithiation generally occurs independent of this cell charging. Excellent results have been obtained in the past by providing supplemental lithium to the negative electrode at the time of cell assembly. In the prelithiation with lithium powder, the reaction of lithium metal with the negative electrode active material occurred primarily after addition of electrolyte to the cell, as described further below. Positive electrode and negative electrode are respectively used interchangeably with cathode and anode.

For anode based prelithiation as described herein, which is particularly suitable for commercial cell production, supplemental lithium can be provided as a lithium sheet/foil that can be placed over the face of the electrode, such as a negative electrode, which can be implemented in a roll-to-roll format or alternatively in a sheet format. Successful implementation of lithium foil prelithiation involves control of the incorporation of the supplemental lithium into the active material. Uncontrolled prelithiation by the lithium foil can result in a safety hazard with a potential for initiating a fire or otherwise damaging the electrode, and controlled prelithiation can be effective to provide desirable electrode performance. Control of the reaction rate can be based on preparation of the components, performance of the lamination step, and control of the temperature evolution. The improved processing has been effectively implemented in a roll-to-roll process environment or using sheets, as described below. While the process can be performed in an oxygen depleted environment, the examples are comfortably performed in a dry room environment using a normal oxygen level, which can result in significant cost savings.

The reaction of the lithium metal with the negative electrode active material is significantly exothermic, so considerable heat can be given off during the reaction. Heat is similarly generated during prelithiation in completed cells, but in these embodiments, the liquid electrolyte can be useful to help dissipate the heat. For electrode processing, if the heat is given off too quickly, a fire can ensue, which is clearly undesirable for a production facility. Appropriate processing described herein can be effective to control the reaction rate to avoid excessive heating and/or to dissipate the heat fast enough to avoid reaching dangerous levels. Nevertheless, it can be desirable for the prelithiation to be completed prior to assembling the cell such that the cell assembly process can be simplified, so prevention of the prelithiation process would prevent completion of the prelithiation in the electrode. Prelithiated electrodes can be produced and stored at a specific facility and either produced into cells at the same or different facility after shipping. Once the prelithiation is completed, the elemental lithium is no longer present, so storage of the prelithiated electrodes does not involve particular precautions for storage of lithium metal, although they still should be appropriately stored. The termination of the prelithiation reactions can be approximated by the end of heat generation, visual examination of the electrodes, and/or testing a section of the electrode to confirm completion of the reaction. Of course, in a manufacturing context, timing can be routinely followed based on experience with appropriate quality control checks. The control of the processes as described herein can allow for some process design to control the rate of reaction within reasonable boundaries if desired. Silicon based active materials are known to expand during lithium alloying. The prelithiated electrodes with silicon based active material may or may not have significantly increased thicknesses upon prelithiation consistent with expansion if the active material due to lithium alloying depending on the density of the initial electrode. However, the prelithiation process described herein is not specific for any particular negative electrode active material.

Silicon-based materials are promising active materials for negative electrodes for lithium ion cells. In particular, silicon oxide composites can be used in cells with desirable performance properties. Silicon-based materials generally undergo significant structural changes during initial lithium alloying that are irreversible. These changes can result in a significant initial irreversible capacity loss. Supplemental lithium can be used to compensate for a significant portion, all of the irreversible capacity loss, or an excess above the irreversible capacity loss. In some embodiments of particular interest, the supplemental lithium exceeds the capacity of the irreversible capacity loss, such that there is extra extractable lithium available in the negative electrode at the time of cell assembly beyond compensating for lithium consumed by the irreversible capacity loss. Prelithiation can also be useful for other electrode chemistries, such as graphite electrodes, and having a lithium reservoir in a negative electrode can be beneficial for cycling depending on the positive electrode active material. Capacity is rate dependent (generally higher capacity at lower rate), so any direct comparison of capacities should be performed at the same rates. Irreversible capacity loss is generally measured at a low rate, such as C/20, i.e., a 20 hour charge/discharge rate. Charge and discharge rates are frequently presented as a “C” value C/x, where “x” is the number of hours for the charge or discharge over the prescribed voltage range.

Some of Applicant's prior efforts identifying the significance of supplemental lithium can be found in U.S. Pat. No. 9,166,222 to Amiruddin et al. (hereinafter the '222 patent), entitled “Lithium Ion Batteries With Supplemental Lithium,” and U.S. Pat. No. 9,190,694 to Lopez et al. (hereinafter the '694 patent), entitled “High Capacity Anode Materials for Lithium Ion Batteries,” both of which are incorporated herein by reference. The '222 patent discusses a range of ways to introduce the supplemental lithium into the cell with examples based on a high capacity cathode active material and graphite based anodes, and the '694 patent is directed to silicon-based active materials. The significance of supplemental lithium in the context of silicon oxide active material is found in Applicant's U.S. Pat. No. 9,601,228 to Deng et al., entitled “Silicon Oxide Based High Capacity Anode Materials for Lithium Ion Batteries,” incorporated herein by reference. Applicant has made great progress with cycling of cells incorporating silicon based negative electrodes, which may be blended with active graphite. These efforts have relied significantly on the use of supplemental lithium.

Applicant's success in cycling cells with significant amounts of silicon based active material, in particular silicon oxide based active material has involved carefully coordinated improvements in all aspects of the cell design. The improvements include electrode engineering, balancing of the anode and cathode, electrolyte composition, formation protocols, and appropriate introduction of supplemental lithium. Initial advances in electrode design and electrode balancing are described in U.S. Pat. No. 10,553,871 to Masarapu et al., entitled “Battery Cell Engineering to Reach High Energy,” and U.S. Pat. No. 9,780,358 to Masarapu et al., entitled “Battery Designs With High Capacity Anode Materials and Cathode Materials,” both of which are incorporated herein by reference. These aspects were combined to form low and moderate form factor cells that can provide desirable performance for a commercial consumer electronics cell, as described in U.S. Pat. No. 11,476,494 to Amiruddin et al., entitled “Lithium Ion Batteries With High Capacity Anode Active Materials and Good Cycling for Consumer Electronics,” incorporated herein by reference. Further improvement involved polymer binder selection and further electrode refinements, see U.S. Pat. No. 11,094,925 to Venkatachalam et al., entitled “Electrodes With Silicon Oxide Active Materials for Lithium Ion Cells, Achieving High Capacity, High Energy Density and Long Cycle Life Performance,” and published U.S. patent application 2022/0006090 to Hays et al., entitled “Lithium Ion Cells With Silicon Based Active Materials and Negative Electrodes With Water-Based Binders Having Good Adhesion and Cohesion,” both of which as incorporated herein by reference. Improved electrolytes for these cells is described in published U.S. patent application 2020/0411901 to Dong et al., entitled “Lithium Ion Cells With High Performance Electrolyte and Silicon Oxide Active Materials Achieving Very Long Cycle Life Performance,” incorporated herein by reference. This application demonstrated in an embodiment about 1000 charge/discharge cycles before dropping to 80% of initial capacity. Essentially all of this work involved supplemental lithium in the cells to achieve good cycling.

While Applicant has taught a wide range of suitable approaches for introducing supplemental lithium into cells, the approach generally used to achieve the advances on the previous paragraph for pouch cells has been to sprinkle powdered lithium metal onto the negative electrode during cell assembly. To facilitate safe handling, stabilized lithium powder can be used. SLMP® (stabilized lithium metal powder) is sold by Arcadium Lithium and was sold for a significant period of time by their predecessors, Livent and FMC Lithium. When using SLMP®, it is generally noticed that the reactions associated with prelithiation seemed to occur mainly following cell assembly with electrolyte. Processing was adjusted accordingly. This processing is effective. The drawback of this approach is the handling of reactive lithium powders at the time of cell assembly and slow prelithiation reactions. As a result conventional lithium cell assembly lines need significant modification to allow for such cell assembly processes. As noted below, coin cells for testing can be prelithiated using electrochemical prelithiation using a lithium foil electrode and a disassemblable cell.

Looking at the patents that presumably are associated with SLMP®, it can be surmised that this stabilized lithium metal powder is coated with a polymer passivation layer. While the formulation of SLMP® is proprietary, the lithium metal powder is presumably coated with a protective coating, likely a polymer or wax. See, for example, published U.S. patent applications 2018/0261829 to Yakovleva et al. (hereinafter the '829 application, with a priority date going back to 2008/2007), entitled “Stabilized Lithium Metal Powder for Li-Ion Application, Composition and Process,” and 2019/0097221 to Yakovleva et al. (hereinafter the '221 application with a prior date going back to 2007/2006), entitled “Stabilized Lithium Metal Powder for Li-Ion Application Composition,” both of which are incorporated herein by reference. The '221 teaches a wax coating, and the '829 application teaches a polymer coating. Applicant's processing has been compatible with effective use of SLMP® for controlled prelithiation for small scale and pilot scale processing with pouch cells.

For the prelithiation reaction to occur with SLMP®, it is believed that abrasion from electrode stack lamination and/or effects of the electrolyte on the protective coating remove the barrier from the passivation coating. The assembled cell structure provides heat dissipation from the contact with the cell components and electrolyte. With the SLMP approach to introduce supplemental lithium, thermal runaway has not been observed with reasonable allowance for cooling of initially assembled cells, and correspondingly no safety concerns have arisen. In some sense the presence of the electrolyte results in a mixed phase reaction since liquid is present along with the insoluble components.

It has been discovered that the prelithiation can occur effectively without the presence of electrolyte and through a solid state reaction. This discovery allows for the performance of the prelithiation reaction in an electrode structure independently and prior to cell assembly. While the primary interest herein relates to negative electrodes, an analogous prelithiation can be used, in principle, with any electrodes that can undergo spontaneous reaction with elemental lithium. The lithium can be provided as a sheet, which is convenient format for manufacturing in an assembly line context. Even though the reaction occurs as a solid state reaction, the reaction can proceed excessively rapidly. Presumably, if the reaction is allowed to proceed too rapidly, the heat further catalyzes the reaction and may even melt the lithium metal, which has a relatively low melting point, and thermal run away can occur. Therefore, to take advantage of the lithium foil-based prelithiation process, the rate of prelithiation reaction should be moderated. On the other hand, if the prelithiation reaction is effectively stopped, the prelithiation reaction may not occur until cell assembly. For example, if the lithium foil surface or the electrode surface is passivated similarly to SLMP, then the reaction may not occur until the addition of electrolyte at cell assembly. Such an approach eliminates the advantages discovered in completing the prelithiation reaction in the electrode.

The reactions described herein involve solid state reactions. Due to the nature of solid state reactions, the materials need to be in close contact for the reaction to proceed. On the other hand, heat dissipation should be considered to avoid localized heating that can provide undesirable results. The reaction though nevertheless occurs with a strong driving force when the materials are in intimate contact, and the reaction should be appropriately controlled to prevent thermal runaway. Several specific aspects of preparation and processing are described that provide control of the prelithiation reaction to provide desired safety comfort. At the same time, the reaction can be completed in a reasonable period of time. The prelithiated electrodes can be stored for later use in a stack of sheets or a roll format. Since the prelithiation reaction has taken place, handling of the completed cells is simplified in that there is less heat generation, and the cells do not need to be stored for the prelithiation to take place. Storage of electrodes is significantly more convenient that the storage of completed cells. Evidence presented herein suggests that the changes to the electrode material due to the lithium foil prelithiation process is similar to the changes that occur with a comparable level of electrochemical prelithiation even though the current process does not involve electrolyte. It is presumed that the presence of electrolyte results in some changes to the material that do not occur without electrolyte based on extensive studies of the effects of electrolytes on the electrodes, but these material changes need revaluation in view of the results presented herein. Further work should ultimately shed light on differences in the changes to the material that occur in the presence of electrolyte.

Commercial scale processing can be efficiently performed with a roll-to-roll process. Applied Materials Corporation has received a $100,000,000 grant (titled “Advanced Prelithiation and Lithium Anode Manufacturing Facility”) from the U.S. Department of Energy (as part of an initiative to expand U.S. manufacturing related to EV battery production) to develop roll-to-roll thin lithium sheet deposition. Applicant has worked with Applied Materials for lithium sheet deposition in a pilot scale cell production process, in which Applied Materials supplied the lithium foil on a PET (polyethylene terephthalate). Any passivation of the lithium metal foil should provide some control of the prelithiation process and improve the safety of handling the foil without slowing the prelithiation process too much. Comparison of prelithiation processing with two different lithium foil suppliers suggest that one supplier may apply a passivation layer of some kind, although seemingly reasonably mild passivation. Referring to the '829 application and the '221 application both cited above, a CO₂ passivation is very mild in comparison with what is believed to be SLMP passivation. Process conditions to achieve safe prelithiation at reasonable time frames are described in detail herein.

The use of a sheet of lithium on a carrier film for application to an anode surface is generally described in published U.S. patent application 2022/0052307 to Rangasamy et al. (applicant—Applied Materials, Inc., hereinafter the '307 application), entitled “Inline Contact Pre-Lithiation,” incorporated herein by reference. The '307 application focuses mostly on carbon/graphite based electrodes, although mention is made of other anode active materials. In the process of the '307 application, the application of heat is described to drive the reaction. As described herein, the application of heat would generally not assist with desired control of the prelithiation process with graphite-based electrodes or with silicon oxide-based electrodes. Distinctions between the present work and the '307 application follow from the detailed explanation below.

Passivation of a lithium foil with a surface of lithium carbonate is described in published U.S. patent application 2022/0181599 to Sevilla et al. (applicant-Applied Materials, Inc., hereinafter the '599 application), entitled “Lithium Metal Surface Modification Using Carbonate Passivation.” incorporated herein by reference. The carbon dioxide passivation results in the formation of some lithium carbonate on the surface of the lithium foil. While a thin lithium carbonate layer may improve the safety of handling the lithium foil, it has been established that such a passivation approach is mild and would not be expected to be a significant deterrent to the prelithiation reactions. In particular, this generally follows from the teachings of FMC Lithium (subsequently Livent/Arcadium Lithium). Referring to the '221 and '829 applications cited above, explicitly teach wax or polymer coatings for lithium powder having significantly improved stability relative to lithium carbonate stabilized powder. Since the present effort is directed to completion of the reaction in a relatively short time in the electrode, the more effective passivation is not desirable, and the carbonate passivation seems relatively inconsequential. It is believed that the exemplified lithium foil sheets had a surface carbonate passivation, but this should not be significant, and either no passivation or comparable very mild passivation should not significantly influence the processing herein.

In preparation for forming an electrode stack, the electrodes are formed in electrode structures involving an electrode on the surface of a metal foil current collector. For forming an electrode stack or a rolled electrode, an electrode is generally placed on each surface of the current collector, although a single electrode structure can be used at the ends of a stack or roll. Thus, comparable processing can be performed with double-sided coated current collectors or single sided coated current collectors, which may be desirable for some cell structures and/or for terminal electrode structures in a stack. We refer to the electrode as the active elements of the electrode structure, which comprise the active material, electrical conductor particulates, binder and any other supporting components, but excluding the current collector. The current collectors provide highly conductive elements for connecting the electrodes to the rest of the cell and to external circuits with a low resistance connection. In appropriate embodiments, a current collector can have two electrodes to construct a stack where each electrode connects with an adjacent half-cell through a separator in the assembled cell, which can be wound, folded or stacked to provide similar functionality.

The lithium foil can be placed on a flexible substrate to facilitate processing and delivery, the substrate also provides some added control of the prelithiation process, as described further below. If the lithium foil is wound on a roll, the underlayer on the roll provides an effective polymer cover on the exposed surface of the lithium foil, which is naturally removed as the foil is unwound. The exposed surface of the unwound lithium foil can be placed directly on the anode surface. The flexible substrate becomes a protective cover sheet that can be removed at an appropriate time in the processing, such as when the prelithiated electrode structure is itself wound on roll, and following sufficient completion of the prelithiation reaction. The flexible substrate can be maintained on the electrode surface to protect the anode during storage. Due to heating of the electrode structure due to the prelithiation reaction, the lithium may be susceptible to reaction with atmospheric oxygen, which do not take place at a relevant rate at lower temperatures, and the flexible substrate, generally a polymer sheet, limits reaction of the lithium foil with atmospheric oxygen.

A schematic depiction of this process is depicted below for a roll-to-roll process. While the roll-to-roll process is very convenient, this can be adapted for corresponding processing of individual sheets, which can be stacked or otherwise collected, rather than rolled. A hybrid version can involve for example, using electrode structure sheets with a roll of lithium foil where the foil is cut to size during the delivery process or the lithium film can be cut into sheets for placement on electrode sheets. A common aspect whether for sheets or rolls involves the passage of the electrode with lithium foil through calender rolls. This is discussed in detail below. A person of ordinary skill in the art can adapt this processing for appropriate variations as desired for a particular application, based on the teachings herein.

While it is not desirable to have a robust passivation coating on the lithium foil at the interface with the electrode surface, the exposed surface of the lithium foil can remain covered with a polymer sheet. It has been discovered that the timing of the removal of the polymer sheet can be used to help avoid burning of the lithium foil. While not firmly established, it is believed that exposure of this surface to molecular oxygen may simulate the reaction of the lithium and result in a contribution to thermal runaway even if the atmosphere is low moisture. Performing the processing in a fully inert atmosphere may remove this issue, but this could add significant cost to the processing, while the results presented herein establish that selection of an appropriate time to removed the protective polymer cover is effective to provide a desired level of control on the processing.

It has been found that control of the initial lamination process provides a significant parameter(s) for the control of the prelithiation reaction. To perform the lamination, the lithium is placed on the electrode without significant passivation and laminated through calender rolls at a pressure sufficient to adhere the lithium to the electrode but not an excess pressure as described below. Excessive pressure can result in reaction at a rate that is too excessive, which can result in excessive heating and thermal run away. Thus, the calender conditions are significant for controlling the prelithiation process. In particular, the calender rolls can be adjusted according to their gap as well as the pressure set on the rolls. Of course, these parameters depend on the thickness set for the electrode structure, and these relationships are described below. While not wanting to be limited by theory, it is believed that the lamination process deforms the malleable lithium metal into the porous electrode structure to provide for close contact with the active material.

Upon initiation of the prelithiation reaction, the rate of reaction should be controlled. Without passivation, application of a lithium foil onto a negative electrode surface can result in rapid reaction with corresponding increase of heating that can risk destroying the electrode and potentially initiating a fire. In contrast, with properly moderated reaction of the lithium foil, the prelithiated electrodes formed with lithium foil perform comparably with cells prelithiated with stabilized lithium metal powder. One step to potentially control the prelithiation reaction involves calendering the negative electrode surface prior to application of the lithium sheet to smooth the electrode surface. A smoother electrode surface reduces the surface area, which can slow the reaction due to a smaller contact area and due to less surface roughness that can penetrate through the lithium film. The reaction rate though should not be too slow so that prelithiation can be completed on the electrode in a reasonable period of time. The production process should comprise some degree of penetrating any passivation layer, such as a carbonate passivation layer, without initiating uncontrolled reaction.

Process conditions can be selected to reduce or eliminate fire risk. For example, the environment for the lithium transfer and roll-up of the negative electrode with lithium can be flooded with inert gas, such as argon and/or nitrogen or performed in vacuum. See '307 application cited above. However, it has been found that an inert gas atmosphere is not needed to safely perform the reaction, allowing for a significant cost reduction. The processing though, as with most if not all lithium ion cell processing, should be performed in a low moisture environment, as described further below. Sheets or stacks of sheets undergoing prelithiation can be cooled to avoid overheating. For roll-to-roll processing, a take up spool for the negative electrode with lithium sheet can be cooled to remove heat generated by the exothermic prelithiation reaction. Also, the distance from the prelithiation calender rolls to a take up roll can be extended to allow for cooling, which can be facilitated with blowing over the electrode. To provide for a long cooling distance without expanding the facility footprint, the conveyance path can follow vertical sections with small horizontal displacements. Cool gas, such as dry air, can be blown over the electrode in transit. Also, the prelithiating electrode can be conveyed over a chilled roller to cool the electrode, and the cooled roller can have a large diameter to provide more surface contact. Also, the calender rolls used for the transfer of the lithium foil to the electrode can be adjusted to use less transfer force to apply the lithium sheet to the electrode surface. The calendering force should be applied consistently to achieve the transfer with an anticipated initiation of the prelithiation reaction under controlled rate conditions.

While the prelithiation can be performed for a range of active materials, silicon based active materials are of particular interest, and silicon oxide active materials have been studied for achievement of good cycling and are exemplified below. As used herein, silicon oxide refers to SiOₓ, where x is 0.5<x<1.4, which can alternatively be referred to as silicon suboxide. SiO can be referred to as silicon monoxide, but in the solid state, this does not seem to be a stoichiometric material with a single unique, homogenous structure. Silicon oxide can have a complex structure with domains of essentially silicon, which may be relatively crystalline, with other amorphous and potentially crystalline domains. Commercial silicon oxide (approximating SiO) are available, for example, from Shin-Etsu, Sigma-Aldrich, Shanshan, Osaka Titanium Technologies Co., Nanostructured & Amorphous Materials, Inc., Posco, BTR, Zhide New Energy Materials Co., Ltd., and TNJ Chemical (China).

Silicon oxide is not electrically conductive. Silicon dioxide, which may be referred in various fields to as silicon oxide or silica, is a well-known dielectric, and elemental silicon is a semiconductor with a low conductivity if undoped. Doping of silicon oxide (suboxide) materials has not been particularly useful as an active material for a cell. Of course, cycling in the cell involves conduction of electrons between the active material and the current collector. To improve the conductivity of the silicon oxide active material, a composite can be formed of the silicon oxide with elemental carbon. Elemental carbon can be moderately electrically conductive in an appropriate form. In particular, amorphous carbon is moderately electrically conductive and graphite/graphene sheets can be conductive along appropriate planes. On the other hand, diamond-like carbon is insulating. In the composite form, the carbon can be intimately associated with the silicon oxide, and low amounts of carbon coatings can significantly improve electrical conductivity without significantly impacting insertion and removal of lithium from the material. This direct association can be achieved, for example, through high energy mechanical milling. The milling can disrupt any initial crystallinity of the carbon in the process of its association with the silicon oxide. An effective way to intimately form a carbon composite with silicon oxide involves the formation of pyrolytic carbon in association with the silicon oxide. Various organic sources can provide the reactant for formation of the pyrolytic carbon. Pyrolytic carbon is generally amorphous with domains of sheets having a graphite structure and with moderate electrical conductivity. Various approaches for forming a carbon composite with silicon oxide is described in U.S. Pat. No. 9,601,228 to Deng et al. (hereinafter the '228 patent), entitled “Silicon Oxide Based High Capacity Anode Materials for Lithium Ion Batteries,” incorporated herein by reference.

Silicon based active materials are known to have a high irreversible capacity loss (IRCL) during the formation cycle(s) after the lithium ion battery is assembled. Generally, the IRCL can be evaluated as the difference between the first cycle charge capacity and the first cycle discharge capacity, but if large capacity changes are observed in the second or possibly third cycles, these can be included in the IRCL. After formation, the per cycle loss of capacity should be small unless related to a cell failure. IRCL can be associated with significant changes in the active material structure, and a larger IRCL can be associated with correspondingly larger structural changes. For example, silicon undergoes large volume changes with alloying and dealloying with lithium that is believed to contribute to irreversible capacity loss for silicon. An irreversible capacity loss at the negative electrode corresponds to consumption of lithium that is subsequently not available for cycling.

In traditional lithium ion battery designs, the lithium for cycling is supplied in the initial positive electrode active material, and if portions of this capacity of lithium for cycling is irreversibly lost in initial charges of the cell, there is significant mass of positive electrode material that is not used during cycling since there is insufficient lithium to discharge into the positive electrode active material with respect to its full capacity. An initial impetus for supplying supplemental lithium in addition to lithium from the positive electrode active material was to directly provide additional lithium for the IRCL to avoid needing extra positive electrode active material capacity that would not be used for cycling. Additional advantages were discovered for providing even greater amounts of supplemental lithium. The processing described herein is effective to lower the IRCL relative to the material prior to prelithiation, while maintaining a desirable discharge specific capacity and good cycling stability. In particular, the amount of lithium deposited into the electrode based on the processing described herein can exceed the IRCL, effectively removing the IRCL and providing a reservoir of lithium.

Evidence suggests that at least a significant amount of the IRCL is involved in irreversible changes to the active material structure. Since lithium is evidently consumed in the process, it may be reasonable to assume that lithium is incorporated into phases in which the lithium is not extractable under the conditions in the cell, although this is a complex process not yet understood. The results presented herein shed significant additional light on this process, although not providing a corresponding reduction of complexity. In the context of the present prelithiation process, it is not clear if different prelithiation reactions take place relative to prelithiation that occurs in other formats, such as in the presence of electrolyte. It is believed that some differences in the material changes take place in the presence of electrolyte based on extensive work on the field relating to the effects of electrolyte. But evidence herein suggests the formation of at least some common phases for prelithiation reaction performed with or without electrolyte.

The overall performance of the prelithiated cells processed without electrolyte exhibit very similar behavior as cells prelithiated in the presence of electrolyte, which suggests that electrolyte is not central to at least some significant reactions related to prelithiation. The results presented here strongly suggests that the material changes taking place during prelithiation are incremental, implying a voltage dependence. So a prelithiation providing a surplus of lithium relative to the previously established irreversible capacity loss results in only a fraction of the irreversible capacity changes with some of the lithium diverted to extractable lattice sites. Generally, the prelithiated material retains a significant capacity for extractable lithium, so there presumably are distinct lattice sites in the material attributable to extractable and non-extractable lithium, which is consistent with significant inhomogeneity of the material. Since silicon oxide has proven to be a promising, high capacity silicon-based material for cells with good cycling, significant attention has been devoted to silicon oxide materials in the context of prelithiation, see the '228 patent cited above. It is highly desirable for a prelithiation process to significantly lower or eliminate the IRCL for the prelithiated material since a major objective of the prelithiation process is to avoid the impetus for supplying lithium to, at least in part, compensate for IRCL associated losses of cycling lithium. So if sufficient lithium equal or exceeding the irreversible capacity loss amount, even if only a portion of this lithium equivalence results in an immediate irreversible structural changes associated with irreversible capacity loss, the remaining lithium is stored in a reservoir of extractable lithium that can later compensate for the remaining irreversible capacity loss structural changes upon later full cycling. In results presented herein, IRCL is found to be effectively eliminated with direct irreversible material changes combined with a surplus of lithium in a reservoir even if all of the irreversible changes to the material have not taken place, although lesser elimination of IRCL could be used if desired.

Applicant's current commercial cell designs are based on association of elemental lithium with the negative electrode at cell assembly. It has been believed that the chemical prelithiation is at least completed after the addition of electrolyte. So after assembly of the cell, near the end of the process electrolyte fluid is added. Once the electrolyte is added, the prelithiation process can begin to occur at a greater rate. Applicant has observed prelithiation reactions occurring even prior to the addition of electrolyte if the elemental lithium is allowed to directly contact the negative electrode. The prelithiation reactions occurring prior to addition of electrolyte fluid can result in reactions that are difficult to control and that produce significant amounts of heat that is not easily dissipated, which can create a significant risk from fire.

The formation of prelithiated electrodes, in particular electrodes using silicon based active materials for negative electrode use, can significantly facilitate cell assembly since supplemental lithium is not needed at cell assembly. Using prelithiated electrodes, in which the prelithiation reaction is completed, allows cell assembly to proceed without the introduction of highly reactive lithium metal components. Thus, cell assembly lines can be used without modification for the silicon based electrodes, which reduces capital expenses. The prelithiated electrodes can be produced in advance and stored, such as at a remote location to the cell assembly plant. The prelithiated electrode can be input into the cell assembly process as another component with novel production capacity relegated to the electrode production facility. Furthermore, significantly, since the prelithiation is completed prior to cell assembly, the assembled cell does not need to be stored to provide for completion of the prelithiation reactions. If the assembled cells can be stored for shorter periods of time prior to commercial distribution, the overall process can be done for a reduced cost and a larger number of cells can be produced at a particular production facility. Thus, the supply chain for lithium ion cell production can be significantly simplified.

As a result of the prelithiation, the cell assembly can take place essentially as performed with an electrode not involving any prelithiation. With a roll-to-roll (R2R) process, the prelithiated roll of negative electrode can be provided and cut to form the desired size of the negative electrode. For an electrode stack, the cut electrode can be rectangular with an aspect ratio that is likely from roughly 1:1 (square) to 5:1. For a wound cell, the cut electrode can be more of a stripe generally with an aspect ratio of at least 3:1. The electrode and roll sizes can be selected to avoid excess waste. Once the electrodes are cut to size, the prelithiated electrodes can be introduced into the cell assembly process. The cell assembly process would generally be free of any additional assembly or component to introduce supplemental lithium. The remaining cell design aspects can follow Applicant's general cell designs described herein and incorporated by reference with the acknowledgment that the supplemental lithium is already on board.

### General Battery Features

Negative electrode and positive electrode structures can be assembled into appropriate cells. As described further below, the electrodes are generally formed in association with current collectors to form electrode structures. A separator is located between a positive electrode and a negative electrode to form a cell. The separator is electrically insulating while providing for at least selected ion conduction between the two electrodes. A variety of materials can be used as separators. Some commercial separator materials can be formed from polymers, such as polyethylene and/or polypropylene that are porous sheets that provide for ionic conduction. Commercial polymer separators include, for example, the Celgard® line of separator material from Celgard, LLC, a subsidiary of Asahi Kasei (Japan). Also, ceramic-polymer composite materials have been developed for separator applications. These ceramic composite separators can be stable at higher temperatures, and the composite materials can reduce the fire risk. Polymer-ceramic composites for lithium ion battery separators are sold by Celgard® as well as under the trademarks Separion® by Evonik Industries, Germany and Lielsort® by Teijin Lielsort Korea Co., Ltd. Also, separators can be formed using porous polymer sheets coated with a gel-forming polymer. Such separator designs are described further in U.S. Pat. No. 7,794,511 B2 to Wensley et al., entitled “Battery Separator for Lithium Polymer Battery,” incorporated herein by reference. Suitable gel-forming polymers include, for example, polyvinylidene fluoride (PVDF), polyurethane, polyethylene oxide (PEO), polypropylene oxide (PPO), polyacrylonitrile, gelatin, polyacrylamide, polymethylacrylate, polymethylmethacrylate, polyvinylacetate, polyvinylpyrrolidone, polytetraethylene glycol diacrylate, copolymers thereof, and mixtures thereof.

Electrolyte provides for ion transport between the anode and cathode of the battery during the charge and discharge processes. The electrolytes for lithium ion batteries incorporate non-aqueous solvents and lithium salts. The electrolytes generally are infused into the cell prior to sealing the case.

Electrolyte provides for ion transport between the anode and cathode of the battery during the charge and discharge processes. We refer to solutions comprising solvated ions as electrolytes, and ionic compositions that dissolve to form solvated ions in appropriate liquids are referred to as electrolyte salts. Electrolytes for lithium ion batteries can comprise one or more selected lithium salts. Appropriate lithium salts generally have inert anions. Suitable lithium salts include, for example, lithium hexafluorophosphate, lithium hexafluoroarsenate, lithium bis(trifluoromethyl sulfonyl imide), lithium trifluoromethane sulfonate, lithium tris(trifluoromethyl sulfonyl) methide, lithium tetrafluoroborate, lithium perchlorate, lithium tetrachloroaluminate, lithium chloride, lithium difluoro oxalato borate, and combinations thereof. In some embodiments, the electrolyte comprises a 1 M to 2M concentration of the lithium salts, although greater or lesser concentrations can be used.

For lithium ion batteries of interest, a non-aqueous liquid is generally used to dissolve the lithium salt(s). The solvent generally does not dissolve the electroactive materials. In some embodiments, appropriate solvents can include, for example, propylene carbonate, dimethyl carbonate, diethyl carbonate, 2-methyl tetrahydrofuran, dioxolane, tetrahydrofuran, methyl ethyl carbonate, γ-butyrolactone, dimethyl sulfoxide, acetonitrile, formamide, dimethyl formamide, triglyme (tri (ethylene glycol) dimethyl ether), diglyme (diethylene glycol dimethyl ether), DME (glyme or 1,2-dimethyloxyethane or ethylene glycol dimethyl ether), nitromethane and mixtures thereof. Particularly useful solvents for high voltage lithium-ion batteries are described further in U.S. Pat. No. 8,993,177 to Amiruddin et al., entitled “Lithium ion battery with high voltage electrolytes and additives”, incorporated herein by reference.

Electrolyte with fluorinated additives has shown to further improve the battery performance for some embodiments of cells with silicon based negative electrode active material. The fluorinated additives can include, for example, fluoroethylene carbonate, fluorinated vinyl carbonate, monochloro ethylene carbonate, monobromo ethylene carbonate, 4-(2,2,3,3-tetrafluoropropoxymethyl)-[1,3]dioxolan-2-one, 4-(2,3,3,3-tetrafluoro-2-trifluoro methyl-propyl)-[1,3]dioxolan-2-one, 4-trifluoromethyl-1,3-dioxolan-2-one, bis(2,2,3,3-tetrafluoro-propyl) carbonate, bis(2,2,3,3,3-pentafluoro-propyl) carbonate, or mixtures thereof. In some embodiments, the electrolyte can comprise from about 1 weight percent to about 55 weight percent halogenated carbonate, in further embodiments from about 3 weight percent to about 50 weight percent and in other embodiments from about 5 weight percent to about 45 weight percent halogenated carbonate in the electrolyte as a fraction of the total electrolyte weight. A person of ordinary skill in the art will recognize that additional ranges of halogenated carbonate concentrations within the explicit ranges above are contemplated and are within the present disclosure. Additional fluorinated additives include, for example, fluorinated ethers, as described in published U.S. patent application 2018/0062206 to Li et al., entitled “Fluorinated Ether as Electrolyte Co-Solvent for Lithium Metal Based Anode,” and WO 2018/051675 to Takuya et al. entitled “Lithium Secondary Battery,” both of which are incorporated herein by reference. Fluorinated electrolytes are available from Daikin America, Inc.

Applicant has recently developed improved electrolytes for silicon based batteries. These improved electrolytes are described in published U.S. patent applications 2020/0411901 to Dong et al., entitled “Lithium Ion Cells With High Performance Electrolyte and Silicon Oxide Active Materials Achieving Very Long Cycling Performance,” 2022/0393226 to Dong et al., entitled “Lithium Ion Cells With High Performance Electrolyte and Silicon Oxide Active Materials Achieving Long Cycle Life, Fast Charge and High Thermal Stability” and 2023/0085778 to Hays et al., entitled “Lithium Ion Cells With High Rate Electrolyte for Cells With Silicon Oxide Active Materials Achieving Long Cycle Life,” all three of which are incorporated herein by reference.

The electrodes described herein generally can be prelithiated using the procedures described herein, and negative electrodes can comprise silicon oxide active material. The electrodes can be assembled into various commercial cell/battery designs such as prismatic shaped batteries, wound cylindrical cells, coin cells, or other reasonable cell/battery designs. The cells can comprise a single pair of electrodes (possibly wound or folded) or a plurality of pairs of electrodes assembled in parallel and/or series electrical connection(s). Electrode stacks can have an extra electrode to end the stack with the same polarity as the other end of the stack for convenience in placement in a container.

In some embodiments, the positive electrode and negative electrode can be stacked with the separator between them, and the resulting stacked structure can be rolled into a cylindrical or paced in a prismatic configuration to form the cell structure. Appropriate electrically conductive tabs can be welded or the like to the current collectors, and the resulting structure can be placed into a metal canister or polymer package, with the negative tab and positive tab welded to appropriate external contacts. Electrolyte is added to the canister, and the canister is sealed, generally after time to provide for the electrolyte to wet the electrodes and possibly after formation cycling, to complete the cell. Some presently used rechargeable commercial cells include, for example, the cylindrical 18650 cells (18 mm in diameter and 65 mm long) and 26700 cells (26 mm in diameter and 70 mm long), although other cell/battery sizes can be used, as well as prismatic cells and foil pouch cells/batteries of selected sizes.

Pouch batteries can be particularly desirable for various applications, including certain vehicle applications, due to stacking convenience and relatively low container weight. A pouch battery design for vehicle batteries incorporating a high capacity cathode active material is described further in U.S. Pat. No. 8,187,752 to Buckley et al, entitled “High Energy Lithium Ion Secondary Batteries” and U.S. Pat. No. 9,083,062 B2 to Kumar et al., entitled “Battery Packs for Vehicles and High Capacity Pouch Secondary Batteries for Incorporation into Compact Battery Packs,” both incorporated herein by reference. While the pouch battery designs are particularly convenient for use in specific battery pack designs, the pouch batteries can be used effectively in other contexts as well.

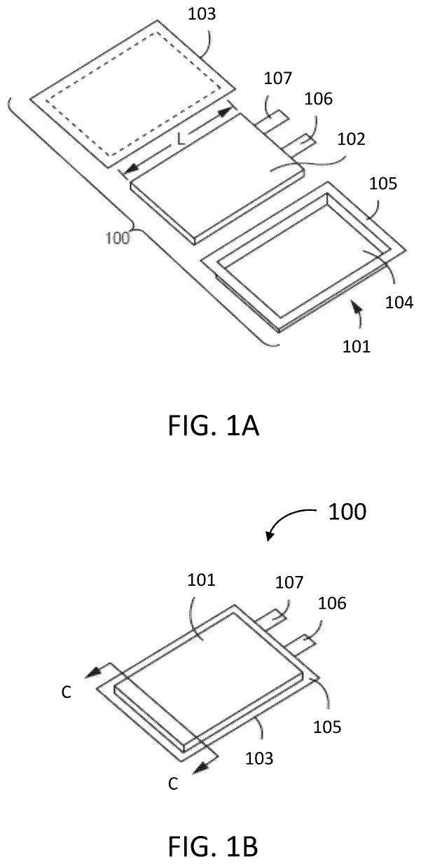

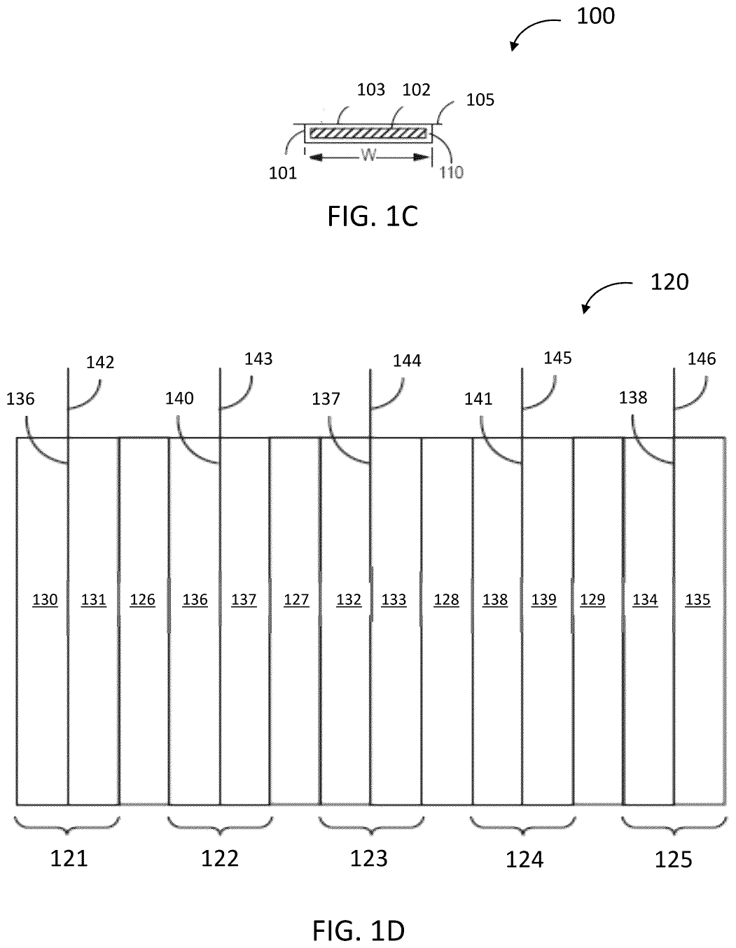

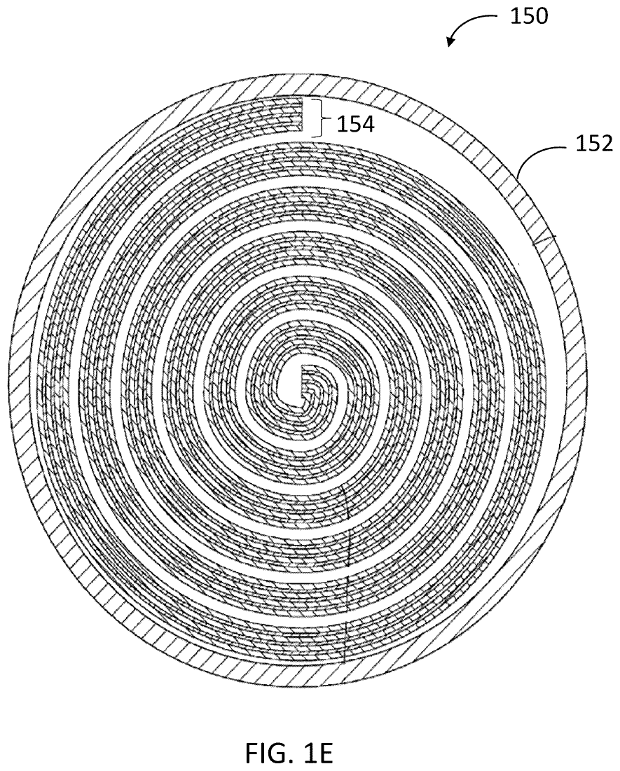

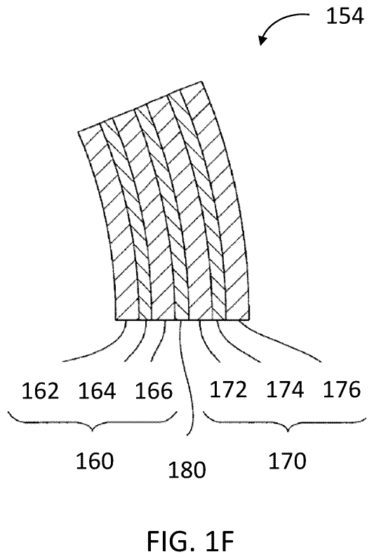

A representative embodiment of a pouch battery is shown in FIGS. 1A to 1D. In this embodiment, pouch battery 100 comprises pouch enclosure 101, electrode core 102 and pouch cover 103. An electrode core is discussed further below. Pouch enclosure 101 comprises a cavity 104 and edge 105 surrounding the cavity. Cavity 104 has dimensions such that electrode core 102 can fit within cavity 104. Pouch cover 103 can be sealed around edge 105 to seal electrode core 102 within the sealed battery, as shown in FIG. 1B. Terminal tabs 106, 107 extend outward from the sealed pouch for electrical contact with electrode core 102. FIG. 1C is a schematic diagram of a cross section of pouch battery 100 viewed along the C-C line. Many additional embodiments of pouch batteries are possible with different configurations of the edges and seals.

FIG. 1D shows an embodiment of electrode core 102 that generally comprises an electrode stack. In this embodiment, electrode stack 120 comprises negative electrode structures 121, 123, 125, positive electrode structures 122, 124, and separators 126, 127, 128, 129 disposed between the adjacent positive and negative electrodes. The separator can be provided as a single folded sheet with the electrode structures placed in the separator folds to form a particularly convenient stack structure. Negative electrode structures 121, 123, 125 comprise negative electrodes 130, 131, negative electrodes 132, 133 and negative electrodes 134, 135, respectively, disposed on either side of current collectors 136, 137, 138. Positive electrode structures 122, 124 comprise positive electrodes 136, 137 and positive electrodes 138, 139, respectively, disposed on opposite sides of current collectors 140, 141, respectively. Tabs 142, 143, 144, 145, 146 are connected to current collectors 136, 140, 137, 141, 138, respectively, to facilitate the connection of the individual electrodes in series or in parallel. For vehicle applications, tabs are generally connected in parallel, so that tabs 142, 144, 146 would be electrically connected to an electrical contact accessible outside the container, and tabs 143, 145 would be electrically connected to an electrical contact as an opposite pole accessible outside the container.

Electrode stacks can have an extra negative electrode such that both outer electrodes adjacent the container are negative electrodes. The end electrode structures can have an electrode only on one side of the current collector to face the interior of the cell and adjacent positive electrode. In some embodiments, a battery with stacked electrodes of the dimensions described herein have from 5 to 40 negative electrode elements (current collector coated on both sides with active material) and in further embodiments from 7 to 35 negative electrode elements with corresponding numbers of positive electrode elements being generally one less than the negative electrode elements. A person of ordinary skill in the art will recognize that additional ranges of electrode numbers within the explicit ranges above are contemplated and are within the present disclosure.

A representative embodiment of a spirally wound or rolled battery is shown in FIG. 1E. In this embodiment, rolled battery 150 comprises electrode assembly 154 spirally wound and inside of cylindrical container 152. A portion of electrode assembly 154 is shown in FIG. 1F. Positive electrode 160 and negative electrode 170 are disposed on opposite sides of separator 180. Positive electrode 160 comprises positive electrode layers 162 and 166 disposed on opposite sides of positive electrode current collector 164. Negative electrode 170 comprises negative electrode layers 172 and 176 disposed on opposite sides of negative electrode current collector 174.

### Lithium Foil Based Electrode Prelithiation

In general, prelithiation can be used for either the positive electrode or the negative electrode, but generally, it is most desirable to prelithiate the negative electrode. It has been discovered that using a lithium foil, an electrode can be prelithiated as a separate structure to load lithium, to levels above the irreversible capacity loss with the lithium metal consumed and no longer exposed to the environment. The evaluation of the amount of supplemental lithium, or lithium presence has both a stoichiometric, i.e., quantitation, aspect and a material/chemical aspect, but these relationships can be reasonably understood even if certain complexities are elusive. In this way, an electrode structure, such as a silicon oxide based negative electrode, can be prepared for assembly into a cell using conventional cell assembly technology without needing further concern regarding prelithiation. The performance of the cells formed with prelithiated electrodes formed with lithium foil has been found to be comparable, and possibly functionally equivalent to cells formed by Applicant using other prelithiation techniques.

The conventional wisdom has been that electrolyte is needed for a successful prelithiation process. See Shellikeri et al. (Shellikeri article), “Investigation of Pre-lithiation in Graphite and Hard-Carbon Anodes Using Different Lithium Source Structures,” Journal of The Electrochemical Society, 164 (14) A3914-A3924 (2017), incorporated herein by reference. Referring to the Shellikeri article at page A3914, right column: “In the direct contact pre-lithiation process, the two necessary conditions for the lithiation to start, are the establishment of: (i) a direct electronically conductive path between Li-metal source and carbon anode material and; and (ii) a Li-metal source/electrolyte interface.” While the Shellikeri article is directed to carbon active materials, there is no current understanding that the nature of the active material is a critical distinction. Applicant's previous efforts for prelithiation, such as electrochemical prelithiation or prelithiation with SLMP® powder has been performed in the presence of electrolyte. Clearly, in Applicant's current process method with lithium foil, there is no Li metal source/electrolyte interface since there is no electrolyte. Applicant exemplifies prelithiation with SiO active material blended with some graphite and with exclusively graphite active material, and electrolyte is clearly not needed in Applicant's prelithiation process contrary to accepted wisdom.

As presented below, Applicant has obtained x-ray diffractograms of prelithiated silicon oxide based electrodes using lithium foil for the prelithiation and compared these to electrodes formed using electrochemical prelithiation. While the x-ray diffractograms are dominated by peaks from copper current collectors, additional peaks can be seen. The peaks from the lithium foil prelithiation roughly match those from the electrochemical prelithiation and have not been associated with known x-ray spectrum based on the elements present. It is very telling that the peaks do not match known lithium silicate peaks. The spectrum of the chemical prelithiated samples with Li foil are similar to the electrochemical prelithiation, which is consistent with concepts that electrolyte is not needed for the prelithiation process, although the results suggest another layer of complexity.

Once a cell is sealed, the amount of lithium is fixed. The lithium ions associated with the electrolyte is generally constant, although side reactions can deplete lithium ions from the electrolyte during cycling, in which lithium is trapped in unusable forms. Lithium ion cells are designed to have lithium uptake and release take place at both electrodes, although through different half cell reactions that allow for the generation of an electromotive force. Prelithiation involves the association of uncharged lithium atoms into the electrodes. The initial uptake of lithium into the negative electrode results in irreversible changes to the active material structure. The precise nature of these changes are not fully understood and are potentially dependent on the mechanism.

The examples presented below shed some significant additional light on these processes. The electrochemical prelithiation seems similar to the prelithiation with lithium from a foil. It is found though that neither approach commits all of the lithium uptake provided to the irreversible changes to the material. In this context, electrochemical prelithiation refers to a partial cycling to provide a target amount of lithium introduction into the electrode. For comparison, the full irreversible capacity loss of a negative electrode can be evaluated by performing a full charge-discharge cycle. The full charge provides an amount of lithium that can be considered to comprise both lithium that is consumed in irreversible changes associated with the IRCL and lithium that is extractable back out from the electrode in a discharge process. The results presented in the Examples below indicate that this lithium uptake is not sequential; in other words, lithium is not first directed exclusively to the irreversible changes and the remainder being extractable. Qualitatively, this can be thought of as some lithium inserted into the material at irreversible location in the material and other lithium going to lattice positions that are extractable. The data indicates that the irreversible locations are not equal energy, so some lithium goes into reversible (extractable) lattice locations before all of the irreversible changes take place. But from a quantitative perspective, whether some lithium goes into an extractable reservoir does not matter for eventual compensation for IRCL since some later lithium delivered by charging from the positive electrode can complete the irreversible changes corresponding to the IRCL while being compensated by the lithium reservoir from the prelithiation.

However, this allocation of prelithiation lithium can confuse evaluation of removal of the IRCL of the cell during the prelithiation process. Based on a half cell with a lithium foil electrode, the irreversible capacity loss IRCL is equal to the difference between the first cycle charge capacity and the first cycle discharge capacity between a selected voltage range; IRCL=C_{c}−C_{d}, where C_{c} is the charge capacity and C_{d} is the discharge capacity. For a full cell, the IRCL is similarly defined, and for simplicity it can be assumed that the voltage ranges are selected so that an equivalent range is experienced by the anode and cathode in the full cell and the two half cells. The overall IRCL for the full cell is equal to the largest of the anode IRCL (Iₐ) and the cathode IRCL (I_{c}) since the two values are neither cumulative nor compensatory. For most active materials, the anode IRCL is larger than the cathode IRCL. The anode IRCL removes lithium from the cell as a result of material changes, such that a large anode IRCL can result in significant dead weight in the cell. Generally, prelithiation is performed for anodes since most cathode materials are not selected for the ability to be lithiated from its initially formed state.

For simplicity, the following discussion focuses on evaluation of IRCL in a half cell cycling against a lithium foil counter electrode, and thus, ignoring the complications of IRCL of the counter electrode. If one considers the initial electrode capacity (C) over the prescribed voltage limits of the cell design, C can be divided into C_{I}+C_{R}, where C_{I} is the capacity lost by initial irreversible changes and C_{R} is the reversible or cycling capacity. The prelithiation capacity (C_{P}) can be similarly divided, C_{P}=C_{I′}+C_{R′}, where C_{I′} is the prelithiation capacity lost by initial irreversible changes and C_{R′} is the lithium stored in reservoir. If C_{I′}<C_{I}, during the first cycle of the cell, it gives the appearance that the cell still undergoes an irreversible capacity loss and that the IRCL was not fully removed even if C_{P}>C_{I}. But if C_{P}>C_{I}, the appearance of a remaining irreversible capacity loss is a result of not accounting for the C_{R′}. So for a chemically prelithiated electrode, such a prelithiation with lithium foil, the IRCL of the electrode is fully removed if C_{P}>C_{I}.

When the prelithiated electrode is assembled into a full cell, an IRCL^{p} can be evaluated as the charge capacity minus the discharge capacity with the prelithiated electrode; IRCL^{p}=C^{p}_{c}−C^{p}_{d}. Again, IRCL^{p} equals the larger of the cathode IRCL and the prelithiated anode IRCL (C_{I′}). Even though the anode IRCL has been effectively removed, the anode may still influence the observed full cell IRCL^{p}. Depending on the balance of the anode and cathode and the cathode IRCL, the lithium reservoir in the anode after completion of the first cycle generally may or may not be larger than the lithium reservoir after prelithiation. If the cathode has no IRCL, the lithium reservoir after a first cycle would be less than the prelithiation reservoir due to the residual IRCL, C_{I′}. The '222 patent cited above provides data relating to prelithiation of an anode in embodiments in which the cathode IRCL is significantly larger than the anode IRCL and a resulting lithium reservoir from extra lithium prelithiation.

To the extent that the solid electrolyte interface (SEI) layer is formed due to the electrolyte, which is widely believed, this can be formed independent of the prelithiation process after cell assembly without any detriment to cell performance. The material changes that take place during the prelithiation process seem effective, and any further lithium is stored in a reservoir that can compensate for later lithium consumed for further irreversible changes to the material. The chemistry is not completely understood, but some parameters are better understood in view of this work. The SEI layer can form during the first charge step in the assembled cell, and any lithium consumed in this process can be compensated by the lithium reservoir formed during the prelithiation step. The good cycling obtained with the foil prelithiation process suggests that the formation of the SEI layer following cell assembly is not detrimental to cell performance even if other irreversible changes are performed prior to cell assembly. It seems likely that performing electrochemical prelithiation results in some differences in the irreversible changes to the electrode relative to prelithiation from a lithium foil free of electrolyte even if completion of prelithiation occurs in the full cell. While differences in the material structure resulting from electrochemical prelithiation and prelithiation using lithium foil separate from electrolyte are expected, these differences are yet to be clearly identified. Nevertheless, the electrode formed from lithium foil prelithiation is believed to comprise a novel and unexpected material.

As also described below, the electrode after prelithiation can be formed free of an effective irreversible capacity loss (IRCL) and with extra extractable lithium. Thus, the electrode after prelithiation can be placed in an electrochemical cell and charged to remove lithium from the electrode. In other words, the lithium provided in the prelithiation process is effective quantitatively to compensate for lithium consumed by irreversible changes associated with the IRCL and any extra lithium can be provided to be available as a reservoir during cycling. So some of the lithium supplied by the lithium foil is consumed in irreversible reactions of the active material with at least some of the excess lithium available for extraction from the electrode. Once assembled into the cells, the cell performance is uniform, so some complexities of the prelithiation chemistry has no ramifications relative to cell performance. All of this supports the concept that prelithiation in the electrode with a lithium source is an effective, efficient and convenient approach for performing prelithiation.

The prelithiation process using the lithium foil is a solid state reaction since there is no liquid present and it takes place above the melting temperature of lithium metal. Lithium metal reacts quickly with high humidity air, and processing should be performed in a dry room, such as with a dew point below −30° C. or below −40° C. or potentially lower within practical limits of commercial controlled environment facilities. A person of ordinary skill in the art will recognize that additional dew point ranges within the explicit ranges above, i.e., with upper cutoff values below explicit temperatures above are contemplated and are within the present disclosure. Suitable dry room facilities are commercially available for use in lithium ion cell production. While the production can be performed under inert atmospheric conditions, such as nitrogen, argon or helium, Applicant has found that production can safely occur using the protocols herein with dry room conditions. Thus, the dry room conditions can be maintained at a lower cost and expenditure of resources relative to maintaining an inert atmosphere. Lithium metal also is oxidized at room temperature by oxygen gas in the atmosphere, but this reaction is relatively slow, so the prelithiation reactions can be completed prior to lithium oxidation with the adoption of suitable process controls as described herein. Of course, process engineers and technicians can work under dry room conditions, but not in an inert atmosphere without an oxygen source.

While nitrogen is generally considered an inert gas, nitrogen can react at higher temperatures to form lithium nitride, Li₃N. Lithium nitride is generally observed to form at much higher temperatures that are not experienced by lithium ion cells. See Ijams et al., “Temperature Effects on Lithium Nitrogen Reaction Rates,” DOE Report August 1985 (hereinafter Ijams), which reports very slow reaction rates below 500° C. Consistent with some anecdotal reports of Li₃N observed in lithium ion cells, Applicant observe what seems to be the formation of some Li₃N from prelithiation conditions, see Examples. Ijams reports amorphous Li₃N to be a red material, and a red material is observed on the electrode surface under some processing conditions. These results suggest that the electrode catalyzes the formation of lithium nitride allowing reaction above roughly 45° C. This result suggests the desirability to maintain the temperature lower during prelithiation when nitrogen gas is present, even if an objective of eliminating fire risk would be tolerant of a higher temperature. While the precise conditions that lead to formation of lithium nitride have not been elucidated, processing at temperatures below 45° C. or below 40° C. are believed to be suitable for substantially avoiding the formation of Li₃N if nitrogen is present in the ambient atmosphere. Also, the support layer restricts contact with the atmosphere, so pealing the polymer or other support layer from the prelithiated electrode can be performed after the electrode has further cooled.

By compensating for the IRCL prior to cell assembly, the positive electrode does not need to supply extra lithium that is lost to cycling. The reduction in the need for positive electrode active material that does not contribute to cycling reduces the cost and size of the cell for a given overall capacity. It has also been found that have additional supplemental lithium in the negative electrode contributes to cycling stability and extended cycle life. As demonstrated herein, the lithium foil based deposition approach can supply sufficient lithium to completely remove the IRCL and even supply additional lithium that is stored in the negative electrode. Balancing of the electrode capacities can be performed accordingly.

The lithium foil is generally completely consumed in the prelithiation process, so no remaining lithium metal is found on the electrode surface. Correspondingly, the electrode can thicken a significant amount, which is presumably due to expansion of the active material due to lithium alloying. The thickening upon prelithiation is found to depend on the porosity of the electrode at the start of the process, which depends on the degree of calendering provided to the bare electrode prior to application of the lithium foil. While the amount of electrode layer thickening can depend on the active material composition and the amount of lithium used in the prelithiation, the increase in electrode thickness can be more than 10%.

The lithium loading from the foil can be evaluated as equivalents per square centimeter. Based on the loading of active material on the electrode the ratio of the Li-loading/electrode-loading gives the degree of prelithiation. Based on the density of lithium metal (0.534 g/cm³) and the atomic weight of lithium (6.94 g/mole), lithium-loading=average thickness (microns)×7.69×10⁻⁶ (mol/cm²). The foil thickness, electrode capacity, and degree of prelithiation can be coordinated to provide a desired degree of prelithiation based on lithium foil thickness. It is reasonably assumed that the lithium foil is not porous and has a uniform thickness within reasonable bounds. Commercial lithium foil could have a batch thickness variation for average thickness±1 micron or less for a particular specified foil thickness, so the resulting degree of prelithiation can have a corresponding range resulting from the use of the foil. This average variation gives some sense of variation about the average for a sheet. The thickness used in the calculation is an average thickness. The active material loading of the electrode can take values over a significant range depending on the cell design and intended use. For example, a high rate, high power cell may have a greater number of thinner electrodes, while a higher energy cell may have thicker electrodes. Electrode properties are described further below. Generally, the commercial foil average thickness values would be from about 5 microns to about 100 microns, although custom foil thickness can be procured as desired over any reasonable range. For electrode designs described herein, average lithium foil thicknesses would be from about 5 microns to about 200 microns, in further embodiments from about 7.5 microns to about 150 microns and in other embodiments from about 10 microns to about 100 microns. A person of ordinary skill in the art will recognize that additional ranges of lithium foil thicknesses within the explicit ranges above are contemplated and are within the present disclosure.

Lamination is used to initiate the prelithiation reaction. Also, without lamination, the lithium foil does not adhere to the electrode surface so that it can be separated cleanly from the polymer substrate. While not wanting to be limited by theory, it seems plausible that the lamination results in lithium metal being deformed into pores of the electrode structure so that the lithium metal can contact the active material. Evidence suggests that such contact is sufficient to initiate the prelithiation reaction and that this reaction continues to complete consumption of the free lithium metal into electrode active material even though in a calender process, the pressure is applied for only a limited amount of time.

Maintenance of the polymer substrate over the lithium foil following lamination is observed to help control the rate of the prelithiation reaction. In particular, removal of the polymer sheet can result in thermal runaway, as noted in the examples. Observations though suggest that the prelithiation reaction does not need to be complete prior to removal of the polymer substrate to have sufficient control over the process. Also, with the institution of other controls over the reaction rate, such as more aggressive cooling, or performance of the reaction in oxygen depleted atmosphere, may provide alternatives to control the reaction rate and avoid thermal runaway. On the other hand, leaving the polymer sheet longer on the lithium laminated to the electrode is observed to also have the benefit of avoiding any lithium left on the polymer sheet after separation in a simple processing format. While it may be desirable to leave the polymer cover sheet over the lithium foil for a particular amount of time, leaving the polymer sheet for a longer period of time would not be detrimental, so the upper limit for timing can be limited only by cell assembly. For any particular embodiment, the timing for polymer separation can depend on the particular foil thickness, electrode properties, lamination conditions, and the temperature, and it is straightforward to evaluate timing empirically based on the teachings herein. The polymer substrate can be left on the electrode structure for shipping purposes if desired. Generally, the timing from lamination to polymer removal is at least about 1 minute, in further embodiments from about 2 minutes to 6 hours, in some embodiments from about 3 minutes to about 4 hours and in other embodiments from about 4 minutes to about 3 hours. If left on for shipping, the polymer substrate can be on the electrode for days or weeks, where the limit is basically the shelf life of the electrode. A person of ordinary skill in the art will recognize that additional ranges of polymer peal timing within the explicit ranges above are contemplated and are within the present disclosure.

While lamination can, in principle, be performed with a press, calender rolls, or the like, calender rolls provide a convenient format for large scale production and are consistent with performing roll-to-roll processing. Processing is described in more detail with respect to calendering, but it is understood that a person or ordinary skill in the art can transfer this teaching to the use of a press with routine experimentation.

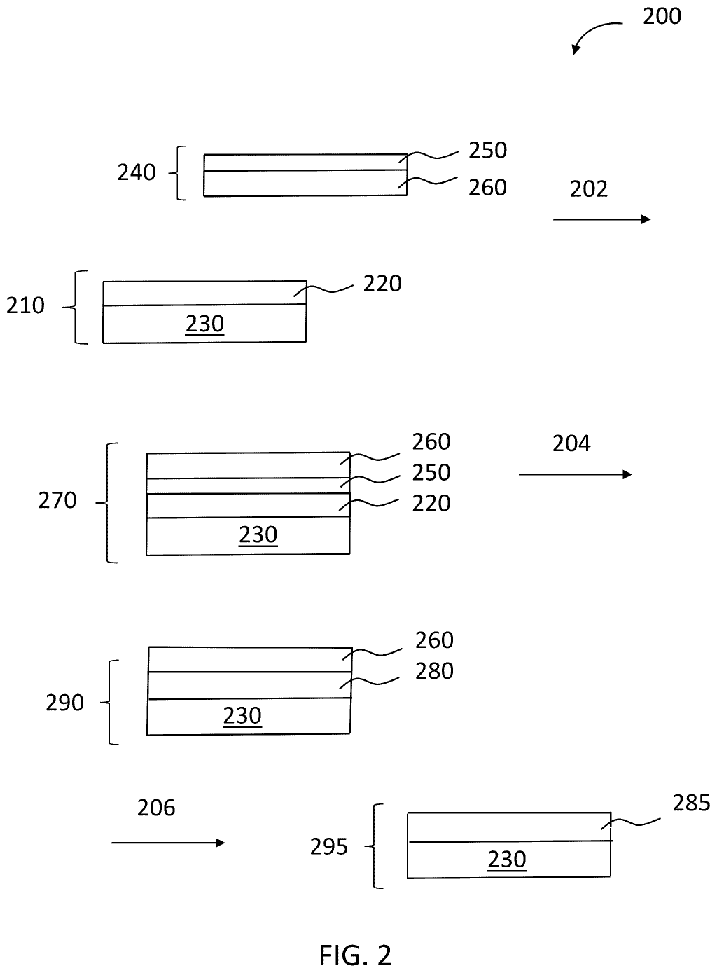

An example of the method for forming the prelithiated negative electrode using a lithium foil is shown schematically in FIG. 2. Method 200 shows single sided negative electrode 210 comprising negative electrode layer 220 disposed on current collector 230, and lithium transfer film 240 comprises lithium layer 250 disposed on polymeric substrate 260. Negative electrode 210 and lithium transfer film 240 are brought together as represented by arrow 202 such that negative electrode layer 220 is in contact with lithium layer 250 to form assembly 270. Prelithiation takes place by transfer of lithium from lithium layer 250 to negative electrode layer 220 thereby forming intermediate layer 280 of assembly 290, as represented by arrow 204.

Intermediate layer 280 may comprise one or more layers, which may be conceptual without a visible separation. For example, intermediate layer 280 may comprise a single layer whereby substantially all of the lithium from lithium layer 250 is transferred to negative electrode layer 220 to form a modified negative electrode layer which is the desired prelithiated negative electrode layer. For another example, intermediate layer 280 may comprise a layered structure in which only a top part of the electrode is prelithiated. A gradient may be formed where the effects of prelithiation extend partially into the electrode structure. The observed results provide no reason though to expect inhomogeneity of the prelithiated material, although they are solid state reactions. And the complexities of lithium electrode chemistry have fooled many experienced scientists, so Applicant does not want to be limited by theory of the prelithiated electrode structure. Removal of polymeric substrate 260 as represented by arrow 206 provides prelithiated negative electrode 295 comprising prelithiated negative electrode layer 285 disposed on current collector 230.

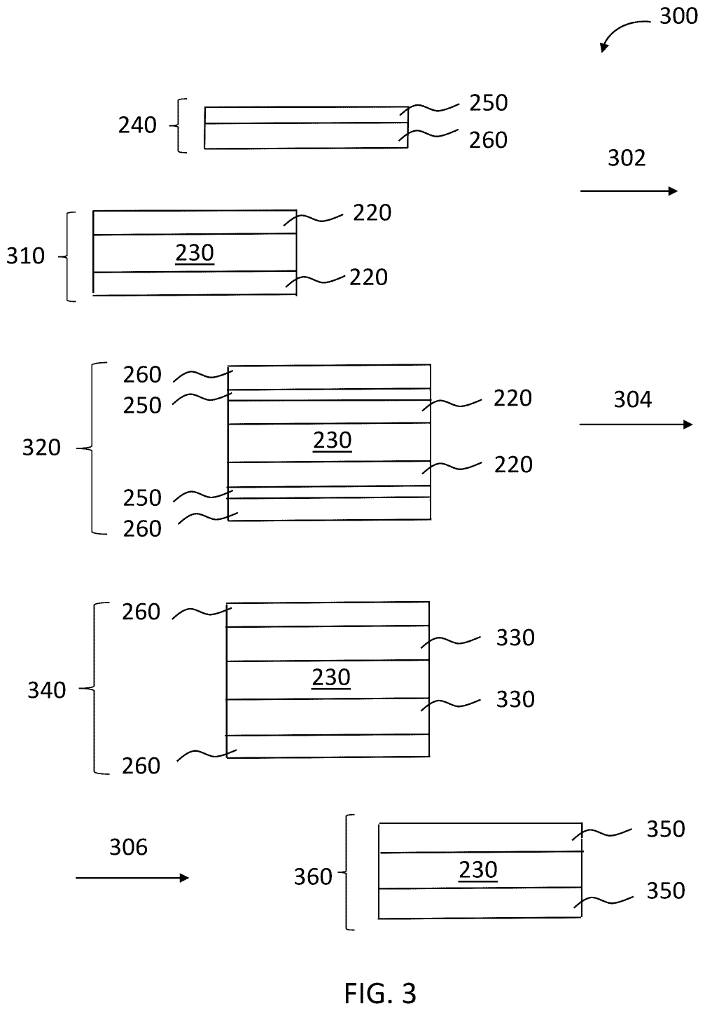

Another example of the method for forming the prelithiated negative electrode is shown in FIG. 3. Method 300 shows double sided negative electrode 310 comprising negative electrode layers 220 disposed on opposing sides of current collector 230. Negative electrode layers 220 can in principle be different from each other, although in a practical electrode stack structure, they would be the same composition and dimensions. Lithium transfer films 240 are contacted with each negative electrode layer 220 as represented by arrow 302 to form assembly 320. Prelithiation takes place by transfer of lithium from lithium layers 250 to negative electrode layers 220 thereby forming intermediate layers 330 of assembly 340 as represented by arrow 304. Intermediate layers 330 may comprise as one or more layers such as the single layer or layered structure as described above for intermediate layer 280. Removal of polymeric substrates 260 as represented by arrow 306 provides prelithiated negative electrode 360 comprising prelithiated negative electrode layers 350 disposed on opposing sides of current collector 230.

FIG. 4 is a schematic depiction of a calendering step which may be used to reduce surface roughness the negative electrode before the negative electrode layer is prelithiated. Step 400 shows single sided negative electrode 410 comprising negative electrode layer 420 disposed on current collector 430. Surface 422 of negative electrode layer 420 is depicted as an uneven or rough surface which can form from a negative electrode composition after it is coated and dried. After calendering, represented by arrow 402, negative electrode 440 is formed with modified negative electrode layer 450 comprising modified surface 452. In particular, the electrode surface can be made smoother without significantly changing the electrode density or porosity. As noted above, this smoothing can provide more consistent and more controllable prelithiation processing.

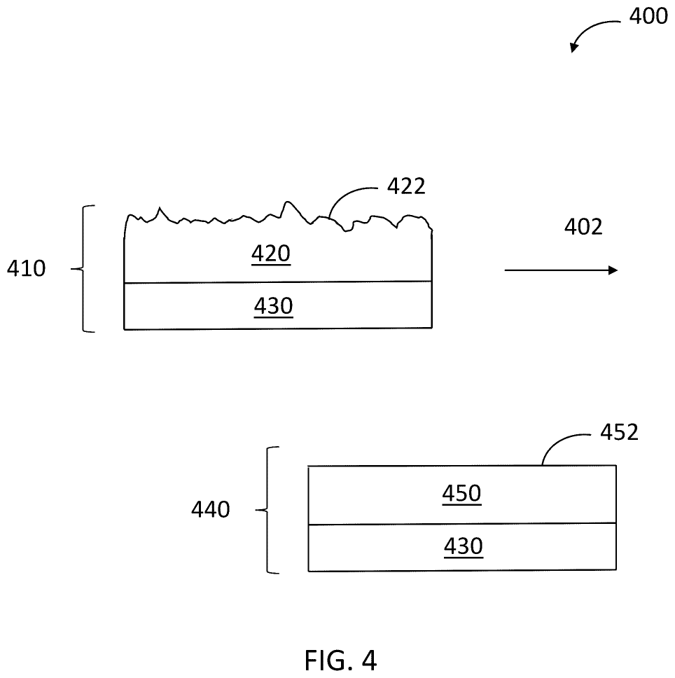

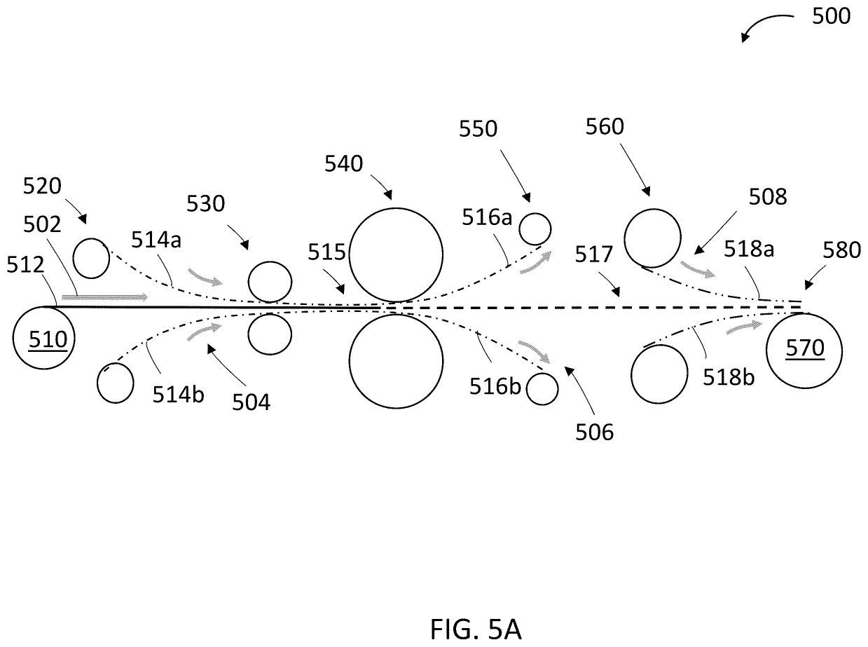

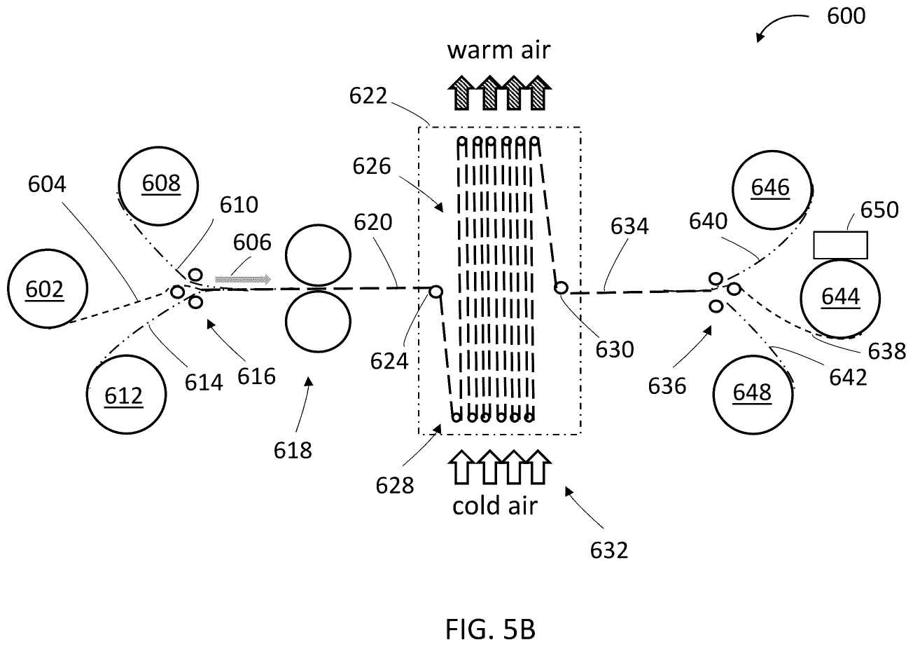

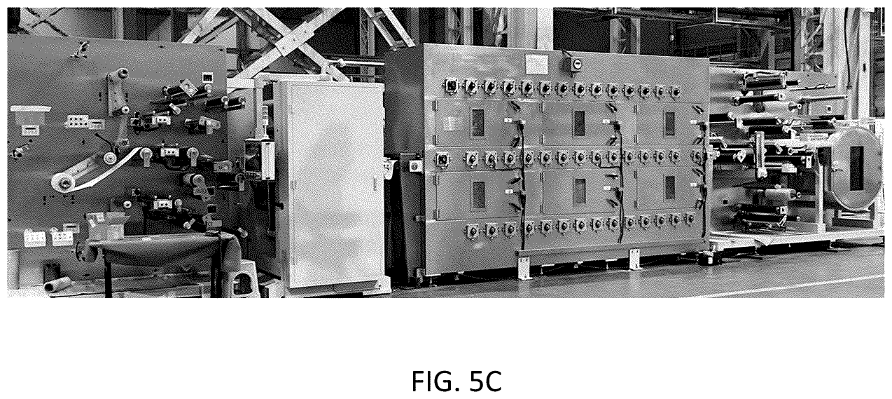

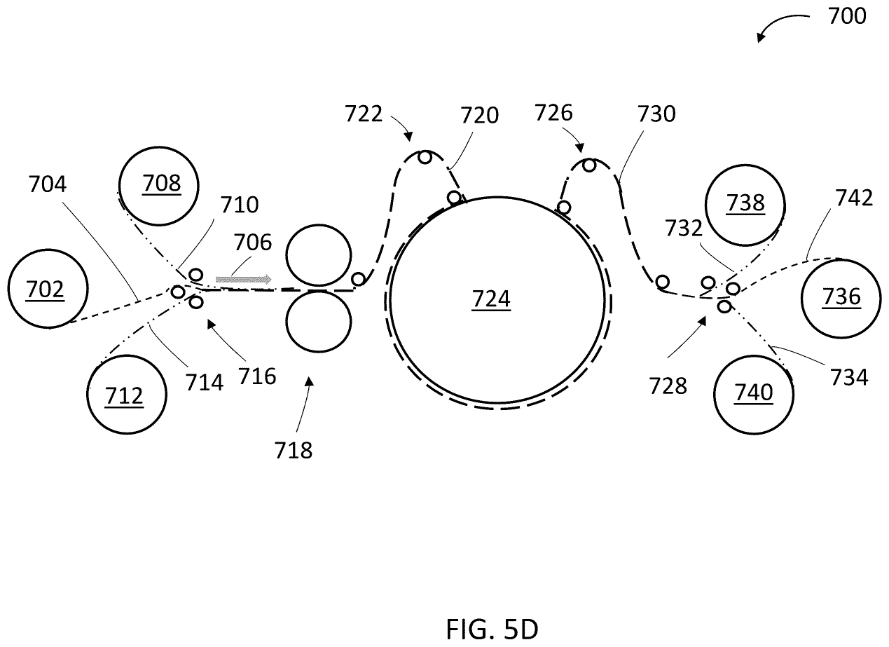

A schematic depiction of the process for prelithiation of a double sided negative electrode is shown in FIG. 5A in a roll-to-roll format starting from an electrode ready to prelithiate and ending with a prelithiated electrode roll. Process tool 500 shows unwinder roller 510 that provides double sided negative electrode 512 travelling in a forward direction as shown by arrow 502. Unwinder rollers 520 provide lithium transfer films 514a and 514b which are brought into contact, as represented by arrows 504, with double sided negative electrode 512 by deflection rollers 530. The resulting assembly 515 passes through calender rollers 540 separated by a gap and configured to deliver a desired load pressure to the assembly. Winder rollers 550 take up, as represented by arrows 506, the substrates 516a and 516b to form double sided prelithiated negative electrode 517. Unwinder rollers 560 provide interleavings 518a and 518b, although only a single interleaving layer may be used, as represented by arrows 508, to form double sided prelithiated negative electrode 580 with interleaving protection, which is taken up by winder roller 570. Interleavings 518a and 518b can be comparable materials, such as polymer sheets, as substrates 516a and 516b, which can be desirable to replace the substrates while providing protection to the prelithiated electrode. In alternative embodiments, substrates 516a and 516b may not be removed, in which case interleavings are not used, or substrates 516a and 516b are removed without the use of interleavings. Interleavings 518a and 518b can be polymeric sheets or other substrates that can be used to cover and protect the prelithiated electrodes for storage, transport and unwinding for cell assembly and can comprise similar polymers as substrates with selection based on easy removal when desired and convenience for use and storage.

Another schematic depiction of an apparatus for prelithiation of a double sided negative electrode is shown in FIG. 5B. Prelithiation apparatus 600 comprises a variation of process tool 500 in which an accumulator section is used to increase a path length of cooling without a commensurate increase in tool footprint, i.e., square area of floor space occupied by the tool. Prelithiation apparatus 600 comprises supply rolls and a take up roll, a calender to initiate prelithiation reaction, a cooling section along with conveyor components for moving the electrode structure though the tool. In particular, process tool 600 comprises unwinder roller 602 that provides double sided negative electrode 604 travelling in a forward direction as shown by arrow 606. Upper unwinder roller 608 provides upper lithium transfer film 610 which is brought into contact with an upper surface of double sided negative electrode 604. Lower unwinder roller 612 provides lower lithium transfer film 614 which is brought into contact with a lower surface of double sided negative electrode 604. Deflection rollers 616 are used to facilitate contact between the lithium transfer films and double sided negative electrode 604 forming an assembly. The resulting assembly 620 passes through calender rollers 618 separated by a selected gap and configured to deliver a desired load pressure to the assembly. The assembly enters accumulator section 622, guided by deflection roller 624, comprising vertical transits 626 formed by opposing series of stacked guide rollers 628. The opposing series of rollers are arranged to form an accordion-shaped path with a relatively small footprint. The accumulator section can be equipped with a source (not shown) for supplying cold or room temperature air or inert gas represented by arrows 632 to cool assembly 620 as it travels along the accordion-shaped path before exiting the accumulator section guided by deflection roller 630. Suitable inert gas can be CO₂, Argon, or possibly nitrogen if the temperature is sufficiently cool. The path length through the accumulator section can be from 2 meter to 100 meters, in some embodiments form about 4 meters to about 80 meters and in further embodiments from about 6 meters to about 60 meters. Generally, the time for the transit of the prelithiating electrode structure through the accumulator section can be at least about 1.5 minutes and in further embodiments at least about 1.75 minutes, and in some embodiments from about 2 minutes to about 20 minutes. A person of ordinary skill in the art will recognize that additional ranges within the explicit ranges above are contemplated and are within the present disclosure.

The detailed trajectory of the electrode assembly with the lithium foil through accumulator section 622 is not particularly significant, although the adjacent paths should be spaced enough from each other to allow for cooling without extending the apparatus footprint unnecessarily. The total path length should allow for appropriate cooling, and this length then can depend on the speed of the sheet through the apparatus.

One or both of the polymeric substrates from the upper and lower lithium transfer films 610 and 614, respectively, can be removed from the cooled assembly after it exits the accumulator section. In the embodiment depicted in FIG. 5B, prelithiation tool 600 is configured to have upper substrate 640 removed from the cooled assembly facilitated by upper winder roller 646. The upper substrate comprises upper lithium transfer film 610 minus any material, i.e., lithium, that has transferred to cooled assembly 634. Prelithiation tool 600 also is depicted with a configuration having lower substrate 642 removed from the cooled assembly facilitated by lower winder roller 648. The lower substrate comprises lower lithium transfer film 614 minus any material, i.e., lithium, that has transferred to cooled assembly 634. The upper and lower substrates can be removed in either order or at or nearly at the same time. If only one substrate is removed, it can be either the upper or lower substrate.

Prelithiated electrode 638 remains after removal of the upper and lower substrates, although prelithiated electrode 638 can be collected with one or both substrates intact. Prelithiation apparatus 600 shows the prelithiated electrode taken up by winder roller 644 to form a prelithiated electrode roll. Outside temperature of the exposed lithiated negative electrode layer surface can be recorded by temperature measuring device 650 to help control. In alternative embodiments, one or both of the polymeric substrates may be replaced with interleavings as described above for process tool 500. A photograph of an actual tool based on the design of FIG. 5B is presented in FIG. 5C.

Another schematic depiction of an apparatus for prelithiation of a double sided negative electrode is shown in FIG. 5D. Prelithiation apparatus 700 comprises a variation of prelithiation apparatus 600 in which cooling drum 724 is used in place of accumulator section 622. Prelithiation apparatus 700 shows unwinder roller 702 that provides double sided negative electrode 704 travelling in a forward direction as shown by arrow 706. Upper unwinder roller 708 provides upper lithium transfer film 710 which is brought into contact with an upper surface of double sided negative electrode 704. Lower unwinder roller 712 provides lower lithium transfer film 714 which is brought into contact with a lower surface of double sided negative electrode 704. Deflection rollers 716 are used to facilitate contact between the lithium transfer films and double sided negative electrode 704 to form an assembly 720. Assembly 720 passes through calender rollers 718 separated by a selected gap and configured to deliver a desired load pressure to the assembly. The assembly is disposed in closed proximity to, or in contact or nearly in contact with, cooling drum 724, guided by first and second deflection rollers 722 and 726, respectively. Cooling drum 724 can have a diameter selected to provide a desired degree of cooling and transit time of assembly 720 to provide controlled prelithiation reactions to take place. Cooling drum 724 can be cooled with internal fluid flow, such as water, or other appropriate cooling mechanism. As described for prelithiation apparatus 600, one or both of the substrates from the upper and lower lithium transfer films 710 and 714, respectively, can be removed from the cooled assembly. Prelithiation apparatus 700 is depicted with a configuration to remove upper substrate 732 from cooled assembly 730 facilitated by upper winder roller 738, and lower substrate 734 removed from the cooled assembly facilitated by lower winder roller 740. The substrates comprise the lithium transfer films minus any material, i.e., lithium, that has transferred to cooled assembly 730 during the prelithiation reactions. The upper and lower substrates can be removed in either order or at or nearly at the same time. If only one substrate is removed, it can be either the upper or lower substrate. Prelithiated electrode 742 is formed by removal of the upper and lower polymeric substrates, although one or both substrates can be maintained, and is taken up by winder roller 736 to form a prelithiated electrode roll. In alternative embodiments, one or both of the polymeric substrates may be replaced with interleavings as described above for process tool 500.

As noted above, the parameters of the calendering process can be significant for the successful prelithiation process. The parameters for the calendering include: speed through the rollers, temperature of the rollers, zero tension spacing of the rollers and pressure of the rollers. In principle, the roller diameters can be significant, but standard commercial calender diameters seem suitable, and it is not clear if calender results are significantly altered by the roll diameter, and initial results suggest that larger rollers of larger scale equipment is well suited for the processing. Adjustment and/or selection of these parameters influences the stability and effectiveness of the prelithiation process. For silicon based anodes, the electrode active material density and porosity (after consumption of the lithium) is believed to not be significantly altered by the calendering process so the binder in the electrode is sufficiently elastic that active material density substantially recovers after the calendering process.

With respect to temperature, generally successful results can be obtained with room temperature calender rolls. Heating of the calender rolls may facilitate initiation of the prelithiation reaction, but this faster initiation of the reaction may make the reaction more difficult to control with respect to potential thermal runaway. Cooling the calender rolls may slow the prelithiation reaction and make control of thermal runaway easier, but sufficient control can be provided subsequent to calendering. Modest temperature changes to the calender rolls can be provided, generally ±30° C. relative to room temperature (22° C.).

The calendering speed essentially correlates with the time during which the pressure is applied to the electrode structure. Due to the geometry of the calender process, there is a relatively rapid ramp up and down of the pressure. Adjustment of the speed then translates into a desired time for pressure application. Of course, the calender speed also influences the process rate for electrode production and roll temperature. Additional cooling capacity may be desirable for faster calender speed processing since the electrode may have less cooling time during transmission through the apparatus. As described herein, various combinations of fans and/or cooled surfaces can be appropriately implemented. It may be desirable to adjust the gap and/or roll pressure suitable based on a desired calender speed, although the speed can be separately adjusted to obtain desired results as appropriate. Suitable line speeds can range from about 0.25 meters/minute (m/min) to about 45 m/min, in further embodiments from about 0.5 m/min to about 30 m/min, in some embodiments from about 1 m/min to about 25 m/min, and in other embodiments from about 1.5 m/min to about 15 m/min. A person of ordinary skill in the art will recognize that additional ranges of line speeds within the explicit ranges above are contemplated and are within the present disclosure. For particularly efficient processing, coating of both sides of the current collector can be done simultaneously, and such coaters are commercially available, such as from Dürr Systems, Inc.

The dimensions of the rolls generally are constrained by practical limitations, such as length of rollers in commercial lamination tools. Such lengths can be on the order of a meter or two meters. Similarly, the length of electrode wound onto a roll can be similarly constrained by dimensions of tool and handling of the roll based on it's weight. For example, the length of electrode material taken up on a roll is exemplified up to 400 meters. Practical limits on electrode material length taken up on a roll can be up to at least about 8000 m and in some embodiment equipment designs can account for lengths from about 200 meters to about 6000 meters. The electrode material can be cut to size for forming cells. Similarly, processing of individual sheets, rather than rolls of electrode material, can be limited by size of process equipment. So sheets could be on the order of 2 meters by 2 meters, or smaller dimension, if desired. Electrodes material can be cut to size for a cell for processing. The handling of individual electrodes can increase the handling effort, but they can be mounted onto support for handling a plurality of individual electrodes simultaneously. A person of ordinary skill in the art will recognize that additional dimensions of electrode material for prelithiation processing within the explicit numbers and ranges above are contemplated and are within the present disclosure.

Depending on the calender design, it may be possible to separately select the roll pressure and roller gap, although the pressure setting is generally an upper limit to the pressure. In general, the calender roller gap for a given electrode structure thickness effectively influences the pressure on the structure through the rollers. To reduce fire risk, the calender gap is generally set to the largest value that still provides lithium transfer. A separate monitoring and/or selection of the roller pressure can be used to verify that the expected pressure is maintained during the processing. Generally, the pressure is set to be in the range from about 0.2 megaPascal (MPa) to about 60 MPa in further embodiments from about 0.5 MPa to about 40 MPa and in other embodiments form about 1 MPa to about 25 MPa. Some calender equipment has a setting based on the force applied to the calender rolls measured in tons (T). These force values do not seem to directly translate into pressures on the rollers for material passing through the rollers. The examples used two calender apparatuses. A roll-to-roll apparatus had a setting in terms of pressures in MPa, and a sheet based calender apparatus used force settings in terms of Tons. For the calender apparatus used in the examples, the approximate conversion is 1 T force=0.4 MPa or 58 psi pressure. This may hold for other calender apparatuses, or it can be similarly determined from pressure measurements. The forces generally can range from about 0.25 tons to about 250 tons, in further embodiments form about 0.5 tons to about 150 tons and in other embodiments from about 1 ton to about 100 tons. A person of ordinary skill in the art will recognize that additional ranges of calender roller pressure or force within the explicit range above is contemplated and within the present disclosure.

As noted above, the calender roll gap can be set according to the initial thickness of the electrode structure. The initial roller gap should be no more than the initial electrode stack or the electrode stack with the lithium foil/substrate structures. As noted above, in some embodiments, the electrode structure is first calendered alone for smoothing purposes, and then assembled with the lithium foil on the substrate and calendered again. This can be done with a single sided or double sided electrode structure, although for forming cell stacks generally only double sided electrode structures can be used. As noted, the initial electrode structure thickness and lithium foil thickness are determined by the cell design. Based on these thicknesses, the thickness of the assembled electrode structure follows.

If the calender rollers are not set to provide an upper limit to the pressures, the pressure is determined by the gap in view of the initial electrode structure thickness. In any case, the calender roller gap is set to provide a range to the pressure if not the only parameter to establish the pressure. The roller gap can be set in proportion to the in initial electrode structure thickness. For the bare electrode structure, the roller gap can be from about 0.20 to about 0.85 times the initial electrode structure thickness, in further embodiments from about 0.25 to about 0.75, in some embodiments from about 0.30 to about 0.675 and in other embodiments from about 0.40 to about 0.60. For the electrode structure with the lithium foil/substrate structures, the roller gap can be from about 0.60 to about 0.98, in further embodiments from about 0.70 to about 0.955, and on other embodiments from about 0.75 to about 0.92. A person of ordinary skill in the art will recognize that additional ranges of roller gap within the explicit ranges above are contemplated and are within the present disclosure. As noted above, if the roller pressure is not separately set, the roller gap can be used to set the roller pressures which can be monitored to verify that the pressures remain within desired boundaries.

Depending on the process format, the temperature moderation can be handled in different ways. While the temperature peak is generally reached quickly after the start the prelithiation reaction, this presumes that the electrode heat can be dissipated efficiently into the ambient air. So if the prelithiating electrode is stacked or rolled prior to completion of the prelithiation reaction, this can result in thermal build up. It has been found that a fan blowing air onto the electrode stacks or roll can help to dissipate the heat. The fan can just blow ambient air, or the air can be cooled. The time, which translates into distance in a conveyor system, such as a roll-to-roll, allowed for cooling prior to stacking or rolling may provide a further mechanism for thermal control. If desired, the temperature of the electrode can be monitored to implement additional cooling, such as through control of a cooling fan, for example, if the temperature rises about a threshold value, such as room temperature (20-25° C.), 35° C., 40° C., 45° C., 50° C., 60° C. or 70° C. While a fan has been found to be effective, other cooling approaches should be similarly effective, such as application to a cool surface, cooling a roller spindle or other components of a take up roller, combinations thereof, or the like. In some embodiments, cooling may be used regardless of threshold temperature measurements, but the cooling effort, such as blower speeds, may be adjusted in response to readings from temperature sensors, which may indicate an undesirable temperature increase. Similarly, conveyor speeds can be adjusted to help control temperature increase and cooling efficacy. A person of ordinary skill in the art will realize that additional threshold values of temperature for initiating or modifying cooling conditions intermittent within the ranges of threshold values provided above are contemplated and are within the present disclosure.

In summary, following the laminating process, the prelithiation reactions begin if the lamination pressure is sufficient. Insufficient application of pressure avoids the initiation of the reaction. To avoid excess heat generation, the applied pressure can be just sufficient to initiate the reaction, although with sufficient control of the reaction, a faster rate can be acceptable. For free standing prelithiating electrode in dry room air, the initial heat rise generally involves reaching a temperature maximum in a relatively short period of time, such as less than a minute to a few minutes, although this timing may depend on the amount and type of active material. The generation of heat and completion of the reaction, as evaluated by visual observation can take more than an hour with a gradual decrease in heat generation if heat is allowed to dissipate. The later stages of the prelithiation reaction seem to involve significantly lower levels of heat generation although visible changes to the material are observed to take place. However, accumulation of the prelithiating electrode, such as on a roll, complicates the cooling as prelithiation reactions continue with less free exposed surface area to facilitate cooling, and the pre-winding cooling and mechanisms for cooling of the roll can be selected in the context of the expected line speeds to achieve appropriate control of the temperature.

While the reaction of the lithium foil with atmospheric oxygen under low humidity conditions is slow, the heating due to the prelithiation reaction can accelerate this reaction. To reduce reactivity with atmospheric oxygen, it can be desirable to keep a polymer substrate on the top surface of the lithium foil, or if removed, the polymer substrate can be replaced back on the top surface of the lithium foil or with an alternative polymer sheet, see discussion of interleavings relating to FIG. 5. After the temperature has cooled sufficiently, corresponding with progress of the prelithiation reaction, the polymer cover can be safely removed without significant additional heating, presumably due to slower reaction with atmospheric oxygen at the lower temperatures. On the other hand, there is no harm in leaving the polymer cover over the electrode surface(s), and the electrodes in a sheet or roll format can be shipped with the polymer cover for manufacturing into cells. In some embodiments, the polymer cover is kept on for at least about 2 minutes, in further embodiments for at least 4 minutes and in additional embodiments for at least about 6 minutes after lamination/calendering, and if not shipped with the electrode, the polymer sheet can be removed in no more than 40 hours, in some embodiments no more than 8 hours, and in other embodiments no more than about 6 hours. A person of ordinary skill in the art will recognize that additional ranges of polymer peal times within the explicit ranges above are contemplated and are within the present disclosure. In some embodiments, it is desirable to remove any support structure/polymer sheet following sufficient or full completion of the prelithiation reaction, such as to reduce volume and weight of the roll.

In principle, the prelithiation process can be implemented in any type of electrode that can alloy and/or intercalate lithium in a spontaneous reaction. But the prelithiation is generally relevant for action on negative electrodes/anodes, so these embodiments are the focus of the remaining discussion. With respect to negative electrodes, silicon based active materials are of particular significance due to a high irreversible capacity loss and significant swelling upon prelithiation. The resulting lithium ion cells have a selected positive electrode to match with the negative electrode. Suitable positive electrodes and negative electrodes are discussed generally in this section. In the following section, silicon based negative electrodes are discussed in more detail, with particular emphasis on silicon oxide based electrodes, which are also exemplified. Electrode balance is discussed after the section on silicon based negative electrodes.

### Electrode Structures

The electrodes of the cell generally comprise the active material along with a binder and conductive additives. The electrodes are formed into a sheet, dried and optionally pressed to achieve a desired density and porosity. The electrode sheets are generally formed directly on a metal current collector, such as a metal foil or a thin metal grid. For many cell structures, electrode layers are formed on both sides of the current collector to provide for desirable performance in the assembled cell or battery as well as efficient use of the current collectors. The electrode layers on each side of the current collector can be considers elements of the same electrode structure since they are at the same potential in the cell, but the current collector itself, while part of the electrode structure is not generally considered part of the electrode since it is electrochemically inert. Thus, references to the physical aspects of an electrode generally refer to one layer of electrode composition within the electrode structure. An electrically conductive current collector can facilitate the flow of electrons between the electrode and an exterior circuit.

In some embodiments, when the positive electrode or negative electrode uses a high loading level, the density of the electrode can be reduced to provide good cycling stability of the electrode. The density of the electrodes is a function, within reasonable ranges, of the press pressures, although some electrodes can be formed with a desired density and porosity without separate pressing other than used in the layer forming process to adhere the electrode on the current collector. As noted above, negative electrodes can be calendered to smooth the electrode, and relatively mild calender conditions can be used that are observed to smooth the electrode without significantly increasing the active material density or correspondingly lowering the porosity. Generally, the density of the electrodes cannot be arbitrarily increased without sacrificing performance with respect to loading levels while achieving desired cycling performance and capacity at higher discharge rates. The characterization of the specific negative electrode layers and positive electrode layers are presented in the following.

In some embodiments, a current collector can be formed from nickel, aluminum, stainless steel, copper or the like. An electrode material can be cast as a thin film onto a current collector. The electrode material with the current collector can then be dried, for example in an oven, to remove solvent from the electrode. In some embodiments, a dried electrode material in contact with a current collector foil or other structure can be subjected to a pressure from about 2 to about 10 kg/cm² (kilograms per square centimeter). The current collector used in the positive electrode can have a thickness from about 5 microns to about 30 microns, in other embodiments from about 10 microns to about 25 microns, and in further embodiments from about 14 microns to about 20 microns. In one embodiment, the positive electrode uses an aluminum foil current collector. The current collector used in the negative electrode can have a thickness from about 2 microns to about 20 microns, in other embodiments from about 4 microns to about 14 microns, and in further embodiments from about 6 microns to about 10 microns. In one embodiment, the negative electrode uses copper foil or nickel foil as current collector. A person of ordinary skill in the art will recognize that additional ranges of current collector thicknesses within the explicit ranges above are contemplated and are within the present disclosure.

The positive electrode active materials are not generally constrained for use with prelithiated negative electrodes. Suitable positive electrode active materials can comprise, for example, lithium cobalt oxide (LiCoO₂), lithium manganese oxide (LiMn₂O₄), lithium iron phosphate (LiFePO₄), lithium nickel oxide (LiNiO₂), lithium nickel cobalt oxide (LiNiCoO₂), lithium nickel cobalt manganese oxide (LiNiMnCoO₂), lithium nickel cobalt aluminum oxide (LiNiCoAlO₂) and the like. Nickel-rich lithium nickel manganese cobalt oxides (N-NMC) can provide desirable cycling and capacity properties for the lithium ion batteries described herein. In particular, the nickel-rich compositions can be approximately represented by the formula LiNiₓMn_{y}Co_{z}O₂, X+y+z≈1, 0.45≤x, 0.025≤y, z≤0.35, in further embodiments, 0.50≤x, 0.03≤y, z≤0.325, and in 0.55≤x, 0.04≤y, z≤0.3. Note in the art, NMC and NCM are used interchangeably. The amount of nickel can influence the selected charge voltage to balance cycling stability and discharge energy density. For values of x in the range of 0.525≤x≤0.7 a selected charge voltage can be from 4.25V to 4.375V. For values of x in the range of 0.7≤x≤0.9, the selected charge voltage can be from 4.05V to 4.325V. Examples are provided with NMC 811 (x=0.8, y=z=0.1) or NMC 622 (x=0.6, y=z=0.2) with a charge voltage of 4.2V. A person of ordinary skill in the art will recognize that additional ranges of composition and selected charge voltages within the explicit ranges above are contemplated and are within the present disclosure. These nickel-rich compositions have been found to provide relatively stable higher voltage cycling, good capacities and desirable impedance. Various stoichiometries of these materials are commercially available.

As noted above, the positive electrode generally comprises active material, with an electrically conductive material within a binder. The active material loading in the electrode can be large. In some embodiments, the positive electrode comprises from about 85 wt % to about 99 wt % of positive electrode active material, in other embodiments from about 90 wt % to about 98 wt % of the positive electrode active material, and in further embodiments from about 95 wt % to about 97.5 wt % of the positive electrode active material. In some embodiments, the positive electrode has from about 0.75 wt % to about 10 wt % polymeric binder, in other embodiments from about 0.8 wt % to about 7.5 wt % polymeric binder, and in further embodiments from about 0.9 wt % to about 5 wt % polymeric binder.

The positive electrode composition generally can also comprise an electrically conductive additive distinct from the electroactive composition. In some embodiments, the positive electrode can have 0.4 wt % to about 12 wt % conductive additive, in further embodiments from about 0.45 wt % to about 7 wt %, and in other embodiments from about 0.5 wt % to about 5 wt % conductive additive. A person of ordinary skill in the art will recognize that additional ranges of particles loadings within the explicit ranges about are contemplated and are within the present disclosure. The positive electrode active materials are described above. Suitable polymer binders for the positive electrode include, for example, PVDF, polyethylene oxide, polyimide, polyethylene, polypropylene, polytetrafluoroethylene, polyacrylates, rubbers, e.g. ethylene-propylene-diene monomer (EPDM) rubber or SBR, copolymers thereof, or mixtures thereof. Electrically conductive additives are described in detail for the negative electrode, and nanoscale conductive carbon can be used effectively for the positive electrode.

For a particular loading level, the electrode density (of active material) is inversely correlated with thickness so that an electrode with a greater density is thinner than an electrode with a lower density. Loading is equal to the density times the thickness. In some embodiments, the positive electrode of the battery has a loading level of positive electrode active material that is from about 10 to about 120 mg/cm², in other embodiments from about 15 to about 75 mg/cm², in additional embodiments from about 20 to about 70 mg/cm², and in some embodiments from 20 to about 55 mg/cm² In some embodiments, the positive electrode of the battery has an active material density in some embodiment from about 2.2 g/cc to about 4.6 g/cc, in other embodiment from about 2.4 g/cc to 4.4 g/cc, and in additional embodiment from about 2.8 g/cc to about 4.3 g/cc. In further embodiments, the positive electrodes can have a thickness on each side of the current collector following compression and drying of the positive electrode material from about 45 microns to about 300 microns, in some embodiments from about 80 microns to about 275 microns and in additional embodiments from about 90 microns to about 250 microns. A person of ordinary skill in the art will recognize that additional ranges of active material loading level, electrode thickness and electrode densities within the explicit ranges above are contemplated and are within the present disclosure.

### Negative Electrodes

The basic electrode design comprises one or a blend of active compositions, polymer binder, and an electrically conductive diluent. In some embodiments, electrode designs can involve a polymer binder blend and optionally a blend of active compositions as well as nanoscale conductive additives, such as carbon additives. The prelithiation process can be applicable to a range of electrode active materials. Nevertheless, there is a particular interest in silicon based active materials due to their high specific capacity and large irreversible capacity loss, which provide significant commercial interest and significance of the ability to prelithiate. While the active material can be solely a silicon based material or composite, an active material blend can comprise in some embodiments a lesser portion of silicon based material can be used, and in some embodiments majority of silicon based active material, such as a silicon oxide composite, and at least 2.5 weight percent of distinct active graphite. To achieve different commercial objectives of the cells, a wide range of proportions of active materials can be successfully used. A general description of high capacity silicon based active material is found in the '694 patent, cited above.

Also, it has been discovered that stabilization of the electrode cycling with silicon based active materials can obtained with a binder that is solvent based or water based. While graphite can provide electrical conductivity to the electrode, it has also been found that in some embodiments a quantity of distinct nanoscale conductive particles, such as carbon, nevertheless can be significant toward the ability to produce a long cycling negative electrode. The nanoscale conductive material presumably assists with improved electrical conduction through the electrode while lowering the electrical impedance. In general, the nanoscale conductive carbon is not believed to be electrochemically active while the graphite can be electrochemically active. These improved design aspects are then incorporated into electrodes with further previously discovered silicon based electrode improvements.

Significant interest has been directed to high capacity negative electrode active material based on silicon. Silicon based active materials generally have not achieved suitable cycling stability for automotive use for batteries containing significant quantities of silicon. With silicon-based active materials, Applicant has demonstrated successful cycling suitable for consumer electronics applications and the like with cycling up to around 200-300 cycles at values of at least 80% initial capacity, see published U.S. patent application 2015/0050535 to Amiruddin et al., entitled “Lithium Ion Batteries With High Capacity Anode Active Materials for Consumer Electronics,” incorporated herein by reference. Applicant has had particular success with respect to cycling stability has been achieved using materials primarily based on silicon oxide composites. With previous electrolyte formulations, Applicant has used effective electrode designs that can be successfully cycled for more than 800 cycles without a drop in capacity below 80% with cycling over a large voltage range at a reasonable rate, see the '901 application cited above. The successful achievement of long cycling with silicon based electrodes has, among other improvements, has been enabled through the use of supplemental lithium. Applicant, through their predecessor in interest, has noted the significance of supplemental lithium for silicon based anodes for some time. See the '694 patent and the '228 patent. The processing described herein provides significant improvement for efficient manufacturing using supplemental lithium. Evidence supports the comparable cycling using the lithium foil prelithiation and achievement of the equivalent prelithiated compositions. Good cycling has been achieved with 100% silicon oxide based active material, mostly silicon oxide based active material with a small amount of graphitic carbon active material, or a majority silicon oxide based active material with a moderate amount of graphite active material. Even further improved cycling may be achievable with the use of additional graphite active material with corresponding adjustment of the prelithiation.

With silicon based material forming a significant fraction of the active material, an overall capacity of the negative electrode blended active material can be at least about 750 mAh/g, in further embodiments at least about 900 mAh/g, in additional embodiments at least about 1000 mAh/g, in some embodiments at least about 1100 mAh/g, and in other embodiments at least about 1250 mAh/g cycled against lithium metal from 5 millivolts (mV) to 1.5V at a rate of C/3. While a silicon based active material, such as a SiO/Si/C composite, can be used as the sole anode active material, a blended active material can comprise at least about 40 wt % silicon based active material, in further embodiments at least about 50 wt % silicon based active material, in other embodiments from about 55 wt % to about 99 wt % silicon based active material, and in additional embodiments from about 60 wt % to about 95 wt % silicon based active material. Correspondingly, the blended active material can comprise from about 1 wt % graphite to about 65 wt % graphite, in further embodiments from about 2 wt % graphite to about 60 wt % graphite, in additional embodiments from about 3 wt % graphite to about 55 wt %, and in other embodiments from about 5 wt % graphite to about 50 wt % graphite. Desirable graphites are described below. A person of ordinary skill in the art will recognize that additional ranges of specific discharge capacity and concentrations of silicon based active material within the explicit ranges above are contemplated and are within the present disclosure.

In some embodiments, to get even higher cycling stability, it can be desirable to use from 20 wt % to about 40 wt % silicon based active material with the balance being active graphite. For some of these embodiments, the specific capacity of the negative electrode can be from about 550 mAh/g to about 900 mAh/g. The irreversible capacity loss of the overall electrode generally is correspondingly less, and the amount of supplemental lithium can be adjusted accordingly. Nevertheless, the presence of the supplemental lithium provided through prelithiation generally can result in improved cycling performance.

As noted above and described in detail below, suitable silicon based active materials can comprise a composite with a carbon component. The carbon can be present in a relatively low weight percent, so even though it is not believed to be active in the electrochemistry, it can improve electrical conductivity without excessive lowering of the specific capacity. Silicon based active materials are discussed in detail in the following section. A composite refers to a particulate material with components that are intimately combined into an integral material with effective uniformity over appropriate scales, in contrast with blends that involve mixtures held together with a polymer binder. Composite components that can comprise, for example, silicon, oxygen, carbon and the like. While not wanting to be limited by theory, it is not generally believed that a carbon component of a composite with silicon is active in electrochemistry and generally not graphitic, although the activity is an abstract concept given the intimate combination in the composite and the structure may be extremely complex with crystalline and amorphous domains and difficult to evaluate. In any case, the carbon component of a composite material is readily understood by a person of ordinary skill in the art to be distinguishable from the distinct graphite not in a composite in active material blends. The examples below are based on a commercial composite composition believed to be comprising primarily of silicon suboxide with some amounts of elemental silicon crystals and elemental carbon in a combined composite particulate material.

Graphite is available commercially in natural and synthetic forms, and suitable graphite includes either natural or synthetic graphite or the like. Graphite is a crystalline form of carbon with covalently bonded carbon in sheets. As used herein, graphite refers to graphitic carbon without requiring perfect crystallinity, and some natural graphite materials can have some crystalline impurities. But the graphite refers generally to a material dominated by a graphitic structure, as would be recognized in the art. Graphite is electrically conductive along the plane of the covalent carbon sheets that are stacked in the crystal. The crystalline carbon in graphitic forms can intercalate lithium, so that it is an established electrochemically active material for lithium ion batteries, although the graphite particle morphology can influence the efficacy of the graphite for lithium intercalation.

Graphite particles can have average particle diameters from about 1 micron to about 30 microns, in further embodiments from about 1.5 microns to about 25 microns, and in other embodiments from about 2 microns to about 20 microns. In general, it is desirable for the graphite to not include particles greater than the electrode thickness to avoid a bumpy electrode surface, and graphitic particles with a size significantly less than a micron can be less crystalline. In some embodiments, the graphitic carbon can have a D50 (mass median diameter) from about 5 microns to about 50 microns, in further embodiments from about 7 microns to about 40 microns and in additional embodiments from about 10 microns to about 8 microns to about 30 microns. Also, in some embodiments the BET surface area of graphitic carbon active material (which can be evaluated according to ISO 4652) can be from about 1 m²/g to about 50 m²/g, in further embodiments from about 1.5 m²/g to about 35 m²/g and in additional embodiments from about 2 m²/g to about 25 m²/g. A person of ordinary skill in the art will recognize that additional ranges of particle size and surface area for graphitic carbon active materials are contemplated and are within the present disclosure. In comparison, electrically conductive carbon blacks or the like (which have been referred to as paracrystalline) generally have surface areas of at least roughly 40 m²/g to 1000 m²/g or greater.

With respect to the polymer binder, Applicant has obtained reasonable cycling of silicon based cells using high tensile strength binders, e.g., polyimide binder. See the '228 patent. In some embodiments to obtain longer cycling stability, it has been surprisingly found that a polymer binder blend further stabilizes cycling. In particular, a second polymer or combination of polymers providing a lower elastic modulus (corresponding with greater elasticity) can be blended with high tensile strength polyimide. The binder blend generally comprises at least about 50 wt % polyimide, in further embodiments at least about 55 wt % and in other embodiments from about 60 wt % to about 95 wt % polyimide. Similarly, the binder blend generally comprises at least about 5 wt % polymer with a lower elastic modulus, in further embodiments at least about 10 wt %, and in other embodiments from about 12 wt % to about 40 wt % lower elastic modulus polymer, as specified further below. A person of ordinary skill in the art will recognize that additional ranges of polymer quantities within the explicit ranges above are contemplated and are within the present disclosure. The polymers of the blend can be selected to be soluble in the same solvents. Polymer blends effective to achieve good cycling of silicon-based anodes are described further in U.S. Pat. No. 11,094,925 to Venkatachalam et al. (hereinafter the '925 patent), entitled “Electrodes with Silicon Oxide Active Materials for Lithium Ion Cells Achieving High Capacity, High Energy Density and Long Cycle Life Performance,” incorporated herein by reference.

Polyimides are polymers based on repeat units of the imide monomer structure. The polyimide polymer chain can be aliphatic, but for high tensile strength applications, the polymer backbone generally is aromatic with the polymer backbone extending along the N-atom of the polyimide structure. For silicon-based anodes that exhibit significant morphological changes during cycling, thermally curable polyimide polymers have been found desirable for high capacity negative electrodes, which may be due to their high mechanical strength. Table 1 provides suppliers of high tensile strength polyimide polymers, and names of corresponding polyimide polymers.

TABLE 1

| Supplier | Binder |
|---|---|
| New Japan Chemical Co., Ltd. | Rikacoat PN-20; Rikacoat EN-20; |
| | Rikacoat SN-20 |
| DuPont | Kapton ® |
| AZ Electronic Materials | PBI MRS0810H |
| Ube Industries. Corp. | U-Varnish S; U-Varnish A |
| Maruzen petrochemical Co., Ltd. | Bani-X (Bis-allyl-nadi-imide) |
| Toyobo Co., Ltd. | Vyromax ® HR16NN |

The polyimide polymers can have a tensile strength of at least about 60 MPa, in further embodiments at least about 100 MPa and in other embodiments at least about 125 MPa. Some commercial polyimides with high tensile strength can also have relatively high elongation values, which is the amount of elongation tolerated before the polymer tears. In some embodiments, the polyimides can have an elongation of at least about 40%, in further embodiments at least about 50% and in other embodiments at least about 55%. Tensile strengths and elongation values can be measured according to procedures in ASTM D638-10 Standard Test Method for Tensile Properties of Plastics or ASTM D882-91 Standard Test Method for Tensile Properties of Thin Plastic Sheeting, both of which are incorporated herein by reference. Based on values reported by commercial suppliers, the results from these alternative ASTM protocols seem similar to each other for polyimides. A person of ordinary skill in the art will recognize that additional ranges of polymer properties within the explicit ranges above are contemplated and are within the present disclosure.

Suitable more flexible polymer components can be selected to be inert with respect to the electrochemistry of the cell and to be compatible with processing with the polyimide. In particular, suitable more flexible polymer components include, for example, PVDF, carboxy methylcellulose (CMC), styrene-butadiene rubber (SBR), polyacrylic acid (PAA and salts thereof (e.g., lithiated polyacrylic acid (LiPAA)), or mixtures thereof. With respect to polymer properties, some significant properties for high capacity negative electrode application are summarized in Table 2A.

TABLE 2A

| | | Tensile | |
|---|---|---|---|
| | | Strength | ElasticModulus |
| Binder | Elongation | (MPa) | (GPa) |
| PVDF | 5-50% | 30-45 | 1.0-2.5 |
| Polyimide | 30-100% | 60-300 | 2.5-7 |
| CMC | 30-40% | 10-15 | 1-5 |
| SBR | 400-600% | 1-25 | 0.01-0.1 |
| LIPAA | 1-6% | 90 | 1-4 |

PVDF, CMC, and SBR are available commercially from many sources listed in Table 2B.

TABLE 2B

| Supplier | Binder |
|---|---|
| BASF | SBR - Licity 2698 XF |
| Sumitomo | acryalate - Aquacharge |
| Zeon | SBR/aqueous - BM451B |
| Nippon Paper | CMC Sunrose Mac series |
| Daicel | CMC 2200 |

LiPAA can be made from LiOH and commercial polyacrylic acid (PAA). For example, a stoichiometric amount of LiOH can be added to a solution of PAA with one mole of LiOH per monomer unit of PAA. The formation and use of LiPAA is described further in Li et al., “Lithium polyacrylate as a binder for tin-cobalt-carbon negative electrodes in lithium-ion batteries,” Electrochemica Acta 55 (2010) 2991-2995, incorporated herein by reference.

For the polymer binder blend, it can be desirable for the more elastic polymer binder component to have an elastic modulus (alternatively referred to as Young's modulus or tensile modulus) of no more than about 2.4 GPa, in further embodiments no more than about 2.25 GPa, in other embodiments no more than about 2 GPa, and in additional embodiments no more than about 1.8 GPa. A person of ordinary skill in the art will recognize that additional ranges of more elastic polymer component properties within the explicit ranges above are contemplated and are within the present disclosure.

To form the electrode, the powders can be blended with the polymer in a suitable liquid, such as a solvent for dissolving the polymer. Polyimides and PVDF can generally be processed in N-methyl pyrrolidone (NMP), although other suitable organic solvents may be used. Water processable polyimides are commercially available, and these water processable polyimides are suitable for blending with a wider range of other polymers. The particulate components of the electrode, i.e., the active material and nanoscale conductive carbon, can be blended with the polymer binder blend in the solvent to form a paste. The resulting paste can be pressed into the electrode structure.

While the polymer binders described above have facilitated achievement of impressive cycling stability for silicon-based negative electrodes, water-based polymer binders have been developed that can achieve comparable or better cycling performance. In some embodiments, a polymer binder that is water processable is a copolymer of acrylic acid salt monomers (S-PAA), where the cation(S) can be a metal cation, and acrylamide monomers. Desirable polymer binders are found to have both good adhesion with respect to the current collector and good particle to particle cohesion. The S-PAA monomers can contribute good cohesion, and the acrylamide co-monomer can contribute good adhesion. Binders based on a copolymer of S-PAA and acrylamide can be provided with appropriate proportions of the monomers to result in excellent cycling with silicon based negative electrode active materials. Water-based polymer blends effective to achieve excellent cycling of silicon-based anodes are summarized below and are described further in published U.S. patent application 2022/0006090 to Hays et al. (hereinafter the '047 application), entitled “Lithium Ion Cells With Silicon Based Active Materials and Negative Electrodes with Water-Based Binders Having Good Adhesion and Cohesion,” incorporated herein by reference.

The simultaneous achievement of good adhesion and good cohesion is found to be significant for achieving improved cycling. The monomer units of the copolymer binder are an acrylamide and a salt of polyacrylic acid (S-PAA). The salt cation can be a metal cation, such as lithium (LiPAA) or sodium (NaPAA) or potassium (KPAA), although other metals can be used or non-metal cations, such as ammonium NH₄⁺. A mixture of counter ions can be used if desired. S-PAA polymers are found to contribute strong cohesion to the corresponding electrodes. Cohesion can be evaluated for the electrode structure on the current collector with bending around a mandrel with a particular diameter. Adhesion is evaluated using commercial testing equipment with forces applied in a controlled fashion to evaluate the forces to pull the electrode from the current collector. The ratio of monomer units can be selected to achieve a desired balance of adhesive and cohesive stability.

The molar ratio of acrylamide moieties to S-PAA moieties can range from about 5:95 to about 95:5, in further embodiments from about 10:90 to about 90:10, in additional embodiments from about 20:80 to about 80:20, in other embodiments from about 25:75 to about 75:25, and in some embodiments from about 30:70 to about 70:30. With respect to average molecular weight, the copolymer can have in some embodiments an average molecular weight from about 50,000 Daltons to about 5,000,000 Daltons, in further embodiments from about 75,000 Daltons to about 2,000,000 Daltons, and in other embodiments from about 100,000 Daltons to about 1,000,000 Daltons. A person of ordinary skill in the art will recognize that additional ranges of moiety ratios and average molecular weight within the explicit ranges above are contemplated and are within the present disclosure.

While desirable cycling results have been achieved with the copolymers alone as the electrode binders, Applicant has had success in improving binder performance using polymer blends. The copolymers described herein may be useful also in polymer blends. Suitable polymer blends would generally include at least 25 weight percent poly(acrylamide-co-M-PAA), in further embodiments at least about 35 wt %, and in other embodiments from about 40 wt % to about 90 wt %. A person of ordinary skill in the art will recognize that additional ranges within the explicit polymer blend rations above are contemplated and are within the present disclosure. Commercial aqueous electrode binders are sold by Sumitomo Seika Chemicals Co., as Aquacharge®.

For negative electrodes, the active material loading in the binder can be large. In some embodiments, the negative electrode has from about 75 to about 94 wt % of negative electrode active material, in other embodiments from about 77 to about 93 wt % of the negative electrode active material, and in further embodiments from about 80 to about 92 wt % of the negative electrode active material. In some embodiments, the negative electrode has from about 4 to about 20 wt % polymeric binder, in other embodiments about 5 to 19 wt % polymeric binder, and in further embodiments from about 6 to 18 wt % polymeric binder. Also, in some embodiments, the negative electrode comprises from about 1 to about 7 wt % particulate conductive particles, such as nanoscale conductive carbon, in further embodiments form about 1.5 to about 6.5 wt %, and in additional embodiments from about 2 to about 6 wt % nanoscale conductive carbon. A person of ordinary skill in the art will recognize that additional ranges of polymer loadings within the explicit ranges above are contemplated and are within the present disclosure.

For improved cycling negative electrodes, nanoscale conductive additives or combinations thereof, which are particulates, have been found to be particularly desirable. Nanoscale conductive carbon refers generally to particles of high surface area elemental carbon having at least two dimensions of the primary particles being submicron, although nanoscale metal particles can also be used, which can be collectively referred to with nanoscale carbons as nanoscale conductive particulates. Suitable nanoscale conductive carbon includes, for example, carbon black, carbon nanotubes and carbon nanofibers. In some embodiments, the nanoscale conductive carbon additive used in the negative electrode can comprise carbon nanotubes, carbon nanofibers, carbon nanoparticles (e.g., carbon black), or combinations thereof. Other nanoscale conductive additives include, for example, metal nanoparticles, metal nanofibers, metal nanowires, other metal nano-particulates, and combinations thereof, such as silver nanoparticles, silver nanowires and the like. In some embodiments, to achieve improved performance a conductive additive can have a conductivity of at least about 40 S/cm, in some embodiments at least about 50 S/cm, and in further embodiments at least about 60 S/cm. A person of ordinary skill in the art will recognize that additional ranges of particles loadings and conductivities within the explicit ranges about are contemplated and are within the present disclosure.

Electrical conductivity, which is the inverse of resistivity, can be reported by distributors, and the conductivity is generally measured using specific techniques developed by the distributors. For example, measurements of carbon black electrical resistance is performed between two copper electrodes with Super P™ carbon blacks, see Timcal Graphite & Carbon, A Synopsis of Analytical Procedures, 2008, www.timcal.com. Suitable supplemental electrically conductive additives can also be added to contribute to longer term cycling stability. Alternatively, some suppliers describe the conductive carbon concentrations to achieve the conductive percolation threshold.

Carbon black refers to synthetic carbon materials and can alternative be referred to as acetylene black, furnace black, thermal black or other names suggesting the synthesis approach. Carbon black generally is referred to as amorphous carbon, but there are suggestions of small domains with short or medium range order corresponding to graphite or diamond crystal structure in at least some forms of carbon black, but for practical purposes the material can be considered amorphous. Under ISO Technical Specification 80004-1 (2010) carbon black is a nanostructured material. The primary particles of carbon black can be on the order of tens of nanometers or less, but the primary particles are generally hard fused into chains or other aggregates, and the smallest dispersible units can be considered between about 80 nm and 800 nm, which is still submicron. Carbon blacks are available commercially that have been synthesized to provide a desirable level of electrical conductivity, such as Super-P® (Timcal), Ketjenblack® (Akzo Nobel), Shawinigan Black® (Chevron-Phillips), and Black Pearls 2000® (Cabot).

Carbon nanofibers are high aspect ratio fibers that generally comprise graphene layers in plates, cones or other forms, which carbon nanotubes comprise graphene sheets folded into tubes. Carbon nanofibers can have diameters of 250 nm or less and are commercially available, for example, Pyrograf® carbon nanofibers (Pyrograf Products, Inc.) or from American Elements, Inc. Carbon nanotubes have been found to be a desirable conductive additive that can improve cycling performance for either a positive electrode or a negative electrode. Single wall or multiwall carbon nanotubes are also available from American Elements, Inc. (CA, USA), Cnano Technologies (China), Fuji, Inc. (Japan), Alfa Aesar (MA, USA) or NanoLabs (MA, USA).

The negative electrode used in the cells described herein can have high active material loading levels along with reasonably high electrode density. For a particular active material loading level, the density is inversely correlated with thickness so that an electrode with a greater density is thinner than an electrode with a lower density. Loading is equal to the density times the thickness. In some embodiments, the negative electrode of the battery has a loading level of negative electrode active material that is at least about 2.0 mg/cm², in other embodiments from about 4.5 mg/cm² to about 14 mg/cm², in additional embodiments from about 5 mg/cm² to about 13 mg/cm², and in other embodiments from about 5.5 mg/cm² to about 12.5 mg/cm². In some embodiments, the negative electrode of the battery has an active material density in some embodiment from about 0.5 g/cc (cc=cubic centimeters (cm³)) to about 2 g/cc, in other embodiment from about 0.6 g/cc to about 1.5 g/cc, and in additional embodiments from about 0.7 g/cc to about 1.3 g/cc. Similarly, the electrodes with silicon oxide based composite active material can have an average dried thickness of at least about 30 microns, in further embodiments at least about 40 microns, in other embodiment from about 50 microns to about 160 microns and in additional embodiments from about 55 microns to about 140 microns. The resulting silicon oxide based electrodes can exhibit capacities per unit area of at least about 3 mAh/cm², in further embodiments at least about 3.5 mAh/cm² and in additional embodiments from about 3.75 mAh/cm² to about 14 mAh/cm². A person of ordinary skill in the art will recognize that additional ranges of active material loading level and electrode densities within the explicit ranges above are contemplated and are within the present disclosure.

### High Capacity Silicon Based Anode Materials

In exemplified embodiments and embodiments of particular interest, the battery designs herein are based on a high capacity anode active material. Specifically, the anode active materials, or a component thereof if a blend, generally have a specific capacity of at least about 800 mAh/g, in further embodiments at least about 900 mAh/g, in additional embodiments at least about 1000 mAh/g, in some embodiments at least about 1150 mAh/g and in other embodiments from about 1400 mAh/g to about 2500 mAh/g when cycled at a rate of C/10 against lithium metal from 0.005V to 1.5V. As this implies, the specific capacity of negative electrode active material can be evaluated in a cell with a lithium metal counter electrode. In embodiments with an active material blend, the overall specific capacity of the electrode reflects the overall composition. Furthermore, the negative electrodes can exhibit reasonably comparable specific capacities when cycled against high capacity lithium metal oxide positive electrode active materials. In the battery with non-lithium metal electrodes, the specific capacity of the respective electrodes can be evaluated by dividing the battery capacity by the respective weights of the active materials. As described herein, desirable cycling results can be obtained with a combination of a silicon based active material and a graphitic carbon active material with good capacities observed.

Elemental silicon, silicon alloys, silicon composites and the like can have a low potential relative to lithium metal similar to graphite. However, elemental silicon generally undergoes a very large volume change upon alloying with lithium. A large volume expansion on the order of two to four times of the original volume or greater has been observed, and the large volume changes have been correlated with a significant decrease in the cycling stability of batteries having silicon-based negative electrodes.

Commercially available composites of silicon suboxide, elemental silicon and carbon can be used in the cells, as exemplified herein. Also, other formulations of silicon based negative electrode active materials have been developed with high capacity and reasonable cycling properties. Some silicon based compositions are described below that provide potential and promising alternatives to commercially available SiO based compositions. The electrode designs and electrolyte formulations described herein are found to be particularly effective with silicon based negative electrode active materials as well as with blends of silicon based active materials with graphite.

Also, silicon based high capacity materials in a negative electrode of a lithium-based battery can exhibit in some formulations a large irreversible capacity loss (IRCL) in the first charge/discharge cycle of the battery. The high IRCL of a silicon-based anode can consume a significant portion of the capacity available for the battery's energy output. Since the cathode, i.e., positive electrode, supplies all of the lithium in a traditional lithium ion battery, a high IRCL in the anode, i.e., negative electrode, can result in a low energy battery during cycling. In order to compensate for the large anode IRCL, supplemental lithium can be added directly or indirectly to the negative electrode material to offset the IRCL. The processing approaches described herein provide efficient and effective ways to introduce supplemental lithium into the cell.

With respect to optional silicon based active materials, the anode, i.e., negative electrode, of the batteries described herein can use nanostructured active silicon based materials to accommodate better for volume expansion and thus maintain the mechanical electrode stability and cycle life of the battery. Nanostructured silicon based negative electrode compositions are disclosed in the '694 application, the '228 patent, as well as U.S. Pat. No. 9,139,441 to Anguchamy et al. (the '441 patent), entitled: “Porous Silicon Based Anode Material Formed Using Metal Reduction,” incorporated herein by reference. Suitable nanostructured silicon can include, for example, nanoporous silicon and nanoparticulate silicon. Also, nanostructured silicon can be formed into composites with carbon and/or alloys with other metal elements. The objective for the design of improved silicon-based materials is to further stabilize the negative electrode materials over cycling while maintaining a high specific capacity and in some embodiments reducing the irreversible capacity loss in the first charge and discharge cycle. Furthermore, pyrolytic carbon coatings are also observed to stabilize silicon-based materials with respect to battery performance.

Desirable high capacity negative electrode active materials can comprise porous silicon (pSi) based materials and/or composites of the porous silicon based materials. In general, the pSi based material comprises highly porous crystalline silicon that can provide high surface areas and/or high void volume relative to bulk silicon. While nanostructured porous silicon can be formed through a variety of approaches such as electrochemical etching of a silicon wafer, particularly good battery performance has been obtained from nanostructured porous silicon obtained by metal reduction of silicon oxide powders. In particular, the material has particularly good cycling properties while maintaining a high specific capacity. The formation of composites of pSi based material with carbon based material or metal can additionally mechanically stabilize the negative electrode for improved cycling. Additional description of the pSi based material from the reduction of silicon oxide can be found in the '441 patent referenced above.

With respect to the composite materials, nanostructured silicon components can be combined with, for example, carbon nanoparticles and/or carbon nanofibers within an intimate composite material. The components can be, for example, milled to form the composite, in which the materials are intimately associated. Generally, it is believed that the association has a mechanical characteristic, such as the softer silicon coated over or mechanically affixed with the harder carbon materials. In additional or alternative embodiments, the silicon can be milled with metal powders to form alloys, which may have a corresponding nanostructure. The carbon components can be combined with the silicon-metal alloys to form multi-component composites.

Also, carbon coatings can be applied over the silicon-based materials to improve electrical conductivity, and the carbon coatings seem to also stabilize the silicon based material with respect to improving cycling and decreasing irreversible capacity loss. Desirable carbon coatings can be formed by pyrolyzing organic compositions. The organic compositions can be pyrolyzed at relatively high temperatures, e.g., about 800° C. to about 900° C., to form a hard amorphous coating. In some embodiments, the desired organic compositions can be dissolved in a suitable solvent, such as water and/or volatile organic solvents for combining with the silicon based component. The dispersion can be well mixed with silicon-based composition. After drying the mixture to remove the solvent, the dried mixture with the silicon based material coated with the carbon precursor can be heated in an oxygen free atmosphere to pyrolyze the organic composition, such as organic polymers, some lower molecular solid organic compositions and the like, and to form a carbon coating.

As with silicon, oxygen deficient silicon oxide, e.g., SiOₓ, 0.1≤x≤1.9, can intercalate/alloy with lithium such that the oxygen deficient silicon oxide can perform as an active material in a lithium ion battery. In particular, silicon oxide active materials, SiOₓ, 0.5≤x≤1.4 can be effectively sued. These oxygen deficient silicon oxide materials can contain domains with various amounts of silicon, silicon oxide, and silicon dioxide within a composite structure. The oxygen deficient silicon oxide can incorporate a relatively large amount of lithium such that the material can exhibit a large specific capacity.

Silicon oxide based compositions have been formed into composite materials with high capacities and very good cycling properties as described in the '228 patent referenced above. In particular, oxygen deficient silicon oxides can be formed into composites with electrically conductive materials, such as conductive carbons, which surprisingly significantly improve cycling while providing for high values of specific capacity. Furthermore, the milling of the silicon oxides into smaller particles, such as submicron structured materials, can further improve the performance of the materials.

In general, a range of composites can be used and can comprise silicon oxide, carbon components, such as graphitic particles (Gr), inert metal powders (M), elemental silicon (Si), especially nanoparticles, pyrolytic carbon coatings (HC), carbon nano fibers (CNF), or combinations thereof. The component structure may or may not correspond with the structure of the components within the composite material. Thus, the general compositions of the composites can be represented as aSiO-βGr-CHC-dM-eCNF-fSi, where α, β, c, δ, e, and f are relative weights that can be selected such that α+β+c+δ+e+f=1. Generally 0.35<a<1, 0≤β<0.6, 0≤c<0.65, 0≤d<0.65, 0≤e<0.65, and 0≤f<0.65. Certain subsets of these composite ranges are of particular interest. In some embodiments, composites with SiO and one or more carbon based components are desirable, which can be represented by a formula aSiO-βGr-CHC-eCNF, where 0.35<a<0.9, 0≤β<0.6, 0≤c<0.65 and 0≤e<0.65 (d=0 and f=0), in further embodiments 0.35<a<0.8, 0.1≤β<0.6, 0.0≤c<0.55 and 0≤e<0.55, in some embodiments 0.35<a<0.8, 0≤β<0.45, 0.0≤c<0.55 and 0.1≤e<0.65, and in additional embodiments 0.35<a<0.8, 0≤β<0.55, 0.1≤c<0.65 and 0≤e<0.55. In additional or alternative embodiments, composites with SiO, inert metal powders and optionally one or more conductive carbon components can be formed that can be represented by the formula aSiO-βGr-CHC-dM-eCNF, where 0.35<a<1, 0≤β<0.55, 0<<<0.55, 0.1<d<0.65, and 0≤e<0.55. In further additional or alternative embodiments, composites of SiO with elemental silicon and optionally one or more conductive carbon components can be formed that can be represented by the formula aSiO-βGr-CHC-eCNF-fSi, where 0.35<a<1, 0≤β<0.55, 0≤c<0.55, 0≤e<0.55, and 0.1≤f<0.65 and in further embodiments 0.35<a<1, 0≤β<0.45, 0.1≤c<0.55, 0≤e<0.45, and 0.1≤f<0.55. A person or ordinary skill in the art will recognize that additional ranges within the explicit ranges above are contemplated and are within the present disclosure. As used herein, the reference to composites implies application of significant combining forces, such as from HEMM milling, to intimately associate the materials, in contrast with simple blending, which is not considered to form composites.

### Balance of Cathode and Anode

The overall performance of the battery has been found to depend on the capacities of both the negative electrode and positive electrode and their relative balance. Balance of the electrodes has been found to be significant with respect to achieving a particularly high energy density for the battery as well as to achieve good cycling properties. In some embodiments, there may be a tradeoff with respect to achieving longer cycling stability and energy density. To achieve longer cycling stability, it can be desirable to balance the battery to achieve a relatively lower energy density, but with a battery suitable for stable long term use under a broader range of operating parameters. With appropriately selected active materials, desirable electrode designs and improved electrolyte formulations, high energy densities are still achievable while obtaining cycling to more than 800 cycles with no more than 80% capacity drop. The electrode balance can be evaluated in several alternative ways, which can work effectively when properly accounting for the particular evaluation approach.

Testing of active materials can be performed in lithium cells with a lithium metal electrode, and such cells are generally referred to as half-cells, in contrast with lithium ion cells with both electrodes comprising a lithium alloying or intercalation material (referred to as full cells). In a half cell with a silicon based electrode, the lithium electrode acts as the negative electrode, and the silicon based electrode acts as the positive electrode, which is opposite of its usual role as the negative electrode in a lithium ion cell.

The positive electrode active material capacity can be estimated from the capacity of the material which can be measured by cycling the material against lithium metal foil. For example, for a given positive electrode, the capacity can be evaluated by determining the insertion and extraction capacities during the first charge/discharge cycle, where the lithium is de-intercalated or extracted from the positive electrode to a voltage selected based on the material chemistry and the selected charge voltage of the cell design (generally from 4.2V to 4.5V) and intercalated or inserted back into the positive electrode to 2V at a rate of C/20, with a slight adjustment, e.g. generally 0.1V, to a higher charge voltage against the lithium metal based on the voltage of the ultimate anode relative to lithium metal. Similarly, for a given silicon based electrode, the insertion and extraction capacities can be evaluated with a battery having a positive electrode comprising the silicon based active material and a lithium foil negative electrode. The capacity is evaluated by determining the insertion and extraction capacities of the battery during the first charge/discharge cycle where lithium is intercalated/alloyed to the silicon based electrode to 5 mV and de-intercalated/de-alloyed to 1.5V at a rate of C/20. In actual use, the observed capacities can change from the tested capacities due to various factors, such as high rate operation and alteration of voltage range, which can be due to battery design as well as due to composition of the counter electrode not being lithium metal. For some evaluation approaches, a subsequent capacity after the first cycle can be used to evaluate electrode balance, and if desired a greater discharge rate can be used, such as C/3 or C/10. The use of the balance after a formation cycle or a few formation cycles can be desirable in that the balance is based more on conditions during use of the battery.

In most commercially available carbon based batteries, approximately 7-10% excess anode is taken over the cathode to prevent lithium plating. One important concern of too much excess anode is that the weight of the cell increases reducing the energy density of the cell. Compared to graphite which has a first cycle IRCL of ˜7%, high capacity silicon based anodes can have IRCL ranging from about 10% to about 40%. A significant portion of the capacity may become inactive in the cell after the first charge-discharge cycle and add to significant dead weight to the battery. Removing the IRCL through prelithiation is designed to ameliorate these issues.

For high capacity anode materials, the negative electrode irreversible capacity loss generally is greater than the positive electrode irreversible capacity loss, which generates additional lithium availability for the cell. If the negative electrode has a significantly higher irreversible capacity loss than the positive electrode, the initial charge of the negative electrode irreversibly consumes lithium so that upon subsequent discharge, the negative electrode cannot supply enough lithium to provide the positive electrode with sufficient lithium to satisfy the full lithium accepting capacity of the positive electrode. This results in a waste of positive electrode capacity, which correspondingly adds weight that does not contribute to cycling. Most or all of the lithium loss from the net IRCL (negative electrode IRCL minus positive electrode IRCL) can be compensated by supplemental lithium as described above. Effective removal of all or most of the IRCL can be taken into account in the electrode balance.

Following prelithiation of a negative electrode, the electrode may or may not have the IRCL effectively removed. If there is remaining IRCL, the balance can be performed based on the first cycle capacities. If the IRCL is removed, the electrode can have surplus lithium also stored in the electrode. The electrode can then be evaluated in terms of both extractable lithium and capacity to alloy lithium from the positive electrode during charging. For cell designs of particular interest, any extractable lithium in a negative electrode can be considered a lithium reservoir to stabilize cycling, which does not need to be balanced against the positive electrode. During discharge, the lithium reservoir remains in the negative electrode with gradual consumption to replace lithium that is observed to be lost during cycling. The additional capacity of the electrode to alloy with additional lithium during charging can then be used as the capacity to consider during balancing, which basically ignores the lithium reservoir. So even though the total capacity of the negative electrode in principle includes the capacity in the reservoir, the lithium reservoir is not balanced against the positive electrode since it does not take up lithium from the positive electrode during charging.

In summary, the initial capacity of a negative electrode as formed, prior to prelithiation can be considered as C₀=C_{I}+C_{R}+C_{C}, where C_{I} is the specific IRCL, C_{R} is the lithium reservoir after prelithiation and C_{C} is the cycling specific capacity or the charge specific capacity after prelithiation. After prelithiation, C_{C}+C_{R} at a C/3 rate is the negative electrode capacity value to be used for balancing with the positive electrode. C_{C} represents the amount of lithium that the prelithiated negative electrode can accept from the positive electrode during charging, so C_{C}+C_{R} is the amount of lithium in the electrode after charging.

The lithium reservoir can be selected to stabilize cycling for the target cycling number. C_{R} can be referenced to various values, and C₀ provides an appropriate reference for specifying C_{R}. In some embodiments, C_{R} can be from about 0.1% to about 40% of C₀, in further embodiments form about 1% to about 35%, in additional embodiments from about 2.5% to about 33%, in other embodiments from about 5% to about 30%, in some embodiments from about 7.5% to about 27.5% and additionally from about 10% to about 25%. These lower limits and upper limits can be interchanged as desired, such as from about 5% to about 35% or 25%. A person of ordinary skill in the art will recognize that additional ranges within the explicit ranges above are contemplated and are within the present disclosure.

From the perspective of providing stable longer term cycling performance, it can be desirable to balance the electrodes to provide for effective use of both electrode capacities as well as avoiding the plating of lithium metal during cycling. In general, the balance of the electrodes is considered at the time of assembly of the electrodes referencing the initial capacities of the electrodes relative to lithium metal.

In general, battery life can be selected to end when the energy output drops by roughly 20% from the initial capacity at a constant discharge rate, although other values can be selected as desired. For the materials described herein, the drop in capacity with cycling of the negative electrode is generally greater than for the positive electrode, so that the avoidance of lithium metal deposition with cycling suggests a greater excess capacity of the negative electrode to further stabilize cycling. Roughly, if the negative electrode capacity fades about twice as fast as the positive electrode capacity, it would be desirable to include at least 15% additional negative electrode capacity to account for cycling. In the robust battery design, at least about 15% additional negative electrode can be desired at various discharge conditions. In general, the balance can be selected such that the initial negative electrode charge capacity evaluated at a rate of C/20 from an open circuit voltage to 1.5V against lithium is about 110% to about 195%, in further embodiment from about 120% to about 185% and in additional embodiments from about 130% to about 190% relative to the sum of the initial positive electrode charge capacity at a rate of C/20 from an open circuit voltage to the charge voltage of the cell design (generally from 4.2V to 4.6V) plus the oxidation capacity of any supplemental lithium. Alternatively, the electrode balance can be evaluated after prelithiation at a discharge rate of C/10 or C/3 with the negative electrode capacity (including any lithium reservoir following prelithiation) relative to positive electrode capacity from about 110% to about 195%, in further embodiment from about 120% to about 185% and in additional embodiments from about 130% to about 190%. A person of ordinary skill in the art will recognize that additional ranges of balance within the explicit ranges above are contemplated and are within the present disclosure. Such a balance is described in the battery designs described below.

### Cell Assembly

While the prelithiation processes described herein can be used in various production flows, such as steps integrated into a cell assembly process, efficient production based on the processes herein can entail large scale prelithiated electrode material preparation that is stored for subsequent cell assembly. The electrode prelithiation process can be effectively implemented in a roll-to-roll (R2R) format for large scale prelithiation, and such processing can provide desired integral manipulation of process condition to achieve controlled and successful prelithiation. The following discussion focuses on processing from a roll of prelithiated negative electrode structure with a double coated current collector. A person of ordinary skill in the art can readily adapt this discussion to a directly formed sheet format.

Generally, the roll width is selected to correspond with a multiple of an electrode dimension with proper accounting for any edge effects, losses from cutting, other practical considerations and the like. Cutting to form units of electrode for a cell assembly can generally be performed with any reasonable approach. For example, a blade, such as a diamond edge blade, a focused energy beam, such as a laser, or the like can be used to perform the cutting. In some embodiments, a batch process can be used, such as where a significant section is unwound and simultaneously stamped in a press to form a significant plurality of electrode sections that are collected, and the process repeated. In further embodiments, effective and efficient cutting can be performed continuously. In particular, the width can be cut with an appropriately positioned cutter with the movement of the roll unwinding movement, and the length can be cut at selected intervals with an appropriate timing to not significantly interfere with material movement. General cell manufacturing from electrode rolls is described in U.S. Pat. No. 10,424,779 to Bhardwaj et al., entitled “Lithium-Ion Cells and Method of Manufacture,” incorporated herein by reference.

Since the prelithiated electrode material is essentially ready to use, the cutting of the electrode plates can be in a remote location. Shipping the electrode material in roll form prior to cutting may be desirable in some embodiments. As noted above, the cut electrode segments can have the selected size for assembly into the desired cell. For stacked electrodes, each current collector is welded or otherwise attached to at least one conductive tab that are then connected in series or parallel with the other cells in the stack and configured for electrical connection to the sealed cell to an external circuit. For wound electrodes, one or more electrically conductive tabs formed from a selected metal can be attached to the electrode element at a location to allow for connection of the electrode to an appropriate pole of an external electrical connection.

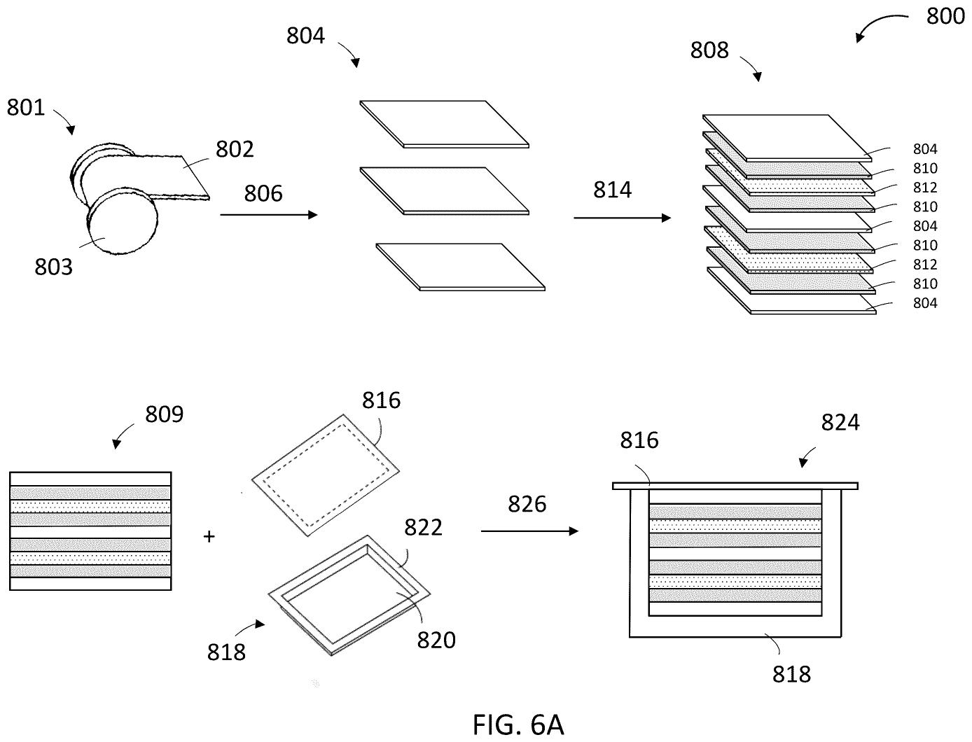

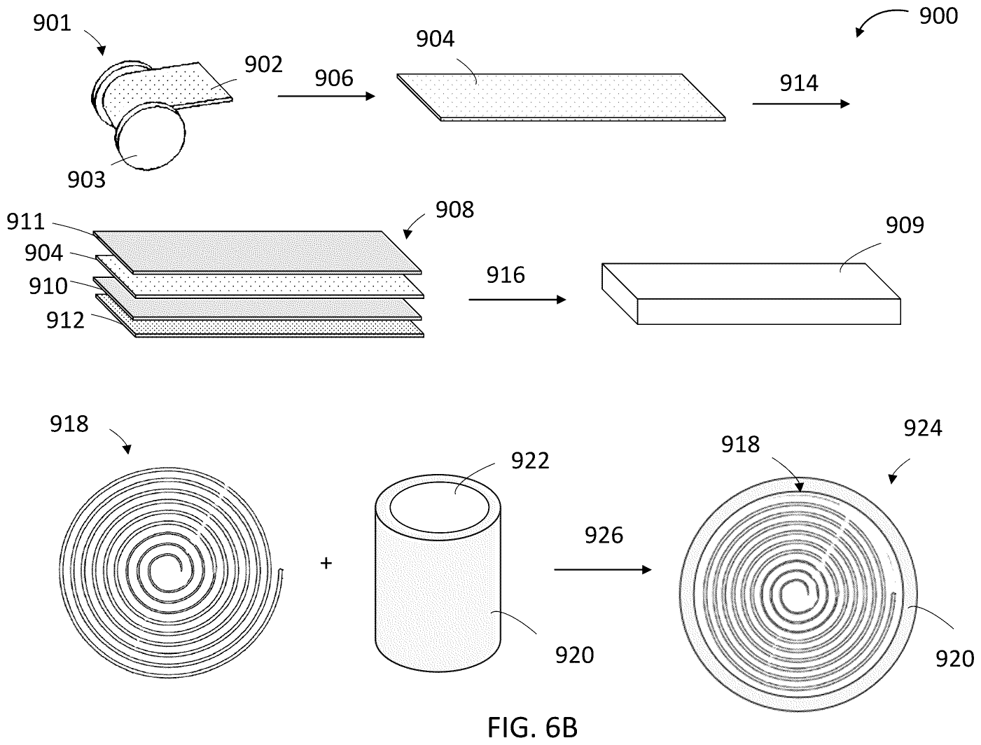

In an automated process, the cut electrode elements can be conveyed to form an electrode stack with a separator between the negative electrode and the positive electrode. A schematic depiction of an exemplary automated process for assembly of a pouch cell is shown in FIG. 6A. Process 800 shows roll 801 of prelithiated negative electrode 802 wound on roller 803, wherein the prelithiated negative electrode structure 802 is prepared according to any of the processes and methods described herein. In this depiction, prelithiated negative electrode structure 802 comprises a prelithiated negative electrode layer formed on each side of a current collector, and for simplicity, additional films, supports, interleaves, etc. are not depicted but may be included. Prelithiated negative electrode structure 802 may have any suitable length and any suitable width, as described above. Prelithiated negative electrode structure 802 is cut widthwise as indicated by 806, and optionally lengthwise, to generate individual prelithiated negative electrode sheets 804. Individual sheets may be cut and/or trimmed as desired, and optionally can be stored for later use. Three individual sheets 804 are shown in this particular depiction. Prelithiated negative electrode sheets 804 can then be assembled into an electrode stack with positive electrode sheets and with separator sheets disposed between each pair of negative and positive electrodes. In alternative embodiments, separator can be folded, with electrodes placed between folds of separator. As shown schematically in FIG. 6A, electrode stack 808 is formed by an automated stacking process represented as 814, wherein three (or more) prelithiated negative electrode sheets are stacked with two positive electrode sheets 812 with three separator sheets 810 disposed in between negative electrode sheets 804 and positive electrode sheets 812 as shown. The electrode sheets and separators may be the same or different sizes depending on the particular design of the pouch cell. In some embodiments, the separators have dimensions larger than either or both of the electrode sheets in order to prevent short circuiting of the pouch cell, and the negative electrode and the positive electrode may or may not be identical in area.

An automated process is used to assemble electrode stack 808 with the electrode sheets and separator appropriately spaced shown as a cross sectional view as electrode stack 809. Electrode stack 809 is placed inside appropriately sized cavity 820 of pouch enclosure 818. Upon proper preparation of the pouch enclosure, electrolyte can be added to the cell. Various aging and pre-sealing processing can be performed as prescribed for the particular cell design. In the schematic depiction, pouch cover 816 is placed in contact with edge 822. and the pouch cover and edge are sealed as represented by 826 to form sealed pouch cell 824. While for commercial embodiments, the sealing and cell assembly processes will follow appropriately. Sealed pouch cell 824 generally includes tabs configured for electrical connection, for example, as described for FIGS. 1A and 1B, but they are not shown in FIG. 6A.

A schematic depiction of an exemplary automated process for assembly of a spirally wound rolled cell assembly is shown in FIG. 6B. Process 900 shows roll 901 of prelithiated negative electrode structure 902 wound on roller 903, wherein the prelithiated negative electrode structure is formed according to any of the processes and methods described herein. In this example, prelithiated negative electrode structure 902 comprises a double sided prelithiated negative electrode with two prelithiated negative electrode layers formed on a current collector, and for simplicity, additional films, supports, interleaves, etc. are not depicted but may be included. Prelithiated negative electrode structure 902 may have any suitable length and any suitable width, as described above. Individual sheets may be cut as desired and may be stored for later use. Prelithiated negative electrode sheet 904 can then be assembled into an electrode stack with a positive electrode sheet, a first separator sheet disposed between the pair of negative and positive electrodes, and a second separator sheet on the outside of the stack, such as on the negative electrode surface. For the embodiment shown in FIG. 6B, electrode stack 908 can be formed by an automated stacking process represented as 914, wherein prelithiated negative electrode sheet 904 is stacked with positive electrode sheet 912 with first separator sheet 910 disposed in between the two sheets and second separator sheet 911 over the prelithiated negative electrode surface, as shown. Positive electrode sheet 912 may be double sided having two positive electrode layers formed on opposing sides of a current collector. With a separator in between the two double sided electrode sheets, the electrode stack may be represented as shown in FIG. 1F. The electrode sheets and the separator may be the same or different sizes depending on the particular design of the rolled cell.

An automated process represented by 916 can be used to assemble electrode stack 909 with the electrode sheets and separator appropriately positioned. Electrode stack 909 is then spirally wound to form rolled electrode stack 918. Rolled electrode stack 918 can then be placed inside appropriately sized cavity 922 of cylindrical container 920, represented as 926, to form rolled cell assembly 924 shown in cross sectional view. Rolled cell assembly 924 may not include electrolyte and may be partially sealed before electrolyte is added. Following addition of electrolyte various resting or process steps can be performed according to the cell design prior to final sealing of the cell. Rolled cell assembly 924 may include additional components for electrical configuration of the final rolled cell but are not shown in FIG. 6B.

### EXAMPLES

### Preparation of Negative Electrode Structures

Negative electrode structures included a negative electrode layer formed from a negative electrode composition deposited on a substrate. The negative electrode composition comprised silicon suboxide/graphite active material at from about 70 wt % to 95 wt % of the composition. The silicon suboxide/graphite active material included silicon suboxide SiOₓ, having an x value of about 1 (SiO) and having an amorphous carbon coating, blended with 30 wt % to 5 wt % natural and/or synthetic electroactive graphite. The blend of negative electrode active material was mixed thoroughly with from about 1 wt % to about 3 wt % of an electrically conductive carbon additive such as acetylene black (Super PR from Timcal, Ltd., Switzerland) and/or carbon nanotubes to form a homogeneous powder mixture.

The negative electrode active material and conductive carbon additive were combined with from about 7 wt % to about 15 wt % binder to form the negative electrode composition. A commercial aqueous acrylic binder was used unless otherwise noted. For some examples, a solvent based binder comprising a blend of polyimide and PVDF (lower elastic modulus binder) in NMP (Sigma-Aldrich) was used. The weight ratio of polyimide to PVDF was about 1 to 0.33. For some examples, a binder comprising styrene butadiene rubber and carboxymethyl cellulose at a weight ratio of about 1 to 0.088 was used.

The negative electrode composition was coated on the substrate to form a thin, wet film which was dried in a vacuum oven. The dried negative electrode layer contained from 2 to 20 wt % binder with the remainder contributed by the powders.

For some examples, a double-sided negative electrode was prepared and used for testing. The double-sided negative electrode consisted of a copper foil substrate with two negative electrode layers, one on each major surface of the copper foil.

### Calendering of Negative Electrodes

For some examples, the substrate with dried negative electrode layer was calendered before joining with the lithium foil. If performed, the initial calendering of just the electrode had a gap from about 30 microns to about 60 microns. Calendering was carried out using a lap press calender consisting of a two-roll compactor of 30 cm of diameter in which the gap between the rolls controls the pressure/force applied. Some embodiments were conducted with a roll-to-roll configuration as described further below. The applied force and gap were varied as described for each the examples. For some examples, the applied force was from about 1 T to about 20 T and the gap was from about 140 microns to about 170 microns. The line speed was held constant at about 0.54 m/min, unless noted otherwise. Roll temperature was set at room temperature unless otherwise noted.

### Preparation of Lithium Transfer Films

Lithium foil was commercially obtained with an appropriate thickness to provide a loading of from about 5% to about 15% over the IRCL of the negative electrode The polymeric substrate was PET film having a thickness from 35 microns to 70 microns.

### Transfer of Lithium

Generally, a negative electrode structure and lithium transfer film were brought together to form an assembly with the negative electrode layer in contact with the lithium layer. The assembly was passed through the two-roll compactor of the lap press calender described above. This step is referred to as transfer or lamination. The PET film was removed immediately or after a specified time interval as described for each of the examples.

For testing lithium transfer and for forming coin cells, a single layer of electrode and lithium was used on the current collector. For forming pouch cells, a double sided electrode structure was used, and the coatings were applied sequentially.

### Preparation of Cells

General methods and materials are described in the '090 and '925 patents cited above. Negative electrodes were tested through their incorporation into coin cells constructed as half cells with a lithium metal electrode or as full cells with positive electrode including an active material comprising nickel-rich lithium nickel manganese cobalt oxide.

The active material for the positive electrodes was a commercially available nickel-rich lithium nickel manganese cobalt oxide having the approximate formula LiNi_{0.8}Mn_{0.1}Co_{0.1}O₂. The positive electrodes had a loading of active material from about 93 wt % to 97.5 wt % blended with 1 wt % to 4 wt % PVDF binder, and 1 wt % to 3 wt % nanoscale carbon. The cathode material was blended with NMP solvent, spread onto an aluminum foil current collector, pressed, and dried. The loading level of positive electrode active material ranged from about 10 mg/cm² to about 30 mg/cm², or from about 18 mg/cm² to about 25 mg/cm².

To form full cells, sections of negative and positive electrodes were cut to size along with separator comprising Celgard® porous polymer or ceramic hybrid membrane. The electrodes with the separator between them was placed in a coin cell enclosure.

Half cells were prepared similarly with lithium foil used instead of the positive electrode.

An electrolyte was placed in the cell and the cell was sealed. The electrolyte included lithium salt LiPF₆ at a concentration of from about 1M to about 2M and non-aqueous solvent including from about 5 wt % to about 40 wt % fluoroethylene carbonate and from about 60 wt % to about 95 wt % selected from one or more of ethylmethyl carbonate, diethyl carbonate, dimethyl carbonate and propylene carbonate.

For some examples, negative electrodes were tested by incorporation into pouch cells having a design similar to that shown in FIG. 1A-1D. The pouch cells were prismatic shaped pouch cells having approximate dimensions, neglecting tabs, of 128 mm×198 mm×6.0 mm (thickness). Positive electrodes included an active material comprising nickel-rich lithium nickel manganese cobalt oxide. The electrodes were formed as described above and cut to suitable dimensions, then placed within the folds of a pleated separator sheet comprising a porous polymer composite coated with a gel-forming polymer. The pouch cells were designed to have a total capacity of about 30 Ah at a discharge rate of C/3 at 30° C.

### Testing and Evaluation of Cells

The coin cells were cycled over a relevant voltage range to evaluate performance. Full cells were cycled by charging from the open circuit voltage to a target voltage of 4.2V and discharging between 4.2V and 2.5V in the first formation cycle and between 4.2V and 2.5V for subsequent cycles. Half cells with lithium foil counter electrode were cycled similarly between 1.5V and 0.005V. With the lithium foil counter electrode used for testing purposes, the electrode with the silicon based material functions as the positive electrode for these batteries, but the electrode with the silicon based material may still be referred to as the “negative electrodes” for simplicity since in a commercial battery these electrodes would be used as negative electrodes with a lithium intercalation composition in the positive electrode. The batteries were discharged at a rate of C/20, C/10, C/5, and C/3 for the 1st cycle, 2nd cycle, 3rd and 4th cycles, and for subsequent cycles, respectively.

The resulting coin cell batteries were tested with a Maccor cycle tester to obtain charge-discharge curve and cycling stability over a number of cycles. Half cells were electrochemically characterized in the range of 0.005 to 1.5V (1 cycle at C/20, 1 cycle at C/10, 2 cycles at C/5, and the rest at C/3).

### Other Lithiation Methods

Negative electrodes were lithiated by other methods for the purpose of comparing with the transfer method. Other methods include a powder method in which lithium powder (SLMP® from Livent Corp.) was applied to the surface of the negative electrode layer in an amount to compensate for about 100% to about 160% of irreversible capacity loss. Another method was an electrochemical method in which a temporary coin cell was assembled with negative electrode and lithium foil counter electrode, and the cell was charged from about 20% to about 40% of the negative electrode capacity (slightly greater than the percentage needed to compensate for irreversible capacity loss). After charging, the temporary coin cell was disassembled to provide an electrochemically lithiated negative electrode. Cycling was carried out using a 1 C charge/1 C discharge rate.

### Example 1—Effects of Calendering Negative Electrode Before Lithiation, Effects of Time to Begin Peeling of Polymeric Substrate to Expose Lithiated Negative Electrode Layer

This example was carried out to assess effects of (1) calendering a prepared negative electrode prior to laminating a lithium layer onto the negative electrode layer, and (2) time to begin removal or peeling of the polymeric substrate after lamination.

Negative electrode structures were prepared by coating the negative electrode composition on each side of copper foil and drying to give a negative electrode structure having a thickness of about 75 microns. Sheets of negative electrodes were calendered under medium or high conditions and thicknesses of the negative electrode layers were remeasured. A lithium transfer film was placed on each negative electrode such that the lithium layer and the negative electrode layer were in contact. The resulting assembly was calendered. The time to begin peeling of the PET polymeric substrate (of the lithium transfer film) was varied from immediate to 2 hours as shown in Table 3. The quality or extent of transfer of the lithium layer to the negative electrode layer was observed for each example. Observations regarding fire or burning of the lithium/negative electrode layer were made. Results are shown in Table 3. For Example 1e, the PET polymeric substrate was peeled immediately from each side of the structure, and the top exposed surface was recovered with the peeled PET. For Examples 1e and 1f, a lower percentage of fire at sheet level was observed, with the chances of fire being 1 in 5 for negative electrodes in the sheet form.

TABLE 3

| | | Negative | | | |
|---|---|---|---|---|---|
| | | Electrode | Time to | | |
| | | Thickness | Begin | Li | |
| Example | Calendering | (micron) | Peeling PET | Transfer | Safety |
| 1a | none | 75 | immediately | complete | caught fire |
| 1b | medium | 71 | immediately | complete | caught fire |
| 1c | medium | 68 | immediately | complete | caught fire |
| 1d | high | 60 | immediately | complete | caught fire |
| 1e | medium | 71 | immediately | complete | recovered one side of |
| | | | | | negative electrode with |
| | | | | | peeled PET |
| | | | | | caught fire during stacking |
| | | | | | lower % of fire at sheet |
| | | | | | level |
| 1f | medium | 71 | few | complete | caught fire when placing |
| | | | minutes | | back PET |
| | | | | | lower % of fires at sheet |
| | | | | | level |
| 1g | medium | 71 | 2 hours | complete | no fire |

### Example 2—Effects of Calendering Conditions

This example was carried out to assess effects of calendering conditions used to transfer the lithium layer to the negative electrode layer.

Sheets of double-sided negative electrodes consisting of copper foil substrate between two negative electrode layers were prepared and calendered using medium conditions with a gap of 50 microns and applied pressure of 3 T. Before calendering, the thickness of each negative electrode layer was 75 microns, and after calendering, the thickness was about 71 microns. A lithium transfer film was placed on each negative electrode layer such that the lithium layer and the negative electrode layer were in contact. The resulting assembly had a thickness of about 193 microns. Assemblies were calendered using a gap of from 150 micron to 200 micron with applied force of from 10 T to 40 T as shown in Table 4. The PET substrate was removed and the quality or extent of transfer of the lithium layer to the negative electrode layer was observed for each example. Results are shown in Table 4.

TABLE 4

| | Gap | Applied Force | |
|---|---|---|---|
| Example | (micron) | (T) | Transfer |
| 2a | 200 | 20 | very little |
| 2b | 190 | 20 | very little |
| 2c | 180 | 20 | very little |
| 2d | 170 | 20 | incomplete |
| 2e | 160 | 20 | incomplete |
| 2f | 160 | 30 | incomplete |
| 2g | 160 | 40 | incomplete |
| 2h | 150 | 20 | complete |
| 2i | 150 | 15 | complete |
| 2j | 150 | 10 | complete |

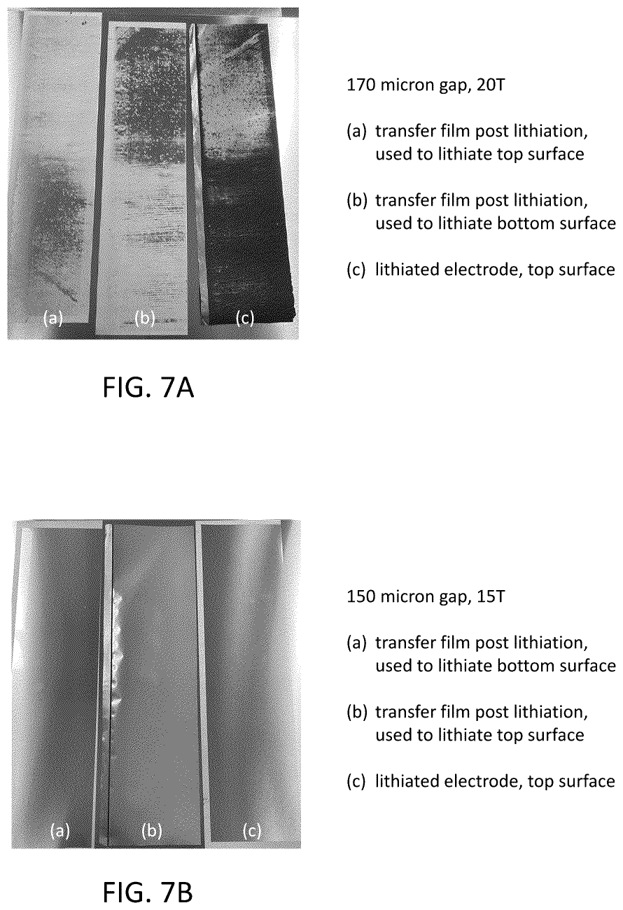

FIG. 7A is an image showing films from Example 2d. Negative electrode (c) shows a surface of one of the prelithiated negative electrode layers (of a double sided negative electrode) following calendering and removal of lithium transfer film (a). Lithium transfer film (b) was used to prelithiate the negative electrode layer not visible for (c). The images show incomplete transfer of lithium from lithium transfer films (a) and (b) to the negative electrode layers.

FIG. 7B is an image showing films from Example 2i. The film in the middle shows a surface of the negative electrode layer (of a double sided negative electrode). The films at the left and the right are polymeric substrates of lithium transfer films that were used to transfer lithium to the negative electrode. The three films show substantially complete transfer of lithium from the lithium transfer films to the negative electrode layers.

### Example 3—Change in Surface Appearance of Lithiated Negative Electrode Layer

This example was carried out to observe changes in the surface appearance after transfer of lithium from the PET film to the negative electrode layer.

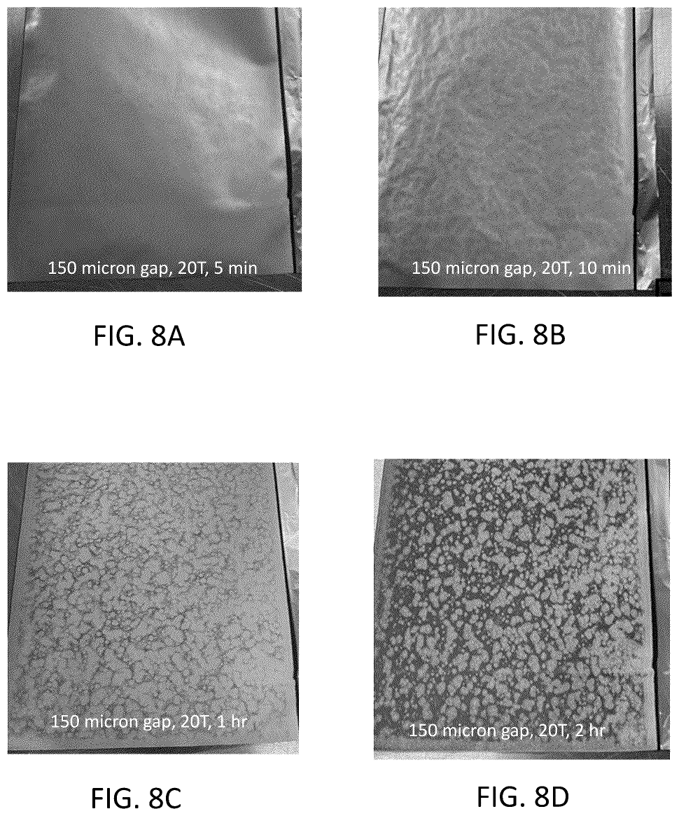

A sheet of negative electrode measuring approximately 130 mm×400 mm was prepared by coating the negative electrode composition on copper foil and drying to give a negative electrode layer having a thickness of about 75 microns. The sheet was calendered using mild conditions to give a negative electrode layer of about 71 microns. A lithium transfer film was placed on the negative electrode such that the lithium layer and the negative electrode layer were in contact. The resulting assembly was calendered with a gap of 150 micron and applied pressure of 20 Ton (20 T). The PET polymeric substrate (of the lithium transfer film) was removed and the surface monitored for 3 hours. Results are shown in Table 5. The surface of the lithiated negative electrode layer is shown after 5 minutes in FIG. 8A, after 10 minutes in FIG. 8B, after 1 hour in FIG. 8C, and after 2 hours in FIG. 8D.

TABLE 5

| | |
|---|---|
| Time | Surface Appearance |

| | | |
|---|---|---|
| 5 | min | little to no change |
| 10 | min | mottled texture appears |
| 15 | min | mottled texture increases |
| 30 | min | mottled texture increases |
| 45 | min | mottled texture increases |
| 1 | hour | mottled texture, darkening |
| 1.5 | hours | mottled texture, increase in darkening |
| 2 | hours | mottled texture, increase in darkening |
| 2.5 | hours | mottled texture, increase in darkening |
| 3 | hours | mottled texture, increase in darkening |

### Example 4—Effects of Calendering Conditions

This example was carried out to assess effects of calendering conditions used to transfer the lithium layer to the negative electrode layer.

Sheets of negative electrodes, measuring approximately 130 mm×400 mm, or 130 mm×1.2 mm, were prepared with each sheet consisting of the negative electrode layer on copper foil. The sheets were calendered using mild conditions. Before calendering, the thickness of the negative electrode layer was 75 microns, and after calendering, the thickness was about 71 microns. A lithium transfer film was placed on each negative electrode layer such that the lithium layer and the negative electrode layer were in contact. The resulting assemblies were calendered using a gap of from 140 micron to 160 micron with applied force of from 3 Tons to 50 Tons as shown in Table 6.

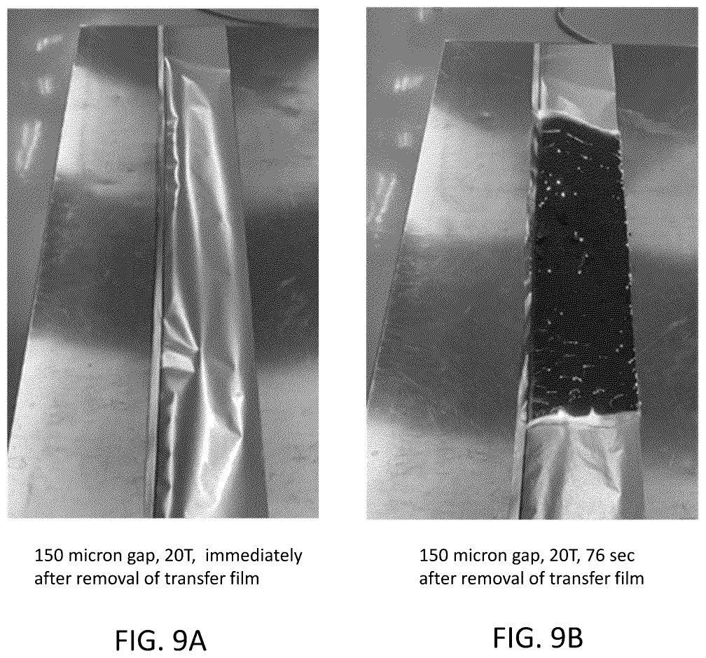

The PET substrate was removed immediately and the lithiated negative electrodes were observed for 2 to 6 hours or until fire or burning of the lithium/negative electrode layer occurred. Results are shown in Table 6. Example 4d, immediately following removal of the PET polymeric substrate, is shown in FIG. 9A. Example 4d, after the ignition, is shown in FIG. 9B.

TABLE 6

| | | Applied | | |
|---|---|---|---|---|
| | Gap | Force | | |
| Example | (micron) | (Tons) | Observation | Li Transfer |
| 4a | 160 | 30 | no fire | Incomplete |
| 4b | 160 | 40 | no fire | Complete |
| 4c | 160 | 50 | no fire | Complete |
| 4d¹ | 150 | 20 | ignited at about | Complete |
| | | | 1 min, 16 sec | |
| 4e | 150 | 15 | caught fire | Complete |
| 4f | 150 | 10 | no fire | Complete |
| 4g | 150 | 8 | no fire | Complete |
| 4h | 150 | 5 | no fire | Complete |
| 4i | 140 | 3 | no fire | Complete |

¹Negative electrode 130 mm × 1.2 m. All others 130 mm × 400 mm.

### Example 5—Effect of Negative Electrode Length

This example was carried out to assess effects of calendering conditions used to transfer the lithium layer to the negative electrode layer.

Negative electrodes consisting of the negative electrode layer on copper foil were prepared as sheets measuring approximately 130 mm×400 mm and 130 mm×1.2 m. A lithium transfer film was placed on each negative electrode layer such that the lithium layer and the negative electrode layer were in contact. The resulting assemblies were calendered using a gap of from 140 micron to 160 micron with applied force of from 1 Tons to 40 Tons as shown in Table 7. The PET substrate was removed immediately and the prelithiated negative electrodes were observed for 2-6 hours or until fire or burning of the lithium/negative electrode layer occurred. Results are shown in Table 7.

TABLE 7

| | | | Applied | |
|---|---|---|---|---|
| | Length | Gap | Force | |
| Example | (mm) | (micron) | (Tons) | Observation |
| 5a | 400 | 160 | 40 | caught fire |
| 5b | 1200 | 160 | 40 | caught fire |
| 5c | 400 | 150 | 10 | caught fire |
| 5d | 1200 | 150 | 10 | caught fire |
| 5e | 400 | 140 | 1 | no fire |
| 5f | 1200 | 140 | 1 | caught fire |

### Example 6—Effects of Calendering Negative Electrode Before Lithiation

This example was carried out to assess effects of calendering a prepared negative electrode prior to laminating a lithium layer onto the negative electrode layer.

A sheet of negative electrode was prepared by coating the negative electrode composition on copper foil and drying to give a negative electrode layer having a thickness of about 75 microns. The sheet was calendered using high conditions to give a negative electrode layer of about 60 microns. A lithium transfer film was placed on the negative electrode such that the lithium layer and the negative electrode layer were in contact. The resulting assembly was calendered with a gap of 150 micron and applied pressure of 17 Tons or 20 Tons. The PET polymeric substrate (of the lithium transfer film) was removed immediately following lithiation. Observations are shown in Table 8.

TABLE 8

| | Gap | Applied Force | |
|---|---|---|---|
| Example | (micron) | (Tons) | Observation |
| 6a | 150 | 20 | caught fire |
| 6b | 150 | 17 | caught fire |

### Example 7—Effects of Calendering Negative Electrode Before Lithiation, Effects of Binder Used in Negative Electrode Layer

This example was carried out to assess effects of (1) calendering a prepared negative electrode prior to lithiation of the negative electrode layer, and (2) binder used in the negative electrode layer.

Negative electrodes were prepared using different negative electrode compositions. One composition included the aqueous acrylic binder and the other composition included the solvent based polyimide binder described above. Two sheets were prepared for each binder, and one sheet of each binder was mildly calendered before lithiation and the other sheet was uncalendered before lithiation. A lithium transfer film was placed on each negative electrode such that the lithium layer and the negative electrode layer were in contact. The resulting assembly was calendered with a gap of 150 micron and applied force of 20 Tons. The PET polymeric substrate (of the lithium transfer film) was removed immediately following lithiation. Observations are shown in Table 9. If the substrate is removed immediately after calendering with the lithium, fire results. This Example demonstrates that the maintenance of the polymer substrate for a period of time after initiation of the prelithiation reaction is significant for avoiding thermal run away regardless of the electrode binder and calendering. Other Examples demonstrate that fire can be avoided by maintaining the polymer substrate for sufficient time to stabilize the prelithiation process.

TABLE 9

| Example | Binder | Calendering | Observation |
|---|---|---|---|
| 7a | aqueous based acrylic | mild | caught fire, 2-3 |
| | | | ignition points |
| 7b | aqueous based acrylic | not calendered | caught fire, 2-3 |
| | | | ignition points |
| 7c | solvent based | mild | ignited immediately |
| | polyimide | | |
| 7d | solvent based | not calendered | ignited immediately |
| | polyimide | | |

### Example 8—Recovering of Lithiated Negative Electrode Layer

This example was carried out to assess effects of recovering the lithiated negative electrode layer with the polymeric substrate that was removed from the assembly.

A negative electrode consisting of copper foil substrate between two negative electrode layers was prepared and calendered using mild conditions. Before calendering, the thickness of each negative electrode layer was 75 microns, and after calendering, the thickness was about 71 microns. A lithium transfer film was placed on each negative electrode layer such that the lithium layer and the negative electrode layer were in contact. Assemblies were calendered using a gap of from 150 micron with applied force of 20 Tons. The PET substrate was removed and replaced on each side of the lithiated negative electrode. The surface appearance of one of the recovered negative electrode layers was monitored for up to 1 hour. Changes in thickness were recorded for the negative electrode layer. Results are shown in Table 10.

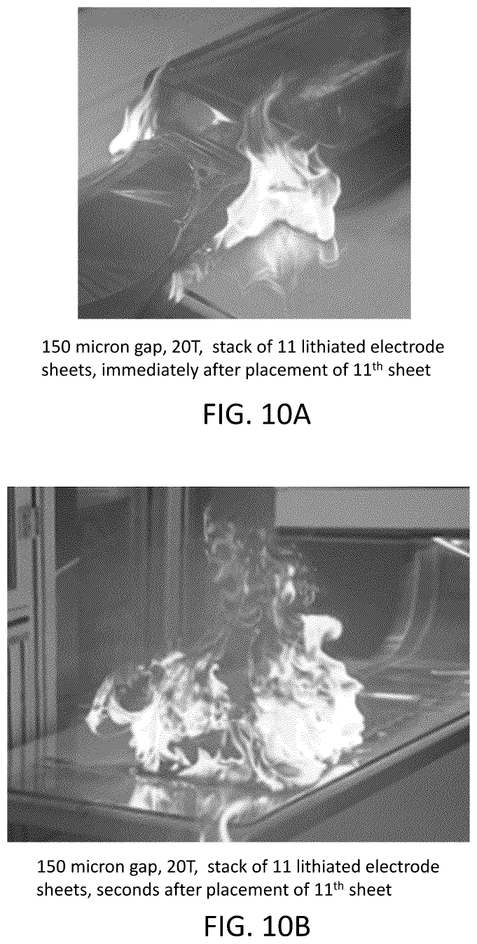

Twelve sheets of the double-sided negative electrode were kept aside and only the top side of the lithiated negative electrode layer was recovered with the PET substrate. The sheets were stacked and the stack caught fire upon placement of the 11th sheet as shown in FIGS. 10A and 10B. These results suggest that heat built up in the stack of electrodes posing a risk of thermal runaway.

TABLE 10

| | Time | Thickness | |
|---|---|---|---|
| Example | (min) | (mm) | Surface Appearance |
| 8a | 0 | 0.087¹ | little to no change |
| 8b | 5 | 0.186 | little to no change |
| 8c | 10 | 0.194 | mottled texture appears |
| 8d | 15 | 0.197 | mottled texture increases |
| 8e | 25 | 0.197 | mottled texture, darkening |
| 8f | 45 | 0.202 | mottled texture, increase in |
| | | | darkening |
| 8g | 60 | 0.202 | mottled texture, increase in |
| | | 0.099¹ | darkening |

¹Without polymer substrate

### Example 9—Effects of Time to Begin Peeling of Polymeric Substrate to Expose Lithiated Negative Electrode Layer

This example was carried out to assess effects of time before removal of the polymeric substrate from the lithiated negative electrode.

A negative electrode consisting of copper foil substrate between two negative electrode layers was prepared and calendered using mild conditions. Before calendering, the thickness of each negative electrode layer was 75 microns, and after calendering, the thickness was about 71 microns. A lithium transfer film was placed on each negative electrode layer such that the lithium layer and the negative electrode layer were in contact. The assemblies were calendered using a gap of from 150 micron with applied force of 20 Tons. The assemblies were observed for up to 2 hours and observations are shown in Table 11. No fires were observed. These results suggest that lithium transfer was essentially complete after roughly 90 minutes.

TABLE 11

| | Time | |
|---|---|---|
| Example | (min) | Observation |
| 10a | 0 | little to no change |
| 10b | 10 | little to no change |
| 10c | 20 | little to no change |
| 10d | 30 | large number of folds begin appearing around |
| | | the sheet; |
| | | polymeric substrate begins peeling at edges |
| 10e | 40 | polymeric substrate continues to peel at edges |
| 10f | 50 | polymeric substrate continues to peel at edges |
| 10g | 60 | polymeric support loosely remains on the |
| | | surface |
| 10h | 75 | polymeric support loosely remains on the |
| | | surface |
| 10i | 90 | polymeric support loosely remains on the |
| | | surface |
| 10j | 105 | polymeric support loosely remains on the |
| | | surface |
| 10k | 120 | polymeric support loosely remains on the |
| | | surface |

### Example 10—Effects of Winding Lithiated Negative Electrodes

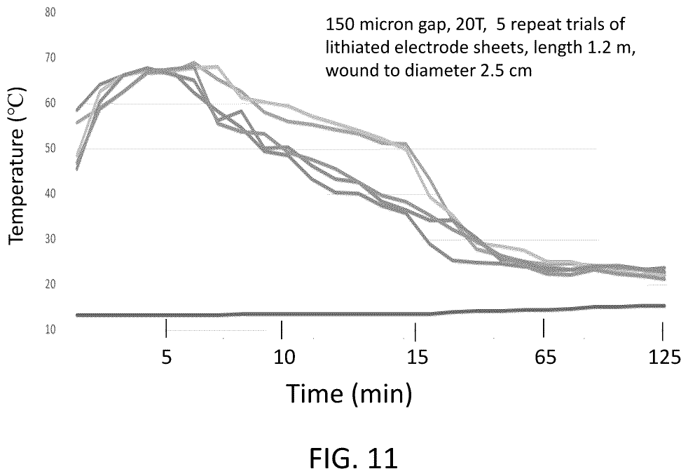

Five negative electrodes consisting of the negative electrode layer on copper foil were prepared as sheets measuring approximately 130 mm×1.2 m. A lithium transfer film was placed on each negative electrode layer such that the lithium layer and the negative electrode layer were in contact. The resulting assemblies were calendered using a gap of 150 micron with applied force of 20 Tons then placed on a metal table. The lithium transfer films were not removed. Each resulting lithiated negative electrode was wound into a roll with inner diameter of 2.5 cm. Infrared temperature was measured by placing a probe a random locations within each roll. Measurements were recorded every minute for the first 15 minutes and every 10 minutes thereafter up to about 2 hours. Results are shown in FIG. 11.

### Example 11—Changes in Thickness Over Time of Negative Electrode Layer after Calendering and Transfer of Lithium to the Layer

This example was carried out to monitor changes in thickness over time, for the negative electrode layer after the negative electrode has been calendered and subsequently laminated with a lithium transfer film to transfer lithium from the film to the layer.

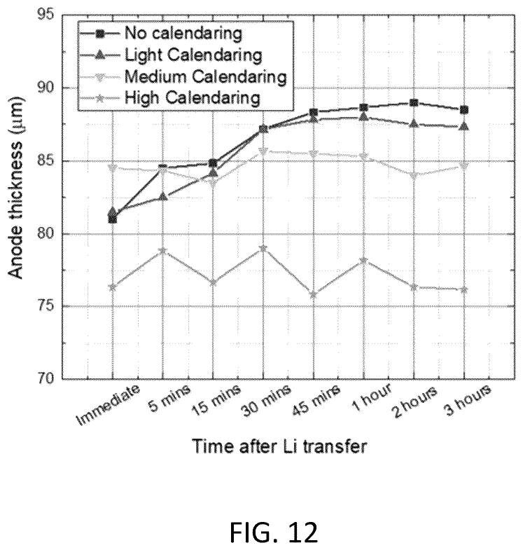

Negative electrodes were prepared by coating the negative electrode composition on copper foil and drying to give a negative electrode layer having a thickness of roughly 60 to 80 microns. The negative electrodes were either uncalendered or calendered to different relative gap reductions relative to electrode thicknesses of 5 microns (light calendering conditions), 10 microns or 15 microns. A lithium transfer film, each film have a lithium layer, was placed on each negative electrode such that the lithium layer and the negative electrode layer were in contact. The resulting assembly was calendered with a gap of 150 microns and force of 15 T. Thickness of negative electrode layer was measured immediately as PET was removed and at time intervals up to 3 hours. (Theoretically, negative electrodes should be ˜85 microns after Li transfer.) Results are shown in FIG. 12.

The results suggest several observations regarding thickness and porosity of the negative electrode layer. The thickness of the initially uncalendered negative electrode layer decreases due to the Li transfer step which then increases up to 89 microns after 2 hours. The uncalendered negative electrode layer may undergo about a 10% change in porosity immediately after the Li transfer step. This assumption may be made because the thickness matches that of the layer that was lightly calendered measured immediately after the Li transfer step. This study confirms that there is a bounce back to the original porosity of the anode when the anode initially undergoes no or light calendering. There is no bounce back when the anode was undergoes medium or high calendering even after 3 hours and the anode thickness stays the same as the immediate transfer.

### Example 12—Cell Performance

This example was carried out to evaluate material changes resulting from the prelithiation step and the accumulation of any lithium reservoir within the prelithiated material.

A lithiated negative electrode referred to as Li Foil was prepared as follows. A single-sided negative electrode of about 3 inches by 2 inches was contacted with Li foil such that the negative electrode layer and the Li foil were in contact. The resulting assembly was calendered using a small calender machine which was mostly gap-driven with applied pressure/force being unknown. The gap was set to about 20 microns to about 30 microns in order to obtain about 100% transfer of the lithium to the negative electrode layer. A 15 mm circular punch was then cut from the lithium negative electrode.

A second 15 mm circular punch was prelithiated electrochemically by forming a temporary coin cell with lithium foil as counter electrode. The temporary coin cell or half cell was cycled between 1.5V and 0.005V and charged from about 20% to about 40% to compensate roughly for IRCL of the negative electrode active material and provide an additional lithium reservoir. After charging, the temporary coin cell was disassembled to provide an electrochemically lithiated negative electrode referred to as “Echem PreLi”. A control cell was formed without prelithiating the negative electrode, and the control cell had an IRCL of about 446 mAh/g.

Coin cells including Echem PreLi and Li Foil PreLi negative electrodes were prepared with lithium foil counter electrode. The half cells were charged to 1.5 V to extract lithium from the negative electrode. Prelithiation capacity, delithiation capacity and Coulombic Efficiency are shown in Table 12. The electrochemical prelithiation capacity was evaluated as the amount of charge delivered to the electrode during electrochemical prelithiation. The Li foil prelithiation capacity is determined by the quantity of lithium delivered per unit mass of active material. The delithiation capacities were evaluated by the charge capacity of the half cells. The coulombic efficiency is found as the delithiation capacity divided by the prelithiation capacity times 100 to convert to a percent.

TABLE 12

| | Prelithiation | Delithiation | Coulombic |
|---|---|---|---|
| | Capacity | Capacity | Efficiency |
| Anode | (mAh/g) | (mAh/g) | (%) |
| Echem PreLi | 707.1 ± 5.0 | 397.1 ± 3.6 | 56.2 ± 0.1 |
| Li Foil PreLi | 665.4 ± 4.0 | 391.2 ± 8.9 | 58.8 ± 1.3 |

The important message here is adding from 20% to 40% of PreLi electrochemically in the presence of electrolyte and approximately an equivalent amount of PreLi through Li/PET in solid state forms similar irreversible Li components and lithium reservoir. In addition, the capacity numbers for the Li/PET method indeed might have lesser value as the individual anodes used for testing were not weighed and an average anode loading from that batch was used to calculate the capacity.

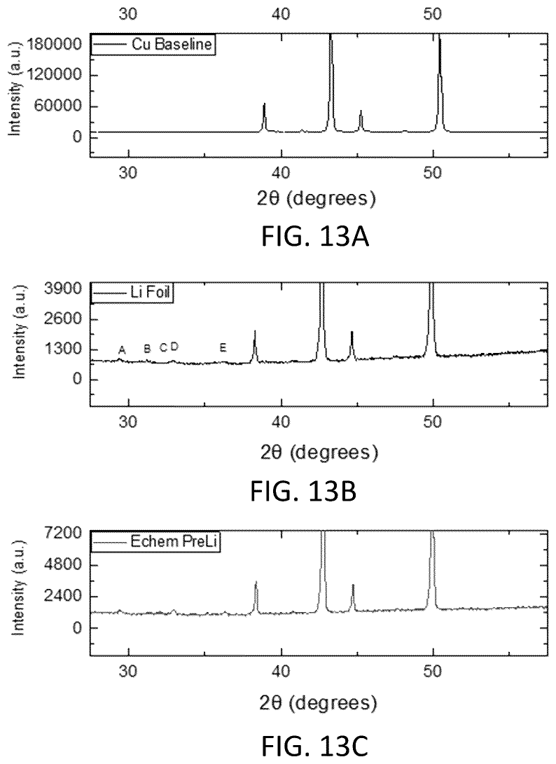

X-ray diffraction (XRD) analysis (Cu Kα) was performed on Li Foil and Echem PreLi electrodes. Plots of intensity in arbitrary units (a. u.) as a function of scattering angle are shown in FIGS. 13A-13C for copper baseline, Li Foil and Echem PreLi, respectively. These results demonstrate a comparable lithium reservoir in the electrodes regardless of the prelithiation approach. This suggests similar structural changes to the silicon based active material regardless of the prelithiation mechanism, which is consistent with the x-ray diffractogram results.

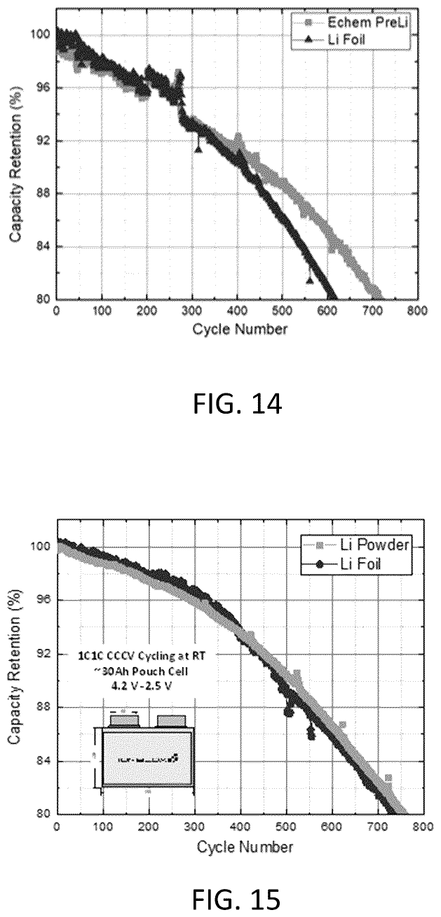

Full coin cells were prepared using Li Foil and Echem PreLi as negative electrodes, and the nickel-rich lithium nickel manganese cobalt oxide described above as positive electrodes. Each coin cell was assembled such that negative electrode and positive electrode were combined to give an N/P ratio or load balancing of about 110-130% relative to the positive electrode. The coin cells were cycled over a voltage window of 4.2V to 2.5V. Each coin cell was charged from its open circuit voltage to a target voltage of 4.2V, then discharged between the target voltage and 2.5V. Cycling was carried out until the coin cells reached about 80% of initial capacity. FIG. 14 is a plot of percent capacity retention as a function of cycle number for the coin cells.

A lithiated negative electrode referred to as Li Powder was prepared by adding lithium powder (SLMP®, Livent Corp.) to the surface of the negative electrode layer. The amount of lithium powder added to the negative electrode layer was over the amount to compensate for the IRCL of the negative electrode active material.

Negative electrode structures were prepared by coating the negative electrode composition on each side of copper foil and drying to give negative electrode structures. Before calendering, the thickness of the negative electrode layer was 75 microns, and after calendering, the thickness was about 71 microns. Sheets of the negative electrode structures were lithiated by calendering with the lithium transfer film using a gap of 140-160 microns and a force of 1-20 Tons. This lithiated negative electrode is referred to as “Li foil”.

Pouch cells were prepared using Li Foil and Li Powder as negative electrodes, and the nickel-rich lithium nickel manganese cobalt oxide described above as positive electrodes. The pouch cells were prismatic shaped pouch cells having approximate dimensions, neglecting tabs, of 128 mm×198 mm×6.0 mm (thickness) and were designed to have a total capacity of about 30 Ah at a discharge rate of C/3 at 30° C. Each pouch cell was assembled such that negative electrode and positive electrode were combined to give an N/P ratio or load balancing of about 110-130% relative to the positive electrode.

The pouch cells were cycled at room temperature and over a voltage window of 4.2V to 2.5V. After charging from an open circuit voltage to a target voltage of 4.2V, the pouch cells were cycled using a 1C1C constant current constant voltage (CCCV) method between the target voltage and 2.5V. Cycling was carried out until the pouch cells reached about 80% of initial capacity. FIG. 15 is a plot of percent capacity retention as a function of cycle number for the pouch cells.

These results demonstrate a comparable lithium reservoir in the electrodes regardless of the prelithiation approach. Both discharge capacities are greater than would be expected based on the irreversible capacity loss from cycling. This indicates that at the lithium loading provided during the prelithiation process does not induce the full extent of the irreversible changes to the negative electrode that is obtained from a full charge-discharge cycle. But this is not indicative of any detrimental effect of the prelithiation since the remaining lithium is in a readily accessible reservoir that compensates at the later time of full cycling to compensate for the remaining, not previously compensated, irreversible capacity loss. However, the electrochemical prelithiation is performed in the presence of electrolyte, which is expected to result in subtle different material changes, which have not yet been elucidated.

### Example 13—Comparison of Commercially Available Lithium Foil

Prelithiated electrodes were prepared from lithium foils obtained from two different commercial suppliers, referred to as Li Foil A and Li Foil B. While the thermal properties were significantly different, safe prelithiation was carried out with each foil.

It is believed that Li Foil A was produced by extrusion of lithium as a foil and the lithium was not passivated. It is believed that Li Foil B has a layer of lightly passivated (CO₂) lithium on PET. Li Foil A did not include a release layer on the lithium layer, and Li Foil B did include a release layer. The foils were used to lithiate negative electrode sheets having a length of about 1.2 m. After lithiation, the Li foils were not removed and each assembly was wound into a roll with inner diameter of 2.5 cm. Infrared temperature was measured by placing a probe a random locations within each roll. Temperature was recorded as a function of time up to about 2 hours.

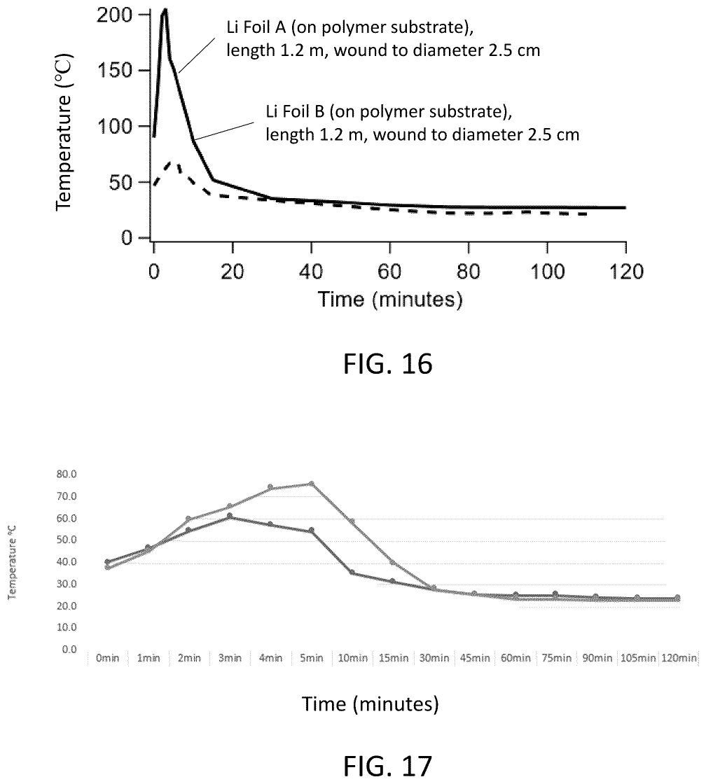

The heat generation as a function of time is shown in FIG. 16. The negative electrode layer lithiated with Li Foil A turned black, and the layer lithiated with Li Foil B did not. The temperature of the negative electrode sheet lithiated with Li Foil A spiked to greater than 200 within less than 10 minutes. The roll was opened and the lithiated negative electrode layer appeared reddish brown indicating the formation of Li₃N. The negative electrode layer lithiated with Li Foil A generated a total heat of 33.5 BTU/m2. The negative electrode layer lithiated with Li Foil B spiked to about 70° C. and generated a total heat of 8.7 BTU/m2. The temperature profiles were similar after about 30 minutes. Even though one sample exhibited a significant heat spike, both electrodes were successfully prelithiated without damage to the electrodes.

### Example 14—Effect of Binder on Lithiated Negative Electrode Layers

This example was carried out to investigate the effects of different binders used to formulate the negative electrode layer.

Negative electrode compositions were prepared with different binders described above. Negative electrode sheets measuring approximately 130 mm×1.2 m were prepared. A lithium transfer film was placed on each negative electrode layer such that the lithium layer and the negative electrode layer were in contact. The resulting assemblies were either uncalendered or mildly calendered using a gap of from 140 microns to 160 microns with an applied force of from about 10 T to about 20 T. The PET substrate was removed either immediately or after 2 hours, and the lithiated negative electrodes were observed for up to 2 hours or until fire or burning of the lithium/negative electrode layer occurred. Binders, processing conditions and results are shown in Table 13.

TABLE 13

| | | | Time to | |
|---|---|---|---|---|
| | | | Begin | |
| Example | Binder | Calendering | Peeling PET | Safety |
| 11a | polyimide/PVDF | none | immediately | caught |
| | weight ratio 1:0.33 | | | fire |
| 11b | polyimide/PVDF | mild | immediately | caught |
| | weight ratio 1:0.33 | | | fire |
| 11c | polyimide/PVDF | mild | after 2 | no fire |
| | weight ratio 1:0.33 | | hours | |
| 11d | styrene butadiene | mild | after 2 | no fire |
| | rubber/carboxymethyl | | hours | |
| | cellulose | | | |
| | weight ratio 1:0.088 | | | |
| 11e | water based acrylic | mild | after 2 | no fire |
| | | | hours | |

### Example 15—Lithiation of Graphite Electrodes

This example was carried out to evaluate lithiation of graphite electrodes. A negative electrode composition was prepared by blending 90 wt % graphite and 5 wt % PVDF binder in NMP. The negative electrode composition was coated on copper foil, pressed and dried to remove solvent to give a negative electrode layer comprising 90 wt % graphite, 5 wt % PVDF binder, and 5 wt % conductive carbon. Thickness of the graphite layer was about 165 microns and the graphite loading was about 12.0 mg/cm². The approximate dimensions of the negative electrode were 130 mm×1.2 m. A lithium transfer film was placed in contact with the negative electrode layer and the resulting assembly was calendered using a gap of 200 micron with applied force of about 2 T. The amount of lithium corresponded to 25-40% of the graphite capacity. The lithiated graphite electrode was wound into a roll having a 2.5 cm core and temperature of the roll was monitored for 2 hours. Measurements were recorded every minute for the first 5 minutes and every 15 minutes thereafter up to about 2 hours. Results for two separate trials are shown in FIG. 17. The PET support was then removed and complete transfer of lithium to the graphite layer was observed.

### Example 16—Change in Temperature for Roll-to-Roll Transfer Process

A negative electrode consisting of copper foil substrate between two negative electrode layers was prepared with dimensions of about 345 mm (width) by about 400 m (length). The negative electrode was calendered using a gap of from 140 microns to 160 microns with applied force of from about 10 T to about 20 T. Before calendering, the thickness of each negative electrode layer was 75 microns, and after calendering, the thickness was about 71 microns.

Lithiation of the double sided negative electrode was carried out using an apparatus similar to that described for the process shown in FIG. 5A. The apparatus was set up such that the lithium transfer films were not removed and air from fans was instead directed to the winder roller 644. The negative electrode in the form of a roll was loaded onto an unwinder roller 602. Lithium transfer films were loaded onto upper and lower unwinder rollers 608 and 612. The lithium transfer films were brought into contact with the negative electrode layers using deflection rollers to facilitate contact. The resulting assembly travelled in a forward direction with a line speed of about 1.5 m/min and passed through a pair of calender rollers separated by a gap of 120 microns and configured to deliver a force of about 5 MPa. After calendaring, the lithiated assembly was taken up by winder roller 644. An infrared gun shown as temperature measurement device 650 was positioned to measure the outer surface, referred to as the outside temperature, of the exposed lithiated negative electrode layer as it was taken up by the roller. Outside temperature of the lithiated negative electrode was recorded as a function of length and time.

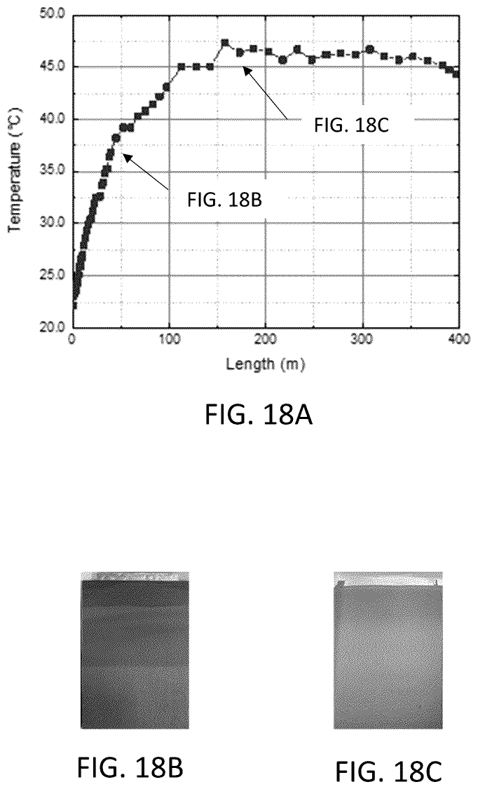

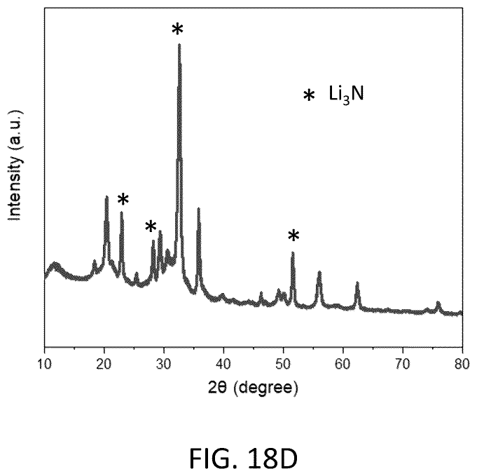

FIG. 18A shows plots of outside temperature as a function of length. The data suggests that outside temperature increases and plateaus at about 45° C. This temperature is reached at about 100 meters and 75 minutes, or at about 150 meters and 100 minutes. Thus, temperature increased as prelithiating electrode is accumulated on the take up roll, but the cooling mechanism was successful to limit the heating.

FIGS. 18B and 18C are images obtained at 2× magnification showing cross-sections of the lithiated negative electrode layer at about 37° C. and about 46° C., respectively, corresponding to the data shown in FIG. 18A. The lithiated negative electrode layer at the higher temperature shown in FIG. 18C appears lighter and shows reddish brown coloration which may be due to formation of Li₃N from reaction of Li with N₂. The reddish brown coloration does not seem to be observed if the lithiation layer is below 40° C. As noted above, the red color suggests amorphous LiN, although a mixture of crystalline and amorphous may be suggested. An x-ray diffractogram of the reddish material removed from the electrode surface is presented in FIG. 18D. Some of the scattering peaks may correspond with alpha-Li₃N. Generally, the formation of lithium nitride would not be expected at these temperatures, so these results suggest that perhaps the electrode catalyzes the reaction to form lithium nitride or other undesirable side product.

The negative electrode described above for this example was prepared as a double sided structure with dimensions of about 345 mm (width) by about 10 m (length). The negative electrode in the form of a roll was loaded onto the lower unwinder roller and a lithium transfer film of similar dimensions was loaded onto the upper unwinder roller. The negative electrode layer and the lithium layer were brought into contact. The resulting assembly traveled in a forward direction with a line speed of about 1.5 m/min and passed through a pair of calender rollers separated by a gap of 120 microns and configured to deliver a force of about 5 MPa. The lithiated roll was then stored at room temperature. After 3 hours, the PET substrate was removed and the color of the lithiated roll did not seem to change.

A second roll of the negative electrode was prepared and lithiated under the same processing conditions. The lithiated roll was then stored at 60° C. After 3 hours, the PET substrate was removed and the color of the lithiated roll (the negative electrode layer) changed to reddish brown confirming the formation of Li₃N at high temperatures.

### Example 17—Effects of Line Speed on Roll-to-Roll Transfer of Lithium

This example was carried out to investigate the effects of line speed on the transfer of lithium from lithium transfer film to negative electrode layers.

Negative electrodes consisting of copper foil substrate between two negative electrode layers were prepared and calendered as described for Example 16 except that the widths of the electrodes were 173 mm and the lengths were 100 m, 60 m and 48 m. Lithiation was carried out using the apparatus described for Example 16, and a similar process was used with the calender rollers separated by a gap of 120 microns and configured to deliver a force of about 2 MPa. The accumulator section was equipped with two cooling fans. The negative electrode with length of 100 m was lithiated at a line speed of 1.5 m/min. The negative electrode with length of 60 m was lithiated at a line speed of 2 m/min, and the negative electrode with length of 48 m was lithiated at a line speed of 3 m/min. The outside roll temperature was recorded as described for Example 16. An inside roll temperature was recorded for each electrode using a thermocouple attached to a surface at the middle of a lithiated negative electrode layer, after the first turn of the assembly as it was taken up by the roller. Outside and inside temperatures of the lithiated negative electrodes were recorded as a function of length and time. An asymptotic model was used to generate extrapolated values out to 500 m. The calculations suggest that temperature levels off from about 42° C. to about 48° C. and after about 100 m.

### Example 18—Effects of Line Speed on Roll-to-Roll Transfer of Lithium

This example was carried out to investigate the effects of line speed and sheet length on the transfer of lithium from lithium transfer film to negative electrode layers.

Negative electrodes consisting of copper foil substrate between two negative electrode layers were prepared and calendered as described for Example 16 except that the widths of the electrodes were 345 mm and the lengths were 200 m and 300 m. Lithiation was carried out using the apparatus described for Example 16, and a similar process was used with the calender rollers separated by a gap of 120 microns and configured to deliver a force of about 5 MPa. The accumulator section was equipped with three cooling fans. The negative electrode with length of 200 m was lithiated at a line speed of 2.0 m/min, and the negative electrodes with length of 300 m was lithiated at a line speed of 1.5 m/min. The outside temperature was recorded as described for Example 16 and the inside temperature was recorded as described for Example 17.

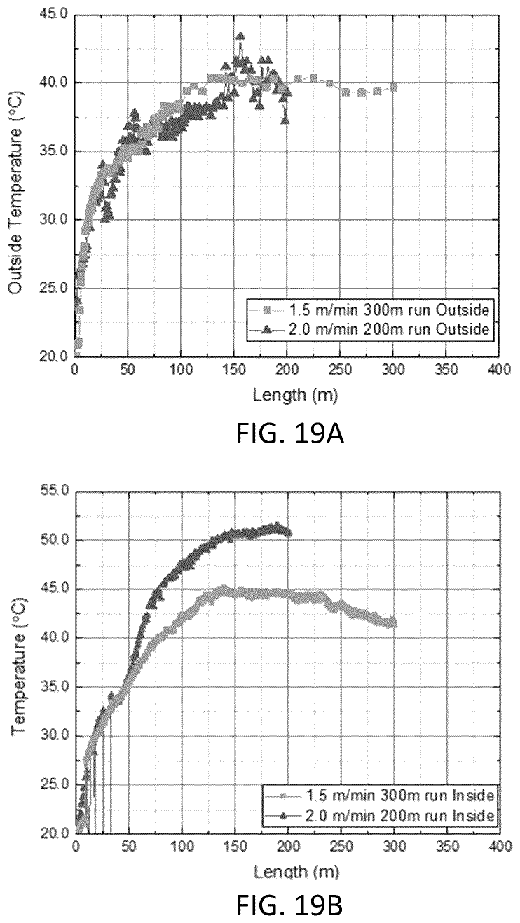

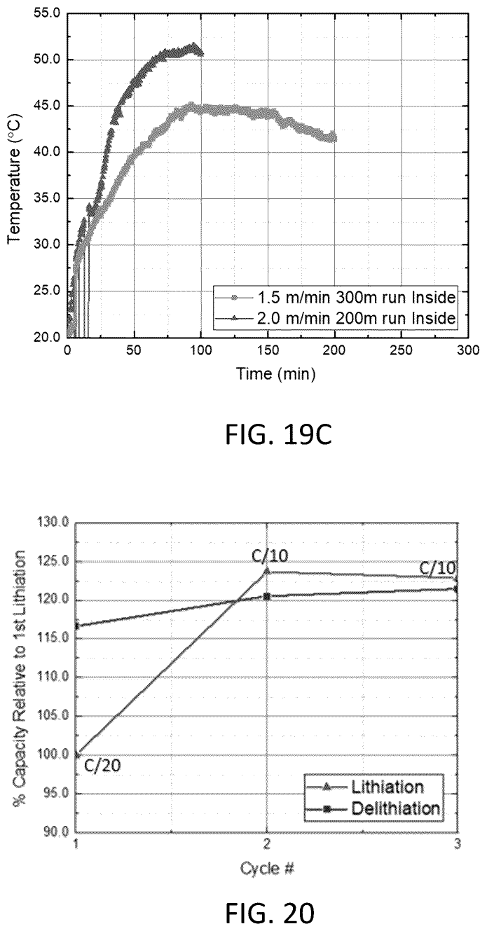

FIG. 19A shows plots of outside temperature as a function of length for the two films. FIG. 19B shows plots of inside temperature as a function of length for the two films, while FIG. 19C shows a plot of inside temperature as a function of time for the two films. For the 200 m length roll at 2.0 m/min, the inside temperature was about 10° C. higher than the outside temperature which may suggest additional cooling can be desirable at 2.0 m/min line speed. For the 300 m length roll at 1.5 m/min, differences of about 7° C. on the outside and 3° C. on the inside were observed. The outside temperature plateaued after about 150 m irrespective of line speed, and the inside temperature plateaued after about 100 minutes of lithium transfer and decreased over time as the calendaring length increased. Run-to-run variations may result from differences in electrode loading, thickness of the lithium transfer film (lithium layer and/or support), cooling fans and room temperature and humidity.

Based on the modeling described for Example 17 and the longer-length temperature data measured as shown in FIG. 19A, it seems that the temperature measured on the outside saturates after a certain length such as about 100 m collected on a 6 inch core.

The roll-to-roll data for prelithiation as described in Examples 16, 17, and 18 show:
a. Runs with lengths of 200 m, 300 m, and 400 m have been achieved.
b. For the wound prelithiated roll, the temperature inside the roll was found to be higher than that of the outside, which may suggest providing additional cooling.
c. Higher temperatures were observed for the higher transfer speeds such that improved cooling would be advantageous.
d. Temperature as a function of length or time saturates for a given transfer speed with appropriate cooling. This suggests that for a steady state process, any roll length or pre-Li time may be possible.

Additional cooling can be designed into systems based on the measurements described herein.

### Example 19—Availability of Lithium for Prelithiated Negative Electrode

A prelithiated negative electrode was prepared as described in Example 12. A 15 mm circular punch of the prelithiated negative electrode was used to assemble a temporary coin cell with lithium foil as counter electrode. The temporary coin cell or half cell was cycled at a rate of C/20 to 0.005V to lithiate the prelithiated negative electrode. The half cell was then cycled at a rate of C/20 to 1.5V to delithiate the negative electrode. The percent lithium capacity extracted was about 116% which suggests the presence of excess lithium available through prelithiation in addition to satisfying the IRCL. Thus, the prelithiation provide more lithium than compensated for the IRCL of the electrode. A plot of percent capacity relative to the first lithiation cycle versus cycle number is shown in FIG. 20.

### Further Inventive Concepts

A1. A negative electrode structure separate from an electrochemical cell structure comprising:
a current collector,
an electrode on a surface of the current collector, the electrode comprising an active material that comprises an active material having a voltage against lithium metal of no more than about 1V at a value of lithium uptake of 10% of capacity, wherein the active material has been prelithiated in an electrolyte-free environment such that the irreversible capacity loss for a charge and discharge cycle against a lithium metal electrode has been eliminated.

A2. The negative electrode structure of inventive concept A1 wherein a polymeric support is disposed on the electrode.

A3. The negative electrode structure of inventive concept A1 further comprising an additional electrode on an opposing surface of the current collector.

A4. The negative electrode structure of inventive concept A1 wherein the electrode further comprises a polymer binder and electrically conductive particles.

A5. The negative electrode structure of inventive concept A1 wherein the negative electrode structure is in the form of a sheet suitable for stacking.

A6. The negative electrode structure of inventive concept A1 wherein the negative electrode structure is in roll form.

A7. The negative electrode structure of inventive concept A1 wherein the electrode comprises extractable lithium corresponding to at least about 5% of the electrode capacity.

A8. The negative electrode structure of inventive concept A1 wherein after cutting the negative electrode to a desired size and removal of any optional polymer support, the negative electrode structure is ready for assembly into lithium ion cell.

A9. The negative electrode structure of inventive concept A1 wherein the active material comprises at least about 20 wt % silicon-based active material

A10. The negative electrode structure of inventive concept A9 wherein the silicon based active material comprises SiOₓ, 0.4<x<1.6.

A11. The negative electrode structure of inventive concept A9 wherein the active material further comprises from about 3 wt % graphite to about 80 wt % graphite.

A12. The negative electrode structure of inventive concept A1 wherein the electrode further comprises a polymer binder comprising polyimide.

A13. The negative electrode structure of inventive concept A1 wherein the electrode further comprises a polymer binder comprising a metal salt of a copolymer of polyacrylic acid.

A14. The negative electrode structure of inventive concept A1 wherein the electrode further comprises nanoscale conductive carbon.

A15. The negative electrode structure of inventive concept A1 wherein the electrode comprises from about 70 wt % to about 97 wt % active material, from about 2 wt % to about 28 wt % polymer binder and from about 1 wt % to about 7 wt % conductive particulates.

A16. The negative electrode structure of inventive concept A1 wherein the electrode comprises from about 75 wt % to about 94 wt % active material, from about 5 wt % to about 23 wt % polymer binder and from about 1 wt % to about 5 wt % conductive particulates.

A17. The negative electrode structure of inventive concept A1 wherein the electrode has an average thickness prior to prelithiation from about 20 micron to about 140 microns.

A18. The negative electrode structure of inventive concept 17 wherein the prelithiated electrode has a thickness at least about 10% greater than the electrode thickness prior to prelithiation.

A19. The negative electrode structure of inventive concept A1 wherein the current collector comprises copper.

A20. The negative electrode structure of inventive concept A19 wherein the current collector has a thickness from about 4 microns to about 14 microns.

B1. A method for forming a lithium ion cell, the method comprising:
cutting a negative electrode structure from a roll of prelithiated negative electrode structure to form a cut electrode structure, wherein the prelithiated negative electrode structure comprises a metal current collector with a prelithiated negative electrode on both surfaces of the current collector, wherein the size of the cut electrode is selected for assembly into the lithium cell, and wherein prelithiation of the prelithiated negative electrode structure is performed in an electrolyte free environment,
forming a cell structure comprising 1) a stack of plurality of the cut negative electrode structures, a separator, and positive electrode structures, wherein separator is between each cut negative electrode structure and an adjacent position electrode structure to avoid a short circuit between the positive electrode structure and the negative electrode structure, or 2) a roll of cut electrode structure, separator and counter electrode structure with a first separator between the cut electrode structure and the counter electrode structure and a second separator on an exposed surface of the electrode or counter electrode; and
placing the formed cell structure into a container.

B2. The method of inventive concept B1 wherein the prelithiated negative electrode is prelithiated with lithium in an amount greater than the irreversible capacity loss of the electrode.

B3. The method of inventive concept B1 wherein the prelithiated negative electrode has an extractable lithium reservoir.

B4. The method of inventive concept B1 wherein the prelithiated negative electrode comprises a silicon based active material.

B5. The method of inventive concept B1 further comprising peeling a protective interlayer from a surface of the prelithiated negative electrode to expose the surface of the negative electrode.

B6. The method of inventive concept B1 wherein the prelithiated negative electrode is prelithiated with a lithium foil calendered with the surface of the electrode to induce prelithiation that is performed under controlled conditions.

B7. The method of inventive concept B1 wherein the cutting is performed by laser.

B8. The method of inventive concept B1 wherein the current collector has a thickness from about 2 microns to about 20 microns and each prelithiated electrode has a thickness from 40 microns to about 160 microns.

B9. The method of inventive concept B1 wherein forming comprises assembling a stack of a plurality of positive electrode and a plurality of negative electrode each adjacent electrode of different polarity separated by a separator wherein the top and bottom electrodes of the stack have the same polarity.

B10. The method of inventive concept B1 wherein forming comprises winding the cut electrode structure, separator and the counter electrode structure with the separator between the cut electrode structure and the counter electrode structure to form the roll.

B11. The method of inventive concept B1 further comprising injecting electrolyte into the container with the formed cell structure.

B12. The method of inventive concept B11 further comprising sealing the container after injecting the electrolyte.

C1. A roll-to-roll process apparatus for prelithiating electrochemical electrodes, the apparatus comprising:
1) a lamination system comprising:
   a) an electrode structure dispensing roll;
   b) a first lithium foil dispensing roll;
   c) a second lithium foil dispensing roll;
   d) a calender roll positioned to receive and pass a continuous sheet with a selected applied pressure passing through the calender roll; and
   e) a first conveyor system configured to guide a first sheet of lithium foil on support layer from the first lithium foil dispensing roll into contact with a first surface of an electrode structure layer from the electrode structure dispensing roll and a second sheet of lithium foil on support layer from the second lithium foil dispensing roll into contact with a second surface of the electrode structure layer opposite to the first surface of the electrode structure layer to form a stacked layer that is then guided to calender roll to form a lithium-electrode laminate having a support layer over each lithium foil layer;
2) a cooling system comprising;
   a) one or more cooling fluid sources and
   b) a second conveyor system configured to provide an extended conveyance path configured to receive the lithium-electrode laminate and convey the lithium-electrode laminate over a path with thermal contact with cooling fluid from the cooling fluid source with a path length that provides for sufficient time for dissipation of heat generated by the prelithiation reaction between the electrode and the lithium foil such that prelithiated electrode exiting the extended conveyance path is thermally stable with respect to avoidance of ignition;
3) prelithiated electrode collection system comprising:
   a1) a take up roll configured to receive the prelithiated electrode exiting the cooling system, or
   a2) an electrode portioning system and collector comprising a cutter configured to cut the continuous roll of prelithiated electrode into a portion for a cell electrode or a plurality thereof and a collector to accumulate the cut portions; and
4) an environmental chamber configured to enclose the lamination system, the cooling system and the prelithiated electrode collection system to maintain the interior of the environmental chamber in a low moisture environment.

C2. The roll-to-roll process apparatus of inventive concept C1 wherein the one or more cooling sources comprises a source of cooled gas, wherein the extended conveyance path comprises a series of conveyor rollers configured to convey the laminate on a switchback path with at least two reverse paths and wherein the cooling system further comprises a blower to blow the gas across the laminate traveling on the switchback path.

C3. The roll-to-roll process apparatus of inventive concept C1 wherein the one or more cooling sources comprises a liquid, wherein the extended conveyance path comprises a roller cooled internally by the liquid and wherein the path of the laminate carries the laminate over at least a third of the surface of the roller.

C4. The roll-to-roll process apparatus of inventive concept C1 wherein the prelithiated electrode collection system comprises one or two take up rolls to collect one or both support layers from the electrode surface.

C5. The roll-to-roll process apparatus of inventive concept C1 wherein the prelithiated electrode collection system comprises a take up roll that is cooled with a blower or liquid.

C6. The roll-to-roll process apparatus of inventive concept C5 wherein the collection system comprises one or more blowers configured to blow gas onto the surface of the take up roll as prelithiated electrode structure is collected.

C7. The roll-to-roll process apparatus of inventive concept C6 wherein the collection system further comprises a liquid flow path that cools the take up roll surface to cool the collected prelithiated electrode structure.

C8. The roll-to-roll process apparatus of inventive concept C1 wherein the first conveyor system and second conveyor system are configured to provide conveyance of prelithiated electrode structures with widths up to two meters and a length up to 8000 m.

C9. The roll-to-roll process apparatus of inventive concept C1 wherein the extended conveyance path comprises a series of conveyor rollers configured to convey the laminate on a switchback path with at least two reverse paths with a length of extended conveyance path through the cooling system of at least about 6 meters.

C10. The roll-to-roll process apparatus of inventive concept C1 wherein the extended conveyance path comprises a series of conveyor rollers configured to convey the laminate on a switchback path with at least two reverse paths with a length of time through the cooling system of at least about 1.5 minutes,

C11. The roll-to-roll process apparatus of inventive concept C1 having a conveyance rate of prelithiated electrode structure from the electrode structure dispensing system to the collection system from about 0.25 meters/minute (m/min) to about 20 m/min.

C12. The roll-to-roll process apparatus of inventive concept C1 wherein the calender roll applies a pressure from about 0.5 MPa to about 60 MPa.

C13. The roll-to-roll process apparatus of inventive concept C1 wherein the calender roll has a temperature of ±30° C. relative to room temperature.

C14. The roll-to-roll process apparatus of inventive concept C1 wherein the collection system further comprises a first take up roll configured to take up a first substrate peeled from a first surface of the prelithiated electrode structure prior to take up of the prelithiated electrode structure on the prelithiated electrode structure take up roll.

C15. The roll-to-roll process apparatus of inventive concept C14 wherein the collection system further comprises a second take up roll configured to take up a second substrate pealed from a second surface opposite the first surface of the prelithiated electrode structure prior to take up of the prelithiated electrode structure on the prelithiated electrode structure take up roll.

C16. The roll-to-roll process apparatus of inventive concept C14 wherein the collection system further comprises an interleaving delivery roll configured to an interleaving layer onto the surface of the prelithiated electrode structure following pealing of the first substrate and prior to take up of the prelithiated electrode structure on the prelithiated electrode structure take up roll.

C17. The roll-to-roll process apparatus of inventive concept C1 wherein the collection system has an atmosphere of cool dry air.

C18. The roll-to-roll process apparatus of inventive concept C1 wherein the collection system has an atmosphere of CO₂ or Ar.

The embodiments above are intended to be illustrative and not limiting. Additional embodiments are within the claims. In addition, although the present invention has been described with reference to particular embodiments, those skilled in the art will recognize that changes can be made in form and detail without departing from the spirit and scope of the invention. Any incorporation by reference of documents above is limited such that no subject matter is incorporated that is contrary to the explicit disclosure herein. To the extent that specific structures, compositions and/or processes are described herein with components, elements, ingredients or other partitions, it is to be understand that the disclosure herein covers the specific embodiments, embodiments comprising the specific components, elements, ingredients, other partitions or combinations thereof as well as embodiments consisting essentially of such specific components, ingredients or other partitions or combinations thereof that can include additional features that do not change the fundamental nature of the subject matter, as suggested in the discussion, unless otherwise specifically indicated. The use of the term “about” herein refers to expected uncertainties in the associated values as would be understood in the particular context by a person of ordinary skill in the art.

What is claimed is:

1. A method for the formation of a prelithiated electrode, the method comprising:
laminating a lithium foil comprising elemental lithium onto a prepared electrode with sufficient pressure to initiate reaction of the lithium foil with an active material of the prepared electrode, as evidenced by the generation of heat, to form a laminated lithium foil-electrode assembly; and
maintaining the laminated lithium foil-electrode assembly under conditions to undergo controlled prelithiation of the active material in a solvent-free reaction to provide for completion of the reaction, evidenced by the disappearance of elemental lithium on the electrode surface, in a time frame from about 5 minutes to about 24 hours.

2. The method of claim 1 wherein the method further comprises calendering the prepared electrode prior to laminating the lithium foil onto the electrode.

3. The method of claim 1 wherein the sufficient pressure is provided by rollers separated by a selected roll gap, and laminating comprises passing the assembly through the rollers.

4. The method of claim 3 wherein the selected roll gap is from about 70% to about 90% of a thickness of the assembled structure.

5. The method of claim 3 wherein the selected roll gap is from about 75% to about 87.5% of a thickness of the assembled structure and sufficient force from about 0.5 tons (T) to about 150 T, or from about 0.2 MPa to about 60 MPa.

6. The method of claim 1 further comprising calendering the prepared electrode prior to laminating, wherein a gap between calender rolls is from about 60% to about 98% of an initial prepared electrode thickness to achieve an active material density from about 0.8 g/cc to about 1.3 g/cc.

7. The method of claim 1, wherein a thickness of the laminated lithium foil-electrode assembly increases over the time frame of the disappearance of the elemental lithium.

8. The method of claim 1 wherein laminating comprises transferring essentially all of the elemental lithium from the lithium foil onto the prepared electrode.

9. The method of claim 1 wherein cooling is applied to control temperature of the laminated lithium foil-electrode assembly to moderate rate of the reaction.

10. The method of claim 9 wherein temperature is controlled to remain below 45° C.

11. The method of claim 1 wherein the lithium foil is supported initially on a polymeric substrate and wherein the laminated lithium foil-electrode assembly further comprises the polymeric substrate.

12. The method of claim 11 wherein maintaining the laminated lithium foil-electrode assembly comprises not removing the polymeric support from the structure for at least about one minute.

13. The method of claim 12 wherein the method further comprises removing and replacing the polymeric substrate with a replacement polymeric cover.

14. The method of claim 1 wherein the prepared electrode comprises a first negative electrode layer comprising the active material, a polymer binder and electrically conductive particles, and the first negative electrode layer is disposed on a current collector to form an electrode structure and wherein laminating results in a laminated lithium foil-electrode assembly comprising the lithium foil-electrode assembly on the current collector.

15. The method of claim 14 wherein the electrode structure comprises a second negative electrode layer comprising the active material, a polymer binder and electrically conductive particles, and the second negative electrode layer is disposed on the current collector opposite the first negative electrode layer.

16. The method of claim 1 wherein the lithium foil and/or the prepared electrode are in the form of sheets suitable for stacking.

17. The method of claim 1 wherein the lithium foil and/or the prepared electrode are in roll form.

18. The method of claim 1 wherein the laminated lithium foil-electrode assembly is maintained at a temperature below about 45° C. during prelithiation.

19. The method of claim 1 wherein the active material comprises at least about 20 weight percent of a silicon based active material.

20. The method of claim 1 wherein the prepared electrode comprises a negative electrode having an irreversible capacity loss, and an amount of elemental lithium supplied by the foil corresponds with from about 80 mole % to about 180 mole % of the irreversible capacity loss.

21. The method of claim 1 wherein the negative electrode comprises from about 75 wt % to about 94 wt % active material, from about 4 wt % to about 20 wt % polymer binder and from about 1 wt % to about 7 wt % conductive particles.

22. The method of claim 21 wherein the polymer binder is soluble in aqueous solution.

23. The method of claim 21 wherein the polymer binder is insoluble in aqueous solution and is soluble in organic solvent.

24. The method of claim 21 wherein the active material comprises at least about 20 wt % silicon based active material.

25. The method of claim 21 wherein the active material comprises at least about 55 wt % silicon based active material.

26. The method of claim 25 wherein the active material comprises a silicon oxide/silicon/carbon composite.

27. The method of claim 26 wherein the active material comprises at least about 85 wt % silicon based active material.
